(19) United States
(12) Patent Application Publication
(10) Pub. No.: US 2006/0216656 A1
(43) Pub. Date: Sep. 28, 2006

(54) Silver salt photothermographic dry imaging material and image forming method by use thereof

(75) Inventor: Narito Goto, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/374,556

(22) Filed: Mar. 13, 2006

(30) Foreign Application Priority Data
Mar. 22, 2005 (JP) JP2005-081882

(51) Int. Cl. G03C 5/16

(52) U.S. Cl. 430/348

(57) ABSTRACT

An image forming method of a photothermographic material comprising a light-sensitive layer containing an organic silver salt, photosensitive silver halide grains and a reducing agent and a light-insensitive layer is disclosed, comprising exposing and thermally developing the photothermographic material using a laser imager, wherein a total thickness of the light-sensitive layer and the light-insensitive layer is from 10 to 20 μm and at least one of the constituent layers contains a compound capable of forming a dye image upon thermal development; the laser imager comprises a developing section having a path length (1) and a cooling section having a path length (2), a ratio of the path length (2) to the path length (1) is not more than 1.5, and the cooling section having a function of conveying the photothermographic material sent from the developing section while cooling the photothermographic material.

This application claims priority from Japanese Patent Application No. JP2005-081882, filed on Mar. 22, 2005, which is incorporated hereinto by reference.

### FIELD OF THE INVENTION

The present invention relates to a silver salt photothermographic material comprising a support having thereon a thermally developable light-sensitive layer containing an organic silver salt, silver halide grains, a binder and a reducing agent and a light-insensitive layer and a image forming method by use thereof.

### BACKGROUND OF THE INVENTION

In the fields of medical diagnosis and graphic arts, there have been concerns in processing of photographic film with respect to effluent produced from wet-processing of image forming materials, and recently, reduction of the processing effluent has been strongly demanded in terms of environmental protection and space saving. Accordingly, thermally developable silver salt photothermographic dry imaging materials which can form images only upon heating were put into practical use and have rapidly spread in the foregoing fields.

Thermally developable silver salt photothermographic dry imaging materials (hereinafter, also denoted photothermographic dry imaging material or simply as photothermographic material) has been proposed over a long time, as disclosed, for example, in U.S. Pat. Nos. 3,152,904 and 3,457,075.

Photothermographic material is usually processed by a thermal-developing apparatus (also called a thermal processor) which stably heats the photothermographic material to form images. Along with this recent rapid spread, a large number of thermal-developing apparatuses have become available on the market. Further, a compact laser imager and shortening of processing time have been desired.

Accordingly, enhancement of characteristics of photothermographic materials are essential. To achieve sufficiently high densities of a photothermographic material even when subjected to rapid processing, it is ffective to employ silver halide grains of a relatively small average grain size to increase the number of development initiating points, thereby enhancing covering power, as disclosed in JP-A Nos. 11-295844 and 11-352627 (hereinafter, the term, JP-A refers to Japanese Patent Application Publication), to use high-active reducing agents containing a secondary or tertiary alkyl group, as disclosed in JP-A No. 2001-209145 and to use development accelerators such as hydrazine compounds, vinyl compounds, phenol derivatives and naphthol derivatives. In a photothermographic material using light-sensitive silver halide, the silver halide remains in the emulsion layer after thermal development, resulting in deteriorated image storage stability under light exposure. Some attempts to overcome such problems have been made, as described, for example, in JP-A Nos. 2003-270755 and 2004-004522.

In response to the rapid access from the aspect of apparatuses by miniaturization of a laser imager, there are disclosed a technique for reducing the distance of the cooling section of a laser imager, as described in JP-A No. 2004-4522 and techniques in which thermal development is performed with conveying the sheets at a speed of 23 mm/sec or more, or thermal development is performed simultaneously with exposure, as described in U.S. Patent Application Publication US 2004/0058281A1 and JP-A No. 2004-085763.

However, when applying the above-mentioned techniques to photothermographic materials, for example, thermal development was conducted by a laser imager with rapidly cooling in a shortened cooling section, there arose problems such that marked difference in fogging, maximum density and silver image tone occurred depending on the kind of photothermographic material, as compared to thermal development on a cooling section of an ordinary length.

### SUMMARY OF THE INVENTION

Accordingly, in view of the foregoing, it is an object of the present invention to provide a method of forming images exhibiting enhanced sensitivity, minimized fogging, higher maximum density and superior silver image tone, even when thermally developing a photothermographic material using a compact laser imager provided with a cooling section of a reduced path length, and a thermally developable photothermographic material adaptable thereto.

Thus, one aspect of the invention is directed to an image forming method comprising exposing and thermally developing a photothermographic material comprising on at least one side of a support a light-sensitive layer containing an organic silver salt, photosensitive silver halide grains, a binder and a reducing agent for silver ions and a light-insensitive layer by using a laser image, wherein the total dry layer thickness of the light-sensitive layer and the light-insensitive layer is from 10 to 20 μm, at least one of constituent layers of the photothermographic material contains a compound capable of forming a dye image upon thermal development; the laser imager comprises a thermal-developing section having a path length (1) and a cooling section having a path length (2), the ratio of the path length (2) to the path length (1) is not more than 1.5, and the cooling section is provided downstream from the thermal-developing section and having a function of conveying the photothermographic material sent from the thermal developing section with cooling.

Another aspect of the invention is directed to a photothermographic material adaptable to the above-mentioned image forming method.

### BRIEF EXPLANATION OF THE DRAWINGS

FIG. 1(a) and FIG. 1(b) each illustrate a laser imager used for image formation by thermally developing a photothermographic material relating to the invention.

### DETAILED DESCRIPTION OF THE INVENTION

A laser imager (thermal development apparatus) relating to this invention is composed of a film supplying unit section, a laser image recording unit section, a thermal-developing unit section for providing heat homogeneously and stably to the whole surface of a photothermographic material, and a transporting unit section for conveying the photothermographic material from the film supplying unit section, via laser recording and thermal developing, till discharging the photothermographic material having formed images.

In the laser imager relating to this invention, the ratio of the path length of the cooling section to the path length of the thermal developing section is 1.5 or less, preferably from 0.1 to 1.2, more preferably from 0.2 to 1.0. The path length of the thermal developing section refers to the distance of conveying a photothermographic material with heating at a developing temperature. The path length of the cooling section refers to the distance of conveying the thermally developed photothermographic material from the end of the thermal developing section (being after completion of heating) to the exit of the laser imager (or until discharging the photothermographic material under the ambient light of a room where the laser imager is installed, from the light-tight region of the laser imager).

The laser imager preferably has a function of making the cooling rate of the opposite side of the photothermographic material to the light-sensitive layer (hereinafter, also denoted as the insensitive side) greater than that of the light-sensitive layer side (hereinafter, also denoted as the sensitive side). Thus, when the surface of the sensitive side of the photothermographic material and the surface of the insensitive side are cooled in the cooling section at cooling rate (A) and cooling rate (B), respectively, the rate (B) is preferably greater than the rate (A).

In the invention, the cooling rate is determined in the manner as follows. Ten thermocouples are uniformly attached to each of the sensitive side and the insensitive side of the photothermographic material and processing of from thermal development to discharging via cooling is performed and the temperature history of each until reaching 45° C. was measured for the respective layer sides. Thus, the time of from the development temperature (123° C.) until reaching 45° C. is measured (which is denoted as a cooling time) and the reciprocal of the cooling time is defined as a cooling rate.

In this invention, the ratio of the cooling rate (B) of the insensitive side to the rate (A) of the sensitive side is preferably at least 1.1, more preferably from 1.1 to 5.0, and still more preferably from 1.5 to 3.0. The means for increasing the cooling rate on the insensitive side are not specifically limited but it is a preferred embodiment to bring the insensitive side into direct contact with a metal plate, a metal roller, unwoven fabric or a flocked roller. It is also preferable to use a heat sink or a heat pipe in combination with the foregoing members.

A laser imager having a short cooling section, which exhibits the ratio of a path length of a cooling section to that of a thermal-developing section of 1.5 or less,.can provide a compact, higher-speed laser imager.

The cooling time of from leaving the thermal-developing section until being discharged from the exit of the laser imager is preferably 0 to 25 sec., more preferably 0 to 15 sec., and still more preferably 5 to 15 sec.

The path length over which a photothermographic material passes after leaving the thermal developing section and before being discharged, is optional, preferably 1 to 60 cm, more preferably 5 to 50 cm, and still more preferably 5 to 40 cm.

Photothermographic material relating to this invention may be thermally developed in any method, but usually, an imagewise exposed photothermographic material is developed, while being heated at a relatively high temperature. The developing temperature is preferably 80 to 250° C., more preferably 100 to 140° C., and still more preferably 110 to 130° C. The developing time is preferably 1 to 30 sec., more preferably 3 to 15 sec., and still more preferably 3 to 10 sec. A developing temperature of less than 80° C. cannot obtain sufficiently high image density over a short period of time, while a developing temperature of more than 200° C. causes melting of the binders, adversely affecting not only the image but also transportability or the processor, such as transfer onto rollers. Heating causes oxidation-reduction reaction between an organic silver salt (which functions as an oxidant) and a reducing agent to form a silver image. This reaction proceeds without supplying any processing solution such as water.

The thermal development system of this invention can employ a drum type heater or a plate type heater but a plate heater system is preferred. The preferred thermal development system of a plate heater system is the method described in JP-A No. 11-133572, that is, a laser imager in which a photothermographic material which has been exposed to light to form latent images on silver halide grains, is brought into contact with a heating means in the thermal-developing section to obtain a visible image. The heating means is composed of a plate heater and a plurality of pressure rollers are arranged facing and along the surface of the plate heater. The photothermographic material is allowed to pass between the plate heater and the pressure rollers to perform thermal development.

The linear velocity in each of the exposure section, the thermal-developing section and the cooling section is optional but a higher velocity is preferred for rapid processing or enhancement of through-put. The linear velocity is preferably 25 to 200 mm/sec, more preferably 28 to 150 mm/sec, and still more preferably 30 to 600 mm/sec. A transport speed falling within this range can improve density unevenness due to thermal development and can decrease the processing time, which is suitable for urgent medical diagnosis.

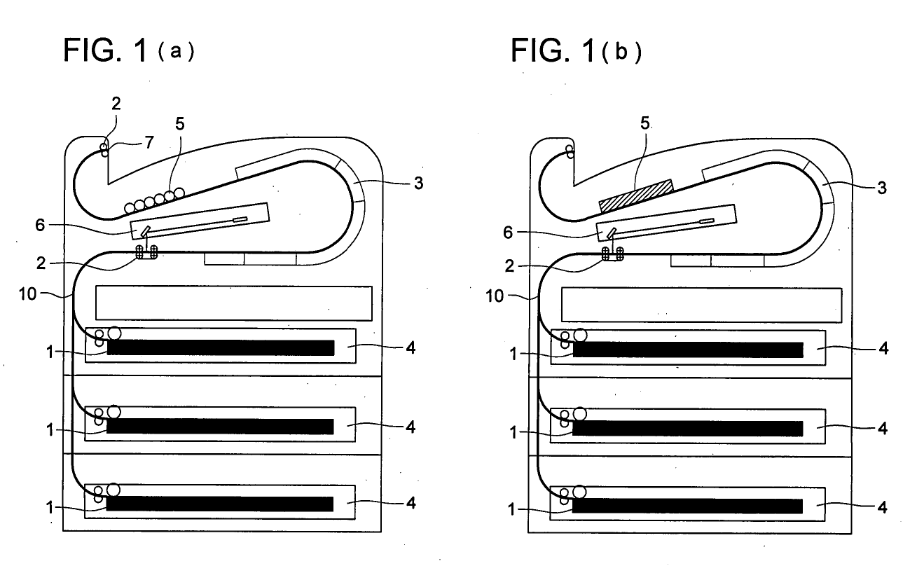

FIG. 1(a) and 1(b) each illustrates one embodiment of a laser imager. The distance between an exposure section and a thermal-developing section is preferably within a range from 0 to 50 cm to perform thermal development concurrently with exposure, i.e., to start development of an exposed portion of a sheet while simultaneously exposing an unexposed portion of the sheet. Thereby, the processing time for exposure and development is extremely reduced. The distance is more preferably 3 to 40 cm, and still more preferably 5 to 30 cm. The exposure section refers to the region in which light from a light source exposes a photothermographic material, and the thermal developing section refers to a region in which a photothermographic material is heated to perform thermal development. In FIG. 1(a) or 1(b), the numeral 6 designates an exposure, while the numeral 4 designates a thermal developing section.

Heating instruments, devices or means can employ typical heating means such as a hot plate, an iron, a hot roller and a heat generator using carbon or white titanium. Heating a photothermographic material having a protective layer on the light-sensitive layer with contacting the protective layer side with heating means to achieve uniform heating is preferred in terms of heat efficiency and workability.

When a photothermographic material is developed for 12 sec. at a heating temperature of 123° C., the photothermographic material preferably exhibits an average gradation of 2.0 to 4.0 over the diffuse density range from 0.25 to 2.5 in a characteristic curve on a rectangular coordinate system comprised of a diffuse density (Y-axis) and a common logarithmic exposure (X-axis). Such a gradation can obtain an image exhibiting enhanced diagnostic recognizing ability at a relatively low silver coverage.

To adapt to a laser imager relating to this invention, the total dry layer thickness of light-sensitive and light-insensitive layers of the photothermographic material is preferably 12 to 19 μm, and more preferably 14 to 18 μm. The light-sensitive layer thickness is preferably 9 to 16 μm, and more preferably 11 to 15 μm.

An organic silver salt usable in this invention is a light-insensitive organic silver salt-capable of functioning as a source for supplying silver ions necessary to form an image in the light-sensitive layer of a photothermographic material.

Organic silver salts usable in the invention which are relatively stable to light, function as a silver ion supplying source and contribute to formation of silver images when heated at a temperature of 80° C. or more in the presence of silver halide grains (photocatalyst) having latent images formed upon exposure a photocatalyst on the grain surface and a reducing agent. There have been known silver salts of organic compounds having various chemical structure. Such light-insensitive organic silver salts are described in JP-A No. 10-62899, paragraph [0048]-[0049]; European Patent Application Publication (hereinafter, denoted simply as EP-A) No. 803,764A1, page 18, line 24 to page 19, line 37; EP-A No. 962 812A1; JP-A Nos. 11-349591, 2000-7683, 2000-72711, 2002-23301, 2002-23303, 2002-49119, 2002-196446; EP-A Nos. 1246001A1 and 1258775A1; JP-A Nos. 2003-140290, 2003-195445, 2003-295378, 2003-295379, 2003-295380 and 2003-295381.

Silver salts of aliphatic carboxylic acids, specifically long chain aliphatic carboxylic acids having 10 to 30 carbon atoms, preferably 15 to 28 carbon atoms are preferable used alone or in combination with the foregoing organic silver salts. The molecular weight of such an aliphatic carboxylic acid is preferably from 200 to 400, and more preferably 250 to 400. Preferred aliphatic carboxylic acid (or fatty acid) silver salts include, for example, silver behenate, silver arachidate, silver stearate, silver oleate, silver laurate, silver caprate, silver myristate, silver palmitate and their mixtures. Of the foregoing aliphatic carboxylic acid silver salts, a fatty acid silver salt having a silver behenate content of 50 mol % or more (preferably 80 to 99.9 mol %, and more preferably 90 to 99.9 mol %) is preferably used.

Prior to preparation of an aliphatic carboxylic acid silver salt, it needs to prepare an alkali metal salt of an aliphatic carboxylic acid. Alkali metal salts usable in this invention include, for example, sodium hydroxide, potassium hydroxide and lithium hydroxide. Of these, the use of potassium hydroxide is preferred. The combined use of sodium hydroxide and potassium hydroxide is also preferred. The molar ratio of the combined use is preferably within the range of 10:90 to 75:25. The use within the foregoing range can suitably control the viscosity of a reaction mixture when forming an alkali metal salt of an aliphatic carboxylic acid through the reaction with an aliphatic carboxylic acid.

When preparing an aliphatic carboxylic acid silver salt in the presence of silver halide grains having an average grain size of 0.050 μm or less, a higher content of potassium of alkali metal salts is preferred in terms of prevention of dissolution of silver halide grains and Ostwald ripening. A high potassium content results in reduced sizes of aliphatic acid silver salt particles. The proportion of a potassium salt-is preferably 50 to 100 mol % of the whole alkali metal salts. The alkali metal salt concentration is preferably from 0.1 to 0.3 mol/1000 ml.

Other than the foregoing organic silver salts are also usable core/shell organic silver salts described in JP-A No. 2002-23303; silver salts of polyvalent carboxylic acids, as described in EP 1246001 and JP-A No. 2004-061948; and polymeric silver salts, as described in JP-A Nos. 2000-292881 and 2003-295378 to 2003-295381.

The shape of organic silver salts usable in the invention is not specifically limited and organic silver salts in any form, such as needle form, bar form, tabular form or scale form, are usable. Organic silver salts in a scale-form are preferred in the invention. There are also preferably used organic silver salts in the form of a short needle exhibiting a ratio of major axis to minor axis of 5 or less, a rectangular parallelepiped or a cube, or potato-form irregular grains. These organic silver salt grains result in reduced fogging during thermal development, as compared to grains in the form of a long-needle exhibiting a ratio of major axis to minor axis of 5 or more. In the invention, an organic silver salt in a scale form is defined as follows. The organic silver salt is electron-microscopically observed and the form of organic silver salt grains is approximated by a rectangular parallelepiped. When edges of the rectangular parallelepiped are designated as “a”, “b” and “c” in the order from the shortest edge (in which c may be equal to b), values of shorter edges a and b are calculated to determine “x” defined as below:
x=b/a
Values of x are determined for approximately 200 grains and the average value thereof, x(av.) is calculated. Thus, grains satisfying the requirement of x(av.)≧1.5 are defined to be a scale form. Preferably, 30≧x(av.)≧1.5, and more preferably, 20≧x(av.)≧2.0. In this connection, the needle form satisfies 1≦x(av)<1.5.

In the foregoing grain in a scale form, “a” is regarded as a thickness of a tabular grain having a major face comprised of edges of “b” and “c”. The average value of “a” is preferably from 0.01 to 0.23 μm, more preferably 0.1 to 0.20 μm. The average value of c/b is preferably from 1 to 6, more preferably 1.05 to 4, still more preferably 1.1 to 3, and further still more preferably 1.1 to 2.

The grain size distribution of an organic silver salt is preferably monodisperse. The expression, being monodisperse means that the percentage of a standard deviation of minor or major axis lengths, divided by an average value of the minor or major axis, is preferably less than 100%, more preferably not more than 80%, and still more preferably not more than 50%. The organic silver salt shape can be determined through transmission electron-microscopic images of an organic silver salt dispersion. Alternatively, the standard deviation of volume-weighted grain size, divided by the average volume-weighted grain size (that is a, coefficient of variation) is preferably less than 100%, more preferably not more than 80%, and still more preferably not more than 50%. The measurement thereof is carried out, for example, as follows. To an organic silver salt dispersed in a liquid, laser light is irradiated and an auto-correction function v.s. time change of fluctuation of scattered light to determine the grain size (volume-weighted average grain size).

Conventionally known methods are applicable to manufacturing or dispersing organic silver salts of the invention, for example, as described in JP-A No. 10-62899, EP 803,763A1, EP 962,812A1, JP-A Nos. 2001-167022, 2000-7683, 2000-72711, 2001-163889, 2001-163890, 2001-163827, 2001-33907, 2001-188313, 2001-83652, 2002--6442, 2002-31870 and 2003-280135.

Dispersing organic silver salts concurrently in the presence of a light-sensitive silver salt results in increased fogging and decreased sensitivity, and it is therefore preferred that the dispersion contains substantially no light-sensitive silver salt. Thus, the content of an aqueous dispersion of light-sensitive silver salt is preferably not more than 1 mol %, based on organic silver salt of the dispersion, more preferably not more than 0.1 mol %, and no addition of light-sensitive silver salt is more preferred.

The photothermographic material of the invention can be prepared by mixing an aqueous dispersion of organic silver salt with an aqueous dispersion of light-sensitive silver salt. The ratio of light-sensitive silver salt to organic silver salt can be optionally chosen but preferably from 1 to 30 mol5, more preferably 2 to 20 mol %, and still more preferably 3 to 15 mol %. To control photographic characteristics, it is preferred to mix an aqueous dispersion of at least two kinds of organic silver salts with an aqueous dispersion of at least two kinds of light-sensitive silver salts.

Organic silver salts are usable in an intended amount but preferably 0.1 to 5 g/m², based on silver amount, more preferably 0.3 to 3 g/m², and still more preferably 0.5 to 2 g/m².

ILight-sensitive silver halide grains (hereinafter, also denoted as light-sensitive silver halide grains or simply as silver halide grains) used in this invention are those which are capable of absorbing light as an inherent property of silver halide crystal or capable of absorbing visible or infrared light by artificial physico-chemical methods, and which are treated or prepared so as to cause a physico-chemical change in the interior and/or on the surface of the silver halide crystal upon absorbing light within the region of ultraviolet to infrared.

The silver halide grains used in the invention can be prepared according to conventionally known methods. Any one of acidic precipitation, neutral precipitation and ammoniacal precipitation is applicable and the reaction mode of aqueous soluble silver salt and halide salt includes single jet addition, double jet addition and a combination thereof. Specifically, preparation of silver halide grains with controlling the grain formation condition, so-called controlled double-jet precipitation is preferred.

The grain forming process is usually classified into two stages of formation of silver halide seed crystal grains (nucleation) and grain growth. These stages may continuously be conducted, or the nucleation (seed grain formation) and grain growth may be separately performed. The controlled double-jet precipitation, in which grain formation is undergone with controlling grain forming conditions such as pAg and pH, is preferred to control the grain form or grain size. In cases when nucleation and grain growth are separately conducted, for example, a soluble silver salt and a soluble halide salt are homogeneously and promptly mixed in an aqueous gelatin solution to form nucleus grains (seed grains), thereafter, grain growth is performed by supplying soluble silver and halide salts, while being controlled at a pAg and pH to prepare silver halide grains. After completion of grain formation, soluble salts are removed in the desalting stage, using commonly known desalting methods such as the noodle method, flocculation method, ultrafiltration method and electrodialysis method.

Silver halide grains are preferably monodisperse grains with respect to grain size. The monodisperse grains as described herein refer to grains having a coefficient of variation of grain size obtained by the formula described below of not more than 30%; more preferably not more than 20%, and still more preferably not more than 15%:
Coefficient of variation of grain size=standard deviation of grain diameter/average grain diameter×100(%)

The grain form can be of almost any one, including cubic, octahedral or tetradecahedral grains, tabular grains, spherical grains, bar-like grains, and potato-shaped grains. Of these, cubic grains, octahedral grains, tetradecahedral grains-and tabular grains are specifically preferred.

The aspect ratio of tabular grains is preferably 1.5 to 100, and more preferably 2 to 50. These grains are described in U.S. Pat. Nos. 5,264,337, 5,314,798 and 5,320,958 and desired tabular grains can be readily obtained. Silver halide grains having rounded corners are also preferably employed.

Crystal habit of the outer surface of the silver halide grains is not specifically limited, but in cases when using a spectral sensitizing dye exhibiting crystal habit (face) selectivity in the adsorption reaction of the sensitizing dye onto the silver halide grain surface, it is preferred to use silver halide grains having a relatively high proportion of the crystal habit meeting the selectivity. In cases when using a sensitizing dye selectively adsorbing onto the crystal face of a Miller index of [100], for example, a high ratio accounted for by a Miller index [100] face is preferred. This ratio is preferably at least 50%; is more preferably at least 70%, and is most preferably at least 80%. The ratio accounted for by the Miller index [100] face can be obtained based on T. Tani, J. Imaging Sci., 29, 165 (1985) in which adsorption dependency of a [111] face or a [100] face is utilized.

It is preferred to use low molecular gelatin having an average molecular weight of not more than 50,000 in the preparation of silver halide grains used in the invention, specifically, in the stage of nucleation. Thus, the low molecular gelatin has an average molecular eight of not more than 50,000, preferably 2,000 to 40,000, and more preferably 5,000 to 25,000. The average molecular weight can be determined by means of gel permeation chromatography. The low molecular weight gelatin can be obtained by adding an enzyme to conventionally used gelatin having a molecular weight of ca. 100,000 to perform enzymatic degradation, by adding acid or alkali with heating to perform. hydrolysis, by heating under atmospheric pressure or under high pressure to perform thermal degradation, or by exposure to ultrasonic.

The concentration of dispersion medium used in the nucleation stage is preferably not more than 5% by weight, and more preferably 0.05 to 3.0% by weight.

In the preparation of silver halide grains, it is preferred to use a compound represent by the following formula, specifically in the nucleation stage:
YO(CH₂CH₂O)m(C(CH₃)CH₂O)p(CH₂CH₂O)ₙY
where Y is a hydrogen atom, —SO₃M or —CO—B—COOM, in which M is a hydrogen atom, alkali metal atom, ammonium group or ammonium group substituted by an alkyl group having carbon atoms of not more than 5, and B is a chained or cyclic group forming an organic dibasic acid; m and n each are 0 to 50; and p is 1 to 100. Polyethylene oxide compounds represented by foregoing formula have been employed as a defoaming agent to inhibit marked foaming occurred when stirring or moving emulsion raw materials, specifically in the stage of preparing an aqueous gelatin solution, adding a water-soluble silver and halide salts to the aqueous gelatin solution or coating an emulsion on a support during the process of preparing silver halide photographic light sensitive materials. A technique of using these compounds as a defoaming agent is described in JP-A No. 44-9497. The polyethylene oxide compound represented by the foregoing formula also functions as a defoaming agent during nucleation. The compound represented by the foregoing formula is used preferably in an amount of not more than 1%, and more preferably 0.01 to 0.1% by weight, based on silver.

The compound is to be present at the stage of nucleation, and may be added to a dispersing medium prior to or during nucleation. Alternatively, the compound may be added to an aqueous silver salt solution or halide solution used for nucleation. It is preferred to add it to a halide solution or both silver salt and halide solutions in an amount of 0.01 to 2.0% by weight. It is also preferred to make the compound represented by formula [5] present over a period of at least 50% (more preferably, at least 70%)of the nucleation stage.

The temperature during the stage of nucleation is preferably 5 to 60° C., and more preferably 15 to 50° C. Even when nucleation is conducted at a constant temperature, in a temperature-increasing pattern (e.g., in such a manner that nucleation starts at 25° C. and the temperature is gradually increased to reach 40° C. at the time of completion of nucleation) or its reverse pattern, it is preferred to control the temperature within the range described above.

Silver salt and halide salt solutions used for nucleation are preferably in a concentration of not more than 3.5 mol/l, and more preferably 0.01 to 2.5 mol/l. The flow rate of aqueous silver salt solution is preferably 1.5×10⁻³ to 3.0×10⁻¹ mol/min per liter of the solution, and more preferably 3.0×10⁻³ to 8.0×10⁻² mol/min. per liter of the solution. The pH during nucleation is within a range of 1.7 to 10, and since the pH at the alkaline side broadens the grain size distribution, the pH is preferably 2 to 6. The pBr during nucleation is 0.05 to 3.0, preferably 1.0 to 2.5, and more preferably 1.5 to 2.0. The average grain size of silver halide of the invention is preferably 10 to 50 nm, more preferably 10 to 40 nm, and still more preferably 10 to 35 nm. An average grain size of less than 10 nm often lowers the image density or deteriorated storage stability under light exposure (aging stability when images obtained in thermal development is used for diagnosis under room light or aged under ambient light). An average grain size of more than 50 nm results in lowered image density.

In the invention, the grain size refers to an edge length of the grain in the case of regular grains such as cubic or octahedral grains. In the case of tabular grains, the grain size refers to a diameter of a circle equivalent to the projected area of the major face. In the case of irregular grains, such as spherical grains or bar-like grains, the diameter of a sphere having the same volume as the grain is defined as the grain size. Measurement is made using an electron microscope and grain size values of at least 300 grains are average and defined as an average grain size.

The combined use of silver halide grains having an average grain size of 55 to 100 nm and silver halide grains having an average grain size of 10 to 50 nm not only adjusts the gradation of image density but also enhances the image density or improves (or reduces) lowering in image density during storage. The ratio (by weight) of silver halide grains having an average grain size of 10 to 50 nm to silver halide grains having an average grain size of 55 to 100 nm is preferably from 95:5 to 50:50, and more preferably form 90:10 to 60:40.

When two silver halide emulsions differing in average grain size, these emulsion may be blended and incorporated to the light-sensitive layer. To make adjustment of gradation, the light-sensitive layer divided to at least two layers and two silver halide emulsions differing in average grain size are contained in the respective layers.

Iodide containing silver halide grains are preferably used as silver halide grains used in this invention. With respect to halide composition, silver halide grains of the invention preferably have an iodide content of 5 to 10 mol % (more preferably 40 to 100 mo % still more preferably 70 to 100 mol %). In the foregoing iodide content range, the halide composition within the grain may be homogeneous, or stepwise or continuously varied. Silver halide grains of a core/shell structure, exhibiting a higher iodide content in the interior and/or on the surface are preferably used. The structure is preferably 2-fold to 5-fold structure and core/shell grains having the 2-fold to 4-fold structure are more preferred.

Introduction of silver iodide into silver halide can be achieved by addition of an aqueous alkali iodide solution in the course of grain formation, addition of fine grains such as particulate silver iodide, particulate silver iodobromide, particulate silver iodochloride or silver iodochlorobromide, or addition of an iodide ion-releasing agent as described in JP-A Nos. 5-323487 and 6-11780. The silver halide usable in the invention preferably exhibits a direct transition absorption attributed to the silver iodide crystal structure within the wavelength region of 350 to 440 nm. The direct transition absorption of silver halide can be readily distinguished by observation of an exciton absorption in the range of 400 to 430 nm, due to the direct transition.

Light-sensitive silver halide grains usable in this invention are preferably those which are capable of being converted from a surface image forming type to an internal image forming type upon thermal development, resulting in reduced surface sensitivity. Thus, the silver halide grains form latent images capable of acting as a catalyst in development (or reduction reaction of silver ions by a reducing agent) upon exposure to light prior to thermal development on the silver halide-grain surface, and upon exposure after completion of thermal development, images are formed preferentially in the interior of the grains (i.e., internal latent image formation), thereby suppressing latent image formation on the grain surface. There has been known the use of silver halide grains capable of varying the latent image forming function before and after thermal development in photothermographic materials.

In general, when exposed to light, light-sensitive silver halide grains or spectral sensitizing dyes adsorbed onto the surfaces of the silver halide grains are photo-excited to form free electrons. The thus formed electrons are trapped competitively by electron traps on the grain surface (sensitivity center) and internal electron traps existing in the interior of the grains. In cases when chemical sensitization centers (chemical sensitization nuclei) or dopants useful as a electron trap exist more on the surface than the interior of the grain, latent images are more predominantly on the surface than in the interior of the grain, rendering the grains developable. On the contrary, the chemical sensitization centers or dopants useful as electron traps, which exist more in the interior than the surface of the grains form latent images preferentially in the interior rather than the surface of the grains, rendering the grain undevelopable. Alternatively, it can be said that, in the former case, the grain surface has higher sensitivity than the interior; in the latter case, the surface has lower sensitivity than the interior. The foregoing is detailed, for example, in T. H. James, The Theory of the Photographic Process, 4th Ed. (Macmillan Publishing Co., Ltd., 1977 and Nippon Shashin Gakai Ed., “Shashin Kogaku no Kiso (Ginene Shashin)” (Corona Co., Ltd:., 1998).

In one preferred embodiment of this invention, light-sensitive silver halide grains each contain a dopant capable of functioning as an electron-trapping dopant when exposed to light after thermal development inside the grains, resulting in enhanced sensitivity and improved image storage stability. The dopant is more preferably one which is capable of functioning as a hole trap when exposed prior to thermal development and which is also capable of functioning as an electron trap after subjected to thermal development.

The electron trapping dopant is an element or compound, except for silver and halogen forming silver halide, referring to one having a property of trapping free electrons or one whose occlusion within the grain causes a site such as an electron-trapping lattice imperfection. Examples thereof include metal ions except for silver and their salts or complexes; chalcogen (elements of the oxygen group) such as sulfur, selenium and tellurium; chalcogen or nitrogen containing organic or inorganic compounds; and rare earth ions or their complexes.

Examples of the metal ions and their salts or complexes include a lead ion, bismuth ion and gold ion; lead bromide, lead carbonate, lead sulfate, bismuth nitrate, bismuth chloride, bismuth trichloride, bismuth carbonate, sodium bismuthate, chloroauric acid, lead acetate, lead stearate and bismuth and acetate.

Compounds containing chalcogen such as sulfur, selenium or tellurium include various chalcogen-releasing compounds, which are known, in the photographic art, as a chalcogen sensitizer. The chalcogeno or nitrogen-containing organic compounds are preferably heterocyclic compounds. Examples thereof include imidazole, pyrazole, pyridine, pyrimidine, pyrazine, pyridazine, triazole, triazine, indole, indazole, purine, thiadiazole, oxadiazole, quinoline, phthalazine, naphthyridine, quinoxaline, quinazoline, cinnoline, pteridine, acridine, phenanthroline, phenazine, tetrazole, thiazole, oxazole, benzimidazole, benzoxazole, benzthiazole, indolenine, and tetrazaindene; preferred of these are imidazole, pyridine, pyrazine, pyridazine, triazole, triazine, thiadiazole, oxadiazole, quinoline, phthalazine, naphthyridine, quinoxaline, quinazoline, cinnoline, tetrazole, thiazole, oxazole, benzimidazole, benzoxazole, benzthiazole, and tetrazaindene. The foregoing heterocyclic compounds may be substituted with substituents. Examples of substituents include an alkyl group, alkenyl group, aryl group, alkoxy group, aryloxy group, acyloxy group, acyl group, alkoxycarbonyl group, aryloxycarbonyl group, acyloxy group, acylamino group, alkoxycarbonylamino group, aryloxycarbonylamino group, sulfonylamino group, sulfamoyl group, carbamoyl group, sulfonyl group, ureido group, phosphoric acid amido group, halogen atoms, cyano group, sulfo group, carboxyl group, nitro group, and heterocyclic group; of these, an alkyl group, aryl group, alkoxy group, aryloxy group, acyl group, acylamino group, alkoxycarbonylamino group, sulfonylamino group, sulfamoyl group, carbamoyl group, sulfonyl group, ureido group, phosphoric acid amide group, halogen atoms, cyano group, nitro group and heterocyclic group are preferred; and an alkyl group, aryl group, alkoxy group, aryloxy group, acyl group, acylamino group, sulfonylamino group, sulfamoyl group, carbamoyl group, halogen atoms, cyano group, nitro group, and heterocyclic group are more preferred.

In one embodiment of this invention, silver halide grains used in this invention occlude transition metal ions selected from groups 6 to 11 inclusive of the periodic table of elements whose oxidation state is chemically prepared in combination with ligands so as to function as an electron-trapping dopant and/or a hole-trapping dopant. Preferred transition metals include W, Fe, Co, Ni, Cu, Ru, Rh, Pd, Re, Os, Ir and Pt. The foregoing transition metal is doped within the interior of the grains, preferably within the interior region of 0% to 99% of the grain volume (more preferably 0% to 50% of the grain volume). The interior region of 0% to 99% of the grain volume refers to the central portion of the grains in an interior region surrounding 99% of the total silver forming the grains.

The foregoing dopants may be used alone or in combination thereof, provided that at least one of the dopants needs to act as an electron-trapping dopant when exposed after being subjected to thermal development. The dopants can be introduced, in any chemical form, into silver halide grains. The dopant content is preferably 1×10⁻⁹ to 1×10 mol, more preferably 1×10⁻⁸ to 1×10⁻¹ mol, and still more preferably 1×10⁻⁶ to 1×10⁻² mol per mol of silver. The optimum content, depending on the kind of the dopant, grain size or form of silver halide grains and other environmental conditions, can be optimized in accordance with the foregoing conditions.

In this invention, transition metal complexes or their ions, represented by the general formula described below are preferred:
(ML₆)^{m}: Formula
wherein M represents a transition metal selected from elements in Groups 6 to 11 of the Periodic Table; L represents a coordinating ligand; and m represents 0, 1-, 2-, 3- or 4-. M is selected preferably from W, Fe, Co, Ni, Cu, Ru, Rh, Pd, Re, Os, Ir and Pt. Exemplary examples of the ligand represented by L include halides (fluoride, chloride, bromide, and iodide), cyanide, cyanato, thiocyanato, selenocyanato, tellurocyanato, azido and aquo, nitrosyl, thionitrosyl, etc., of which aquo, nitrosyl and thionitrosyl are preferred. When the aquo ligand is present, one or two ligands are preferably coordinated. L may be the same or different.

Compounds, which provide these metal ions or complex ions, are preferably incorporated into silver halide grains through addition during the silver halide grain formation. These may be added during any preparation stage of the silver halide grains, that is, before or after nuclei formation, growth, physical ripening, and chemical ripening. However, these are preferably added at the stage of nuclei formation, growth, and physical ripening; furthermore, are preferably added at the stage of nuclei formation and growth; and are most preferably added at the stage of nuclei formation. These compounds may be added several times by dividing the added amount. Uniform content in the interior of a silver halide grain can be carried out. As disclosed in JP-A No. 63-29603, 2-306236, 3-7167545, 4-76534, 6-110146, 5-273683, the metal can be non-uniformly occluded in the interior of the grain.

These metal compounds can be dissolved in water or a suitable organic solvent (e.g., alcohols, ethers, glycols, ketones, esters, amides, etc.) and then added. Furthermore, there are methods in which, for example, an aqueous metal compound powder solution or an aqueous solution in which a metal compound is dissolved along with NaCl and KCl is added to a water-soluble silver salt solution during grain formation or to a water-soluble halide solution; when a silver salt solution and a halide solution are simultaneously added, a metal compound is added as a third solution to form silver halide grains, while simultaneously mixing three solutions; during grain formation, an aqueous solution comprising the necessary amount of a metal compound is placed in a reaction vessel; or during silver halide preparation, dissolution is carried out by the addition of other silver halide grains previously doped with metal ions or complex ions. Specifically, the preferred method is one in which an aqueous metal compound powder solution or an aqueous solution in which a metal compound is dissolved along with NaCl and KCl is added to a water-soluble halide solution. When the addition is carried out onto grain surfaces, an aqueous solution comprising the necessary amount of a metal compound can be placed in a reaction vessel immediately after grain formation, or during physical ripening or at the completion thereof or during chemical ripening. Non-metallic dopants can also be introduced in a manner similar to the foregoing metallic dopants.

Whether a dopant has an electron-trapping property in the photothermographic material relating to this invention can be evaluated according to the following manner known in the photographic art. A silver halide emulsion comprising silver halide grains doped with a dopant is subjected to microwave photoconductometry to measure photoconductivity. Thus, the doped emulsion can be evaluated with respect to a decreasing rate of photoconductivity on the basis of a silver halide emulsion containing no dopant. Evaluation can also be made based on comparison of internal sensitivity and surface sensitivity.

A photothermographic dry imaging material relating to this invention can be evaluated with respect to effect of an electron trapping dopant, for example, in the following manner. The photothermographic material, prior to exposure, is heated under the same condition as usual thermal developing conditions and then exposed through an optical wedge to white light or light in the specific spectral sensitization region (for example, in the case when spectrally sensitized for a laser, light falling within such a wavelength region, in the case when infrared-sensitized, an infrared light and in the case when sensitized to light in the region of intrinsic sensitivity of silver halide grains, for example, a blue region, a blue light) for a period of a given time and then thermally developed under the same condition as above. The thus processed photothermographic material is further subjected to densitometry with respect to developed silver image to prepare a characteristic curve comprising an abscissa of exposure and an ordinate of silver density and based thereon, sensitivity is determined. The, obtained sensitivity is compared for evaluation with that of a photothermographic material using silver halide emulsion grains not containing an electron trapping dopant. Thus, it is necessary to confirm that the sensitivity of the photothermographic material containing the dopant is lower than that of the photothermographic material not containing the dopant.

A photothermographic material is exposed through an optical wedge to white light or a light within the specific spectral sensitization region for a given time and thermally developed under usual practical thermal development conditions (e.g., 123° c., 10 seconds) and the sensitivity obtained based on the characteristic curve is designated as S1. Separately, the photothermographic material, prior to exposure, is heated under the practical thermal development conditions (e.g., 123° C., 10 seconds) and further exposed and thermally developed similarly to the foregoing and the sensitivity obtained based on a characteristic curve is designated as S2. The ratio of S2/S1 of the photothermographic material relating to this invention is preferably not more than 1/10, more preferably not more than 1/20, and still more preferably not more than 1/50. The ratio of S2/S1 of not more than 1/1000 is specifically preferred. In cases when not subjected to chemical sensitization or even when subjected to chemical sensitization, it is most preferred that the surface sensitivity after thermal development is substantially zero.

Specifically, the foregoing characteristics can be evaluated in the following manner. Thus, the photothermographic material is subjected to a heat treatment at a temperature of 123° C. for a period of 10 sec., followed by being exposed to white light (e.g., light at 4874K) or infrared light through an optical wedge for a prescribed period of time (within the range of 0.01 sec. to 30 min., e.g., 30 sec. using a tungsten light source) and being thermally developed at a temperature of 123° C. for a period of 10 sec. The thus processed photothermographic material is further subjected to densitometry with respect to developed silver image to prepare a characteristic curve comprising an abscissa of exposure and an ordinate of silver density and based thereon, sensitivity is determined, which is designated as S2. Separately, the photothermographic material is exposed and thermally developed in the same manner as above, without being subjected to the heat treatment to determine sensitivity, which is designated S1. The sensitivity is defined as the reciprocal of an exposure amount giving a density of a minimum density (or a density of the unexposed area) plus 1.0.

Silver halide may be incorporated into an light-sensitive layer by any means. It is general that silver halide grains (e.g., thermally convertible internal latent image type silver halide grains), which has been prepared in advance, added to a solution used for preparing an organic silver salt. In this case, preparation of silver halide and that of an organic silver salt are separately performed, making it easier to control the preparation thereof. Alternatively, silver halide grains and aliphatic carboxylic acid silver salt grains are separately prepared and immediately before coating, each of them may be added to a solution for the light-sensitive layer.

Silver halide grain emulsions used in the invention may be desalted after the grain formation, using the methods known in the art, such as the noodle washing method and flocculation process.

The silver halide is used preferably in an amount of 0.001 to 0.7 mol, and more preferably 0.03 to 0.5 mol per mol of organic silver salt.

Silver halide grains used in the invention can be subjected to chemical sensitization. In accordance with methods described in JP-A Nos. 2001-249428 and 2001-249426, for example, a chemical sensitization center (chemical sensitization speck) can be formed using compounds capable of releasing chalcogen such as sulfur or noble metal compounds capable of releasing a noble metal ion such as a gold ion. In this invention, it is preferred to conduct chemical sensitization with an organic sensitizer containing a chalcogen atom, as described below. Such a chalcogen atom-containing organic sensitizer is preferably a compound containing a group capable of being adsorbed onto silver halide and a labile chalcogen atom site. These organic sensitizers include, for example, those having various structures, as described in JP-A Nos. 60-150046, 4-109240, 11-218874, 11-218875, 11-218876 and 11-194447. Specifically preferred of these is at least a compound having a structure in which a chalcogen atom is attacked to a carbon or phosphorus atom through a double-bond. Specifically, heterocycle-containing thiourea derivatives and triphenylphosphine sulfide derivatives are preferred. A variety of techniques for chemical sensitization employed in silver halide photographic material for use in wet processing are applicable to conduct chemical sensitization, as described, for example, in T. H. James, The Theory of the Photographic Process, 4th Ed. (Macmillan Publishing Co., Ltd., 1977 and Nippon Shashin Gakai Ed., “Shashin Kogaku no Kiso (Ginene Shashin)” (Corona Co., Ltd., 1998). The amount of a chalcogen compound added as an organic sensitizer is variable, depending on the chalcogen compound to be used, silver halide grains and a reaction environment when subjected to chemical sensitization and is preferably 10⁻⁸ to 10⁻² mol, and more preferably 10⁻⁷ to 10⁻³ mol per mol of silver halide. In the invention, the chemical sensitization environment is not specifically limited but it is preferred to conduct chemical sensitization in the presence of a compound capable of eliminating a silver chalcogenide or silver specks formed on the silver halide grain or reducing the size thereof, or specifically in the presence of an oxidizing agent capable of oxidizing the silver specks, using a chalcogen atom-containing organic sensitizer. To conduct chemical sensitization under preferred conditions, the pAg is preferably 6 to 11, and more preferably 7 to 10, the pH is preferably 4 to 10 and more preferably 5 to 8, and the temperature is preferably not more than 30° C.

Chemical sensitization using the foregoing organic sensitizer is also preferably conducted in the presence of a spectral sensitizing dye or a heteroatom-containing compound capable of being adsorbed onto silver halide grains. Thus, chemical sensitization in the present of such a silver halide-adsorptive compound results in prevention of dispersion of chemical sensitization center specks, thereby achieving enhanced sensitivity and minimized fogging. Although there will be described spectral sensitizing dyes used in the invention, preferred examples of the silver halide-adsorptive, heteroatom-containing compound include nitrogen containing heterocyclic compounds described in JP-A No. 3-24537. In the heteroatom-containing compound, examples of the heterocyclic ring include a pyrazolo ring, pyrimidine ring, 1,2,4-triazole ring, 1,2,3-triazole ring, 1,3,4-thiazole ring, 1,2,3-thiadiazole ring, 1,2,4-thiadiazole ring, 1,2,5-thiadiazole ring, 1,2,3,4-tetrazole ring, pyridazine ring, 1,2,3-triazine ring, and a condensed ring of two or three of these rings, such as triazolotriazole ring, diazaindene ring, triazaindene ring and pentazaindene ring. Condensed heterocyclic ring comprised of a monocyclic hetero-ring and an aromatic ring include, for example, a phthalazine ring, benzimidazole ring indazole ring, and benzthiazole ring. Of these, an azaindene ring is preferred and hydroxy-substituted azaindene compounds, such as hydroxytriazaindene, tetrahydroxyazaindene and hydroxypentazaundene compound are more preferred. The heterocyclic ring may be substituted by substituent groups other than hydroxy group. Examples of the substituent group include an alkyl group, substituted alkyl group, alkylthio group, amino group, hydroxyamino group, alkylamino group, dialkylamino group, arylamino group, carboxy group, alkoxycarbonyl group, halogen atom and cyano group. The amount of the heterocyclic ring containing compound to be added, which is broadly variable with the size or composition of silver halide grains, is within the range of 10⁻⁶ to 1 mol, and preferably 10⁻⁴ to 10⁻¹ mol per mol silver halide.

As described earlier, silver halide grains can be subjected to noble metal sensitization using compounds capable of releasing noble metal ions such as a gold ion. Examples of usable gold sensitizers include chloroaurates and organic gold compounds. In addition to the foregoing sensitization, reduction sensitization can also be employed and exemplary compounds for reduction sensitization include ascorbic acid, thiourea dioxide, stannous chloride, hydrazine derivatives, borane compounds, silane compounds and polyamine compounds. Reduction sensitization can also conducted by ripening the emulsion while maintaining the pH at not less than 7 or the pAg at not more than 8.3. Silver halide to be subjected to chemical sensitization may be one which has been prepared in the presence of an organic silver salt, one which has been formed under the condition in the absence of the organic silver salt, or a mixture thereof.

When the surface of silver halide grains is subjected to chemical sensitization, it is preferred that an effect of the chemical sensitization substantially disappears after subjected to thermal development. An effect of chemical sensitization substantially disappearing means that the sensitivity of the photothermographic material, obtained by the foregoing chemical sensitization is reduced, after thermal development, to not more than 1.1 times that of the case not having been subjected to chemical sensitization. To allow the effect of chemical sensitization to disappear, it is preferred to allow an oxidizing agent such as a halogen radical-releasing compound which is capable of decomposing a chemical sensitization center (or chemical sensitization nucleus) through an oxidation reaction to be contained in an optimum amount in the light-sensitive layer and/or the light-insensitive layer. The content of an oxidizing agent is adjusted in light of oxidizing strength of an oxidizing agent and chemical sensitization effects.

The light-sensitive silver halide usable in this invention is preferably spectrally sensitized by adsorption of spectral sensitizing dyes. Examples of the spectral sensitizing dye include cyanine, merocyanine, complex cyanine, complex merocyanine, holo-polar cyanine, styryl, hemicyanine, oxonol and hemioxonol dyes, as described in JP-A Nos. 63-159841, 60-140335, 63-231437, 63-259651, 63-304242, 63-15245; U.S. Pat. Nos. 4,639,414, 4,740,455, 4,741,966, 4,751,175 and 4,835,096. Usable sensitizing dyes are also described in Research Disclosure (hereinafter, also denoted as RD) 17643, page 23, sect. IV-A (December, 1978), and ibid 18431, page 437, sect. X (August, 1978). It is preferred to use sensitizing dyes exhibiting spectral sensitivity suitable for spectral characteristics of light sources of various laser imagers or scanners. Examples thereof include compounds described in JP-A Nos. 9-34078, 9-54409 and 9-80679.

Useful cyanine dyes include, for example, cyanine dyes containing a basic nucleus, such as thiazoline, oxazoline, pyrroline, pyridine, oxazole, thiazole, selenazole and imidazole nuclei. Useful merocyanine dyes preferably contain, in addition to the foregoing nucleus, an acidic nucleus such as thiohydantoin, rhodanine, oxazolidine-dione, thiazoline-dione, barbituric acid, thiazolinone, malononitrile and pyrazolone nuclei. In the invention, there are also preferably used sensitizing dyes having spectral sensitivity within the infrared region. Examples of the preferred infrared sensitizing dye include those described in U.S. Pat. Nos. 4,536,478, 4,515,888 and 4,959,294.

A photothermographic material used in this invention preferably contains at least one of sensitizing dyes represented by formula (1) and sensitizing dyes-represented by formula (2), as disclosed in U.S. Patent Application publication No. 20040224266, and more preferably at least one of sensitizing dyes represented by formula (5) and sensitizing dyes represented by formula (6). The combined use of sensitizing dyes represented by formula (5) and sensitizing dyes represented by formula (6) results in improved dependency on the wavelength of exposing light at the time of exposure.

The infrared-sensitizing dyes and spectral sensitizing dyes described above can be readily synthesized according to the methods described in F. M. Hammer, The Chemistry of Heterocyclic Compounds vol.18, “The-cyanine Dyes and Related Compounds” (A. Weissberger ed. Interscience Corp., New York, 1964).

The infrared sensitizing dyes can be added at any time after preparation of silver halide. For example, the dye can be added to a light sensitive emulsion containing silver halide grains/organic silver salt grains in the form of by dissolution in a solvent or in the form of a fine particle dispersion, so-called solid particle dispersion. Similarly to the heteroatom containing compound having adsorptivity to silver halide, after adding the dye prior to chemical sensitization and allowing it to be adsorbed onto silver halide grains, chemical sensitization is conducted, thereby preventing dispersion of chemical sensitization center specks and achieving enhanced sensitivity and minimized fogging.

These sensitizing dyes may be used alone or in combination thereof. The combined use of sensitizing dyes is often employed for the purpose of supersensitization, expansion or adjustment of the light-sensitive wavelength region. A super-sensitizing compound, such as a dye which does not exhibit spectral sensitization or substance which does not substantially absorb visible light may be incorporated, in combination with a sensitizing dye, into the emulsion containing silver halide grains and organic silver salt grains used in photothermographic imaging materials of the invention.

Useful sensitizing dyes, dye combinations exhibiting super-sensitization and materials exhibiting supersensitization are described in RD17643 (published in December, 1978), IV-J at page 23, JP-B 9-25500 and 43-4933 (herein, the term, JP-B means published Japanese Patent) and JP-A 59-19032, 59-192242 and 5-341432. In the invention, an aromatic heterocyclic mercapto compound represented by the following formula (6) is preferred as a supersensitizer:
Ar—SM
wherein M is a hydrogen atom or an alkali metal atom; Ar is an aromatic ring or condensed aromatic ring containing a nitrogen atom, oxygen atom, sulfur atom, selenium atom or tellurium atom. Such aromatic heterocyclic rings are preferably benzimidazole, naphthoimidazole, benzthiazole, naphthothiazole, benzoxazole, naphthooxazole, benzoselenazole, benzotellurazole, imidazole, oxazole, pyrazole, triazole, triazines, pyrimidine, pyridazine, pyrazine, pyridine, purine, and quinoline. Other aromatic heterocyclic rings may also be included.

A disulfide compound which is capable of forming a mercapto compound when incorporated into a dispersion of an organic silver salt and/or a silver halide grain emulsion is also included in the invention. In particular, a preferred example thereof is a disulfide compound represented by the following formula:
Ar—S—S—Ar
wherein Ar is the same as defined in the mercapto compound represented by the formula described earlier.

The aromatic heterocyclic rings described above may be substituted with a halogen atom (e.g., Cl, Br, I), a hydroxy group, an amino group, a carboxy group, an alkyl-group (having one or more carbon atoms, and preferably 1 to 4 carbon atoms) or an alkoxy group (having one or more carbon atoms, and preferably 1 to 4 carbon atoms) In addition to the foregoing supersensitizers, there are usable heteroatom-containing macrocyclic compounds described in JP-A No. 2001-330918, as a supersensitizer. The supersensitizer is incorporated into a light-sensitive layer containing organic silver salt and silver halide grains, preferably in an amount of 0.001 to 1.0 mol, and more preferably 0.01 to 0.5 mol per mol of silver.

It is preferred that a sensitizing dye is allowed to adsorb onto the surface of light-sensitive silver halide grains to achieve spectral sensitization and the spectral sensitization effect substantially disappears after being subjected to thermal development. The effect of spectral sensitization substantially disappearing means that the sensitivity of the photothermographic material which has been spectrally sensitized with a sensitizing dye and optionally a supersensitizer, is reduced, after thermal development, to not more than 1.1 times that of the photothermographic material which has not been spectrally sensitized. To allow the effect of spectral sensitization to disappear, it is preferred to use a spectral sensitizing dye easily releasable from silver halide grains and/or to allow an oxidizing agent such as a halogen radical-releasing compound which is capable of decomposing a spectral sensitizing dye through an oxidation reaction to be contained in an optimum amount in the light-sensitive layer and/or the light-insensitive layer. The content of an oxidizing agent is adjusted in light of oxidizing strength of the oxidizing agent and its spectral sensitization effects.

Reducing agents used in this invention can reduce silver ions in the light-sensitive layer are also called a developer or a developing agent. Compounds usable as a reducing agent are those as below.

In this invention, the preferred reducing agent for silver ions is a compound represented by the following formula (1), which may be used alone or in combination with other reducing agents: 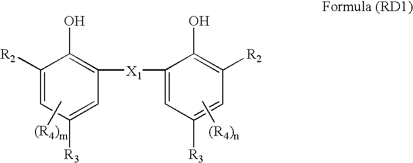
X₁ represents a chalcogen atom or CHR₁ in which R₁ is a hydrogen atom, a halogen atom, an alkyl group, an alkenyl group, an aryl group or a heterocyclic group; both R₂ are each an alkyl group, which may be the same or different; R₃ is a hydrogen atom or a group capable of being substituted on a benzene ring; R₄ is a group capable of being substituted on a benzene ring; m and n are each an integer of 0 to 2.

Of the foregoing compounds of formula (RD1), a high-active reducing agent having R₂ of secondary or tertiary alkyl group {which is denoted as a compound of formula (RD1a)} is preferred. Thus, the use of such a reducing agent results in a photothermographic material exhibiting superior image lightfastness. In this invention, the combined use of a compound of formula (RD1a) and a compound represented by the following formula (RD2) is preferred to achieve desired image color: 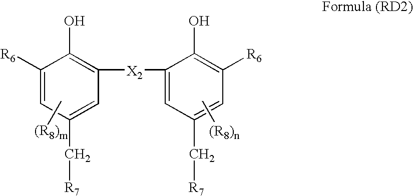
wherein X₂ represents a chalcogen atom or CHR₅ in which R₅ is a hydrogen atom, a halogen atom, an alkyl group, an alkenyl group, an aryl group or a heterocyclic group; both R₆ are each an alkyl group, which may be the same or different, provided that R₆ is not a secondary or tertiary alkyl group; R₇ is a hydrogen atom or a group capable of being substituted on a benzene ring; R₈ is a group capable of being substituted on a benzene ring; m and n are each an integer of 0 to 2.

The weight ratio of compound of formula (RD1a) to compound of formula (RD2) is preferably in the range of from 5:95 to 45:55, and more preferably from 10:90 to 40:60.

In the formula (RD1), X₁ represents a chalcogen atom or CHR₁. Specifically listed as chalcogen atoms are a sulfur atom, a selenium atom, and a tellurium atom. Of these, a sulfur atom is preferred; R₁ in CHR₁ represents a hydrogen atom, a halogen atom, an alkyl group, an alkenyl group, an alkynyl group, an aryl group or a heterocyclic group. Halogen atoms include, for example, a fluorine atom, a chlorine atom, and a bromine atom. Alkyl groups are an alkyl groups having 1-20 carbon atoms and specific examples thereof include a methyl group, an ethyl group, a propyl group, a butyl group, a hexyl group, a heptyl group and a cycloalkyl group. Examples of alkenyl groups are, a vinyl group, an allyl group, a butenyl group, a hexenyl group, a hexadienyl group, an ethenyl-2-propenyl group, a 3-butenyl group, a 1-methyl-3-propenyl group, a 3-pentenyl group, a 1-methyl-3-butenyl group and a cyclohexenyl group. Examples of aryl groups are, a phenyl group and a naphthyl group. Examples of heterocyclic groups are, a thienyl group, a furyl group, an imidazolyl group, a pyrazolyl group and a pyrrolyl group.

These groups may have a substituent. Listed as the substituents are a halogen atom (for example, a fluorine atom, a chlorine atom, or a bromine atom), a cycloalkyl group (for example, a cyclohexyl group or a cyclobutyl group), a cycloalkenyl group (for example, a 1-cycloalkenyl group or a 2-cycloalkenyl group), an alkoxy group (for example, a methoxy group, an ethoxy group, or a propoxy group), an alkylcarbonyloxy group (for example, an acetyloxy group), an alkylthio group (for example, a methylthio group or a trifluoromethylthio group), a carboxyl group, an alkylcarbonylamino group (for example, an acetylamino group), a ureido group (for example, a methylaminocarbonylamino group), an alkylsulfonylamino group (for example, a methanesulfonylamino group), an alkylsulfonyl group (for example, a methanesulfonyl group and a trifluoromethanesulfonyl group), a carbamoyl group (for example, a carbamoyl group, an N,N-dimethylcarbamoyl group, or an N-morpholinocarbonyl group), a sulfamoyl group (for example, a sulfamoyl group, an N,N-dimethylsulfamoyl group, or a morpholinosulfamoyl group), a trifluoromethyl group, a hydroxyl group, a nitro group, a cyano group, an alkylsulfonamide group (for example, a methanesulfonamide group or a butanesulfonamide group), an alkylamino group (for example, an amino group, an N,N-dimethylamino group, or an N,N-diethylamino group), a sulfo group, a phosphono group, a sulfite group, a sulfino group, an alkylsulfonylaminocarbonyl group (for example, a methanesulfonylaminocarbonyl group or an ethanesulfonylaminocarbonyl group), an alkylcarbonylaminosulfonyl group (for example, an acetamidosulfonyl group or a methoxyacetamidosulfonyl group), an alkynylaminocarbonyl group (for example, an acetamidocarbonyl group or a methoxyacetamidocarbonyl group), and an alkylsulfinylaminocarbonyl group (for example, a methanesulfinylaminocarbonyl group or an ethanesulfinylaminocarbonyl group). Further, when at least two substituents are present, they may be the same or different. Most preferred substituent is an alkyl group.

R₂ represents an alkyl group. The alkyl groups are preferably those having 1 to 20 carbon atoms, which may be substituted or unsubstituted. Specific examples thereof include a methyl, ethyl, i-propyl, butyl, i-butyl, t-butyl, t-pentyl, t-octyl, cyclohexyl, 1-methylcyclohexyl, or 1-methylcyclopropyl.

Substituents of the alkyl group are not particularly limited and include, for example, an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, and a halogen atom. In addition, (R₄)ₙ and (R₄)ₘ may form a saturated ring. R₂ is preferably a secondary or tertiary alkyl group and preferably has 2-20 carbon atoms. R₂ is more preferably a tertiary alkyl group, is still more preferably a t-butyl group, a t-pentyl group, or a methylcyclohexyl group, and is most preferably a t-butyl group.

R₃ represents a hydrogen atom or a group capable of being substituted to a benzene ring. Listed as groups capable of being substituted to a benzene ring are, for example, a halogen atom such as fluorine, chlorine, or bromine, an alkyl group, an aryl group, a cycloalkyl group, an alkenyl group, a cycloalkenyl group, an alkynyl group, an amino group, an acyl group, an acyloxy group, an acylamino group, a sulfonylamino group, a sulfamoyl group, a carbamoyl group, an alkylthio group, a sulfonyl group, an alkylsulfonyl group, a sulfonyl group, a cyano group, and a heterocyclic group.

R₃ is preferably methyl, ethyl, i-propyl, t-butyl, cyclohexyl, 1-methylcyclohexyl, or 2-hydroxyethyl. Of these, 2-hydroxyethyl is more preferred.

These groups may further have a substituent. There may be employed as such substituents those listed in aforesaid R₁. R₃ is an alkyl group containing a hydroxyl group or its precursor group and having carbon atoms of 1 to 20, preferably 1 to 5; and 2-hydroxyethyl is specifically preferred. Specifically preferred combination of R₂ and R₃ is R₂ of a tertiary alkyl group (e.g., t-butyl, 1-methylcyclohexyl) and R₃ of a primary alkyl group containing hydroxyl group or its precursor group (e.g., 2-hydroxyethyl). Plural R₂s or R₃s may be the same or different.

R₄ represents a group capable of being substituted on a benzene ring. Specific examples include an alkyl group having 1 to 25 carbon atoms (e.g., methyl, ethyl, propyl, i-propyl, t-butyl, pentyl, hexyl, or cyclohexyl), a halogenated alkyl group (e.g., trifluoromethyl or perfluorooctyl), a cycloalkyl group (e.g., cyclohexyl or cyclopentyl); an alkynyl group (e.g., propargyl), a glycidyl group, an acrylate group, a methacrylate group, an aryl group (e.g., phenyl), a heterocyclic group (e.g., pyridyl, thiazolyl, oxazolyl, imidazolyl, furyl, pyrrolyl, pyradinyl, pyrimidyl, pytidadinyl, selenazolyl, piperidinyl, sulforanyl, piperidinyl, pyrazolyl, or tetrazolyl), a halogen atom (e.g., chlorine, bromine, iodine or fluorine), an alkoxy group (e.g., methoxy, ethoxy, propyloxy, pentyloxy, cyclopentyloxy, hexyloxy, or cyclohexyloxy), an aryloxy group (e.g., phenoxy), an alkoxycarbonyl group (e.g., methyloxycarbonyl, ethyloxycarbonyl, or butyloxycarbonyl), an aryloxycarbonyl group (e.g., phenyloxycarbonyl), a sulfonamido group (e.g., methanesulfonamido, ethanesulfonamido, butanesulfonamido, hexanesulfonamido, cyclohexabesulfonamido, benzenesulfonamido), sulfamoyl group (e.g., aminosulfonyl, methyaminosulfonyl, dimethylaminosulfonyl, butylaminosulfonyl, hexylaminosulfonyl, cyclohexylaminosufonyl, phenylaminosulfonyl, or 2-pyridylaminosulfonyl), a urethane group (e.g., methylureido, ethylureido, pentylureido, cyclopentylureido, phenylureido, or 2-pyridylureido), an acyl group (e.g., acetyl, propionyl, butanoyl, hexanoyl, cyclohexanoyl, benzoyl, or pyridinoyl), a carbamoyl group (e.g., aminocarbonyl, methylaminocarbonyl, dimethylaminocarbonyl, propylaminocarbonyl, a pentylaminocarbonyl group, cyclohexylaminocarbonyl, phenylaminocarbonyl, or 2-pyridylaminocarbonyl), an amido group (e.g., acetamide, propionamide, butaneamide, hexaneamide, or benzamide), a sulfonyl group (e.g., methylsulfonyl, ethylsulfonyl, butylsulfonyl, cyclohexylsulfonyl, phenylsulfonyl, or 2-pyridylsulfonyl), an amino group (e.g., amino, ethylamino, dimethylamino, butylamino, cyclopentylamino, anilino, or 2-pyridylamino), a cyano group, a nitro-group, a sulfo group, a carboxyl group, a hydroxyl group, and an oxamoyl group. Further, these groups may further be substituted with these groups. Each of n and m represents an integer of from 0 to 2. However, the most preferred case is that both n and m are 0. Plural R₄s may be the same or different.

Further, R₄ may form a saturated ring together with R₂ and R₃. R₄ is preferably a hydrogen atom, a halogen atom, or an alkyl group, and is more preferably a hydrogen atom.

In the formula (2), R₅ is the same as defined in R₁, R₇ is the same as defined in R₃, and R₈ is the same as defined in R₄. Both R₆ are each an alkyl group, which may the same or different, provided that R₆ is not a secondary or tertiary alkyl group. Thus, R₆ is preferably an alkyl group having 1 to 20 carbon atoms, which may be substituted. Specific examples thereof include methyl, ethyl, propyl and butyl.

Substituents of the alkyl group are not specifically limited but examples thereof include an aryl group, hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group and a halogen atom. R₆ may combine with (R₈)ₙ or (R₈)ₘ to form a saturated ring. R₆ is preferably methyl, which is most preferred compound of formula (RD2). The compounds are those which satisfy formula (S) and formula (T) described in European Patent No. 1,278,101, specifically, compounds (1-24), (1-28) to (1-54) and (1-56) to (1-75) are cited.

Specific examples of the compound of formula (RD1) or (RD2) are shown below but are not limited to these.

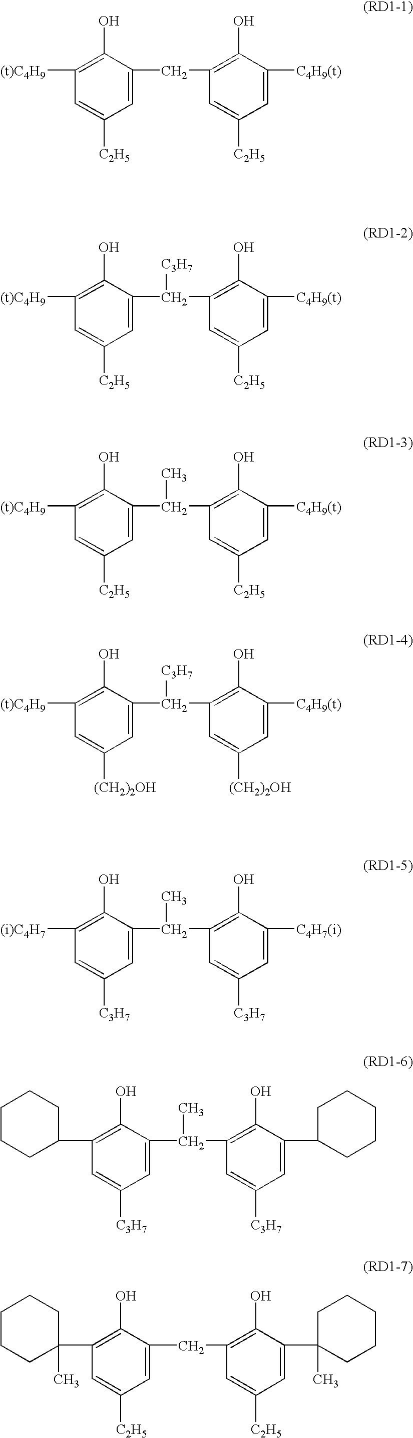

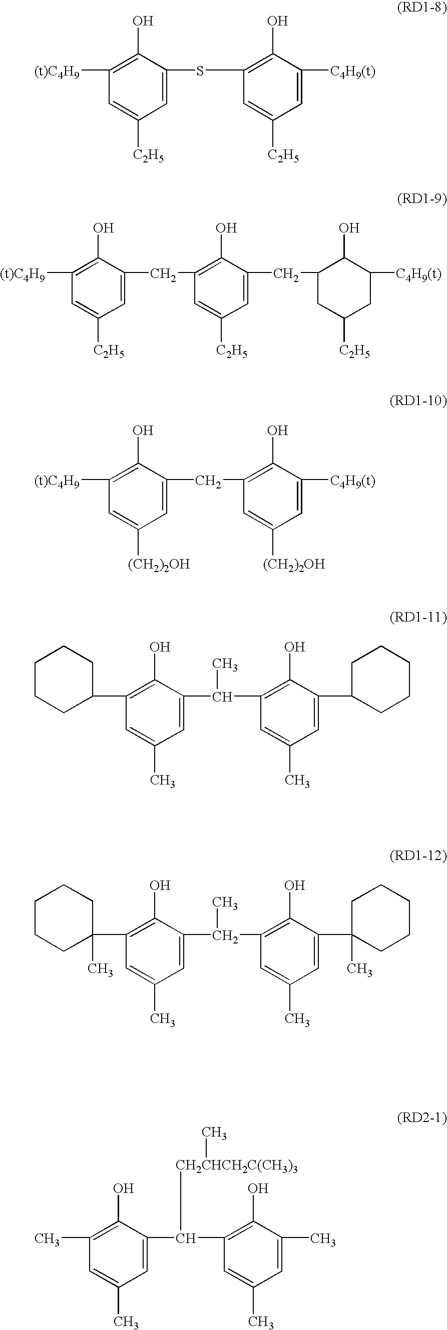

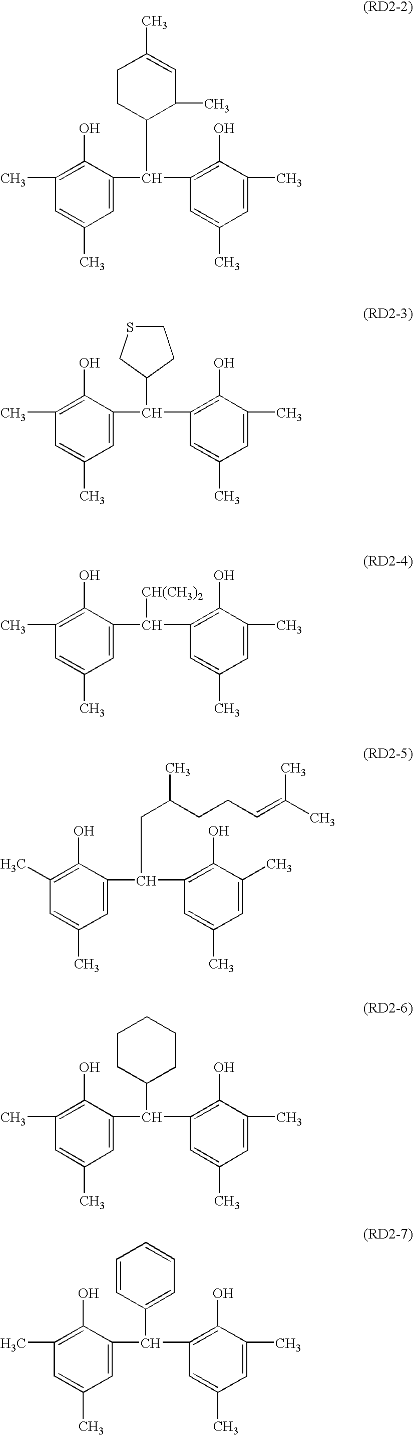

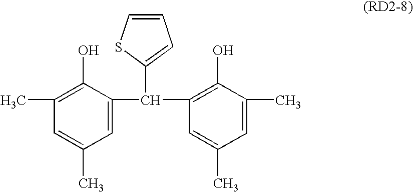

Bisphenol compounds of formula (RD1) or (RD2) can readily be synthesized according to conventionally known methods.

Examples of reducing agents which are usable in combination with the reducing agent described above are described in U.S. Pat. Nos. 3,770,448, 3,773,512, and 3,593,863; RD 17029 and 29963; JP-A Nos. 11-119372 and 2002-62616.

Reducing-agents including the compounds of formula (RD1) are incorporated preferably in an amount of 1×10⁻² to 10 mol per mol of silver, and more preferably 1×10⁻² to 1.5 mol.

The color tone of images obtained by thermal development of the imaging material is described.

It has been pointed out that in regard to the output image tone for medical diagnosis, cold image tone tends to result in more accurate diagnostic observation of radiographs. The cold image tone, as described herein, refers to pure black tone or blue black tone in which black images are tinted to blue. On the other hand, warm image tone refers to warm black tone in which black images are tinted to brown.

The tone is more described below based on an expression defined by a method recommended by the Commission Internationale de l'Eclairage (CIE) in order to define more quantitatively.

“Colder tone” as well as “warmer tone”, which is terminology of image tone, is expressed, employing minimum density Dₘᵢₙ and hue angle h_{ab} at an optical density D of 1.0. The hue angle h_{ab} is obtained by the following formula, utilizing color specifications a* and b* of L*a*b* Color Space which is a color space perceptively having approximately a uniform rate, recommended by Commission Internationale de l'Eclairage (CIE) in 1976.
h_{ab}=tan⁻¹(b*/a*)

In this invention, h_{ab} is preferably in the range of 180 degrees<h_{ab}<270 degrees, is more preferably in the range of 200 degrees<h_{ab}<270 degrees, and is most preferably in the range of 220 degrees<h_{ab}<260 degrees.

This finding is also disclosed in JP-A 2002-6463.

Incidentally, as described, for example, in JP-A No. 2000-29164, it is conventionally known that diagnostic images with visually preferred color tone are obtained by adjusting, to the specified values, u* and v* or a* and b* in CIE 1976 (L*u*v*) color space or (L*a*b*) color space near an optical density of 1.0.

Extensive investigation was performed for the silver salt photothermographic material according to the present invention. As a result, it was discovered that when a linear regression line was formed on a graph in which in the CIE 1976 (L*u*v*) color space or the (L*a*b*) color space, u* or a* was used as the abscissa and v* or b* was used as the ordinate, the aforesaid materiel exhibited diagnostic properties which were equal to or better than conventional wet type silver salt photosensitive materials by regulating the resulting linear regression line to the specified range. The condition ranges of the present invention will now be described.

(1) It is preferable that the coefficient of determination value R² of the linear regression line, which is made by arranging u* and v* in terms of each of the optical densities of 0.5, 1.0, and 1.5 and the minimum optical density, is also from 0.998 to 1.000.

The value v* of the intersection point of the aforesaid. linear regression line with the ordinate is −5-+5; and gradient (v*/u*) is 0.7 to 2.5.

(2) The coefficient of determination value R² of the linear regression line is 0.998 to 1.000, which is formed in such a manner that each of optical density of 0.5, 1.0, and 1.5 and the minimum optical density of the aforesaid imaging material is measured, and a* and b* in terms of each of the above optical densities are arranged in two-dimensional coordinates in which a* is used as the abscissa of the CIE 1976 (L*a*b*) color space, while.b* is used as the ordinate of the same. In addition, value b* of the intersection point of the aforesaid linear regression line with the ordinate is from −5 to +5, while gradient (b*/a*) is from 0.7 to 2.5.

A method for making the above-mentioned linear regression line, namely one example of a method for determining u* and v* as well as a* and b* in the CIE 1976 color space, will now be described.

By employing a thermal development apparatus, a 4-step wedge sample including an unexposed portion and optical densities of 0.5, 1.0, and 1.5 is prepared. Each of the wedge density portions prepared as above is determined employing a spectral chronometer (for example, CM-3600d, manufactured by Minolta Co., Ltd.) and either u* and v* or a* and b* are calculated. Measurement conditions are such that an F7 light source is used as a light source, the visual field angle is 10 degrees, and the transmission measurement mode is used. Subsequently, either measured u* and v* or measured a* and b* are plotted on the graph in which u* or a* is used as the abscissa, while v* or b* is used as the ordinate, and a linear regression line is formed, whereby the coefficient of determination value R² as well as intersection points and gradients are determined.

The specific method enabling to obtain a linear regression line having the above-described characteristics will be described below. In this invention, by regulating the added amount of the developing agents, silver halide grains, and aliphatic carboxylic acid silver, which are directly or indirectly involved in the development reaction process, it is possible to optimize the shape of developed silver so as to result in the desired tone. For example, when the developed silver is shaped to dendrite, the resulting image tends to be bluish, while when shaped to filament, the resulting imager tends to be yellowish. Namely, it is possible to adjust the image tone taking into account the properties of shape of developed silver.

Usually, image toning agents such as phthalazinone or a combinations of phthalazine with phthalic acids, or phthalic anhydride are employed. Examples of suitable image toning agents are disclosed in Research Disclosure, Item 17029, and U.S. Pat. Nos. 4,123,282, 3,994,732, 3,846,136, and 4,021,249.

In this invention, when rapid processing was performed using a compact laser image having a cooling section of a short length, it was proved that silver image tone was greatly different from preferable color. To overcome such a problem, conventional toning agents were insufficient and there were needed compounds capable of performing imagewise dye formation upon thermal development to form a dye image (e.g., leuco dyes or coupler compounds). As such a compound is preferable one capable of forming a dye image exhibiting an absorption peak at a wavelength of 360 to 450 nm upon thermal development or one capable of forming a dye image exhibiting an absorption peak at a wavelength of 600 to 700 nm upon thermal development. It is specifically preferred to contain both compounds to achieve superior image tone. Thus, it is preferable to control color tone employing couplers disclosed in JP-A No. 11-288057 and EP 1134611A2 as well as leuco dyes detailed below.

The photothermographic material relating to this invention can employ leuco dyes to control image tone, as described above. Leuco dyes are employed in the silver salt photothermographic materials relating to this invention. There may be employed, as leuco dyes, any of the colorless or slightly tinted compounds which are oxidized to form a colored state when heated at temperatures of about 80 to about 200° C. for about 0.5 to about 30 seconds. It is possible to use any of the leuco dyes which are oxidized by silver ions to form dyes. Compounds are useful which are sensitive to pH and are oxidizable to a colored state.

Representative leuco dyes suitable for the use in the present invention are not particularly limited. Examples include bisphenol leuco dyes, phenol leuco dyes, indoaniline leuco dyes, acrylated azine leuco dyes, phenoxazine leuco dyes, phenodiazine leuco dyes, and phenothiazine leuco dyes. Further, other useful leuco dyes are those disclosed in U.S. Pat. Nos. 3,445,234, 3,846,136, 3,994,732, 4,021,249, 4,021,250, 4,022,617, 4,123,282, 4,368,247, and 4,461,681, as well as JP-A Nos. 50-36110, 59-206831, 5-204087, 11-231460, 2002-169249, and 2002-236334.

In order to control images to specified color tones, it is preferable that various color leuco dyes are employed individually or in combinations of a plurality of types. In the present invention, for minimizing excessive yellowish color tone due to the use of highly active reducing agents, as well as excessive reddish images especially at a density of at least 2.0 due to the use of minute silver halide grains, it is preferable to employ leuco dyes which change to cyan. Further, in order to achieve precise adjustment of color tone, it is further preferable to simultaneously use yellow leuco dyes and other leuco dyes which change to cyan.

It is preferable to appropriately control the density of the resulting color while taking into account the relationship with the color tone of developed silver itself. In this invention, dye formation is performed so as to have a reflection density of 0.01 to 0.05 or a transmission density of 0.005 to 0.50, and the image-tone is adjusted so as to form images exhibiting tone falling within the foregoing tone range. In the present invention, color formation is performed so that the sum of maximum-densities at the maximum adsorption wavelengths of dye images formed by leuco dyes is customarily 0.01 to 0.50, is preferably 0.02 to 0.30, and is most preferably 0.03 to 0.10. Further, it is preferable that images be controlled within the preferred color tone range described below.

In this invention, particularly preferably employed as yellow forming leuco dyes are color image forming agents represented by the following formula (YA) which increase absorbance between 360 and 450 nm via oxidation: 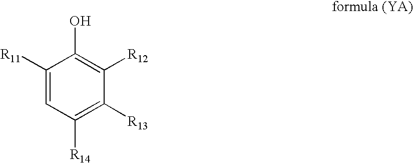
wherein R₁₁ is a substituted or unsubstituted alkyl group; R₁₂ is a hydrogen atom or a substituted or unsubstituted alkyl or acyl group, provided that R₁₁ and R₁₂ are not 2-hydroxyphenylmethyl; R₁₃ is a hydrogen atom or a substituted or unsubstituted alkyl group; R₁₄ is a group capable of being substituted on a benzene ring.

The compounds represented by formula (YA) will now be detailed. In the Formula (YA), R₁₁ is a substituted or unsubstituted alkyl group, provided that when R₁₂ is a substituent other than a hydrogen atom, R₁₁ is an alkyl group. In the foregoing formula (YA), the alkyl groups represented by R₁ are preferably those having 1 to 30 carbon atoms, which may have a substituent. Specifically preferred is methyl, ethyl, butyl, octyl, i-propyl, t-butyl, t-octyl, t-pentyl, sec-butyl, cyclohexyl, or 1-methyl-cyclohexyl. Groups (i-propyl, i-nonyl, t-butyl, t-amyl, t-octyl, cyclohexyl, 1-methyl-cyclohexyl or adamantyl) which are three-dimensionally larger than i-propyl are preferred. Of these, preferred are secondary or tertiary alkyl groups and t-butyl, t-octyl, and t-pentyl, which are tertiary alkyl groups, are particularly preferred. Examples of substituents which R₁ may have include a halogen atom, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, and a phosphoryl group.

R₁₂ represents a hydrogen atom, a substituted or unsubstituted alkyl group, or an acylamino group. The alkyl group represented by R₂ is preferably one having 1-30 carbon atoms, while the acylamino group is preferably one having 1-30 carbon atoms. Of these, description for the alkyl group is the same as for aforesaid R11₁.

The acylamino group represented by R₂ may be unsubstituted or have a substituent. Specific examples thereof include an acetylamino group, an alkoxyacetylamino group, and an aryloxyacetylamino group. R₁₂ is preferably a hydrogen atom or an unsubstituted group having 1 to 24 carbon atoms, and specifically listed are methyl, i-propyl, and t-butyl. Further, neither R₁ nor R₂ is a 2-hydroxyphenylmethyl group.

R₁₃ represents a hydrogen atom, and a substituted or unsubstituted alkyl group. Preferred as alkyl groups are those having 1 to 30 carbon atoms. Description for the above alkyl groups is the same as for R₁₁. Preferred as R₁₃ are a hydrogen atom and an unsubstituted alkyl group having 1 to 24 carbon atoms, and specifically listed are methyl, i-propyl and t-butyl. It is preferable that either R₁₂ or R₁₃ represents a hydrogen atom.

R₁₄ represents a group capable of being substituted to a benzene ring, and represents the same group which is described for substituent R₄, for example, in aforesaid Formula (RED). R₄ is preferably a substituted or unsubstituted alkyl group having 1 to 30 carbon atoms, as well as an oxycarbonyl group having 2 to 30 carbon atoms. The alkyl group having 1 to 24 carbon atoms is more preferred. As substituents of the alkyl group are cited an aryl group, an amino group, an alkoxy group, an oxycarbonyl group, an acylamino group, an acyloxy group, an imido group, and a ureido group of these, more preferred are an aryl group, an amino group, an oxycarbonyl group, and an alkoxy group. The substituent of the alkyl group may be substituted with any of the above alkyl groups.

Among the compounds represented by the foregoing formula (YA), preferred compounds are bis-phenol compounds represented by the following formula (YB): 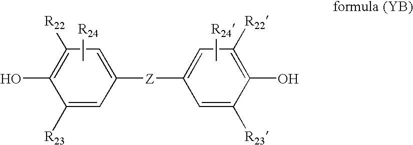
wherein, Z represents a —S— or —C(R₂₁)(R_{21′})— group. R₂₁ and R_{21′} each represent a hydrogen atom or a substituent. The substituents represented by R₂₁ and R_{21′} are the same substituents listed for R₂₁ in the aforementioned Formula (RED). R₂₁ and R_{21′} are preferably a hydrogen atom or an alkyl group.

R₂₂, R₂₃, R₂₂′ and R₂₃′ each represent a substituent. The substituents represented by R₂₂, R₂₃, R₂₂′ and R₂₃′ are the same substituents listed for R₂ and R₃ in the afore-mentioned formula (1). R₂₂, R₂₃, R₂₂′ and R₂₃′ are preferably, an alkyl group, an alkenyl group, an alkynyl group, an aryl group, a heterocyclic group, and more preferably, an alkyl group. Substituents on the alkyl group are the same substituents listed for the substituents in the aforementioned Formula (RD1). R₂₂, R₂₃, R₂₂′ and R₂₃′ are more preferably tertiary alkyl groups such as t-butyl, t-amino, t-octyl and 1-methylcyclohexyl.

R₂₄ and R_{24′} each represent a hydrogen atom or a substituent, and the substituents are the same substituents listed for R₄ in the afore-mentioned formula (RD1).

Examples of the bis-phenol compounds represented by the formulas (YA) and (YB) are, the compounds disclosed in JP-A No. 2002-169249, Compounds (II-1) to (II-40), paragraph Nos. [0032]-[0038]; and EP 1211093, Compounds (ITS-1) to (ITS-12), paragraph No. [0026].

Specific examples of bisphenol compounds represented by formulas (Ya) and (YB) are shown below.

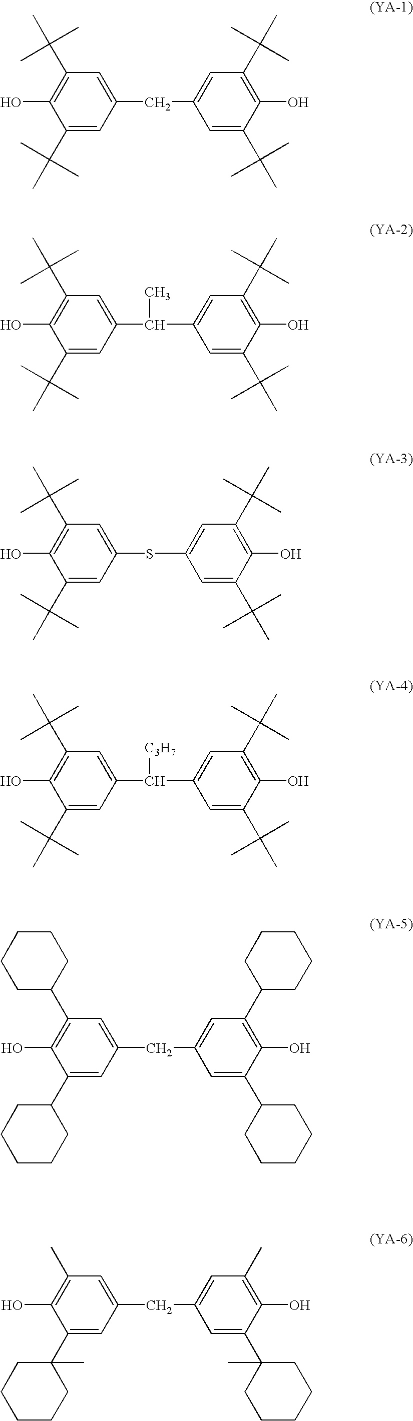

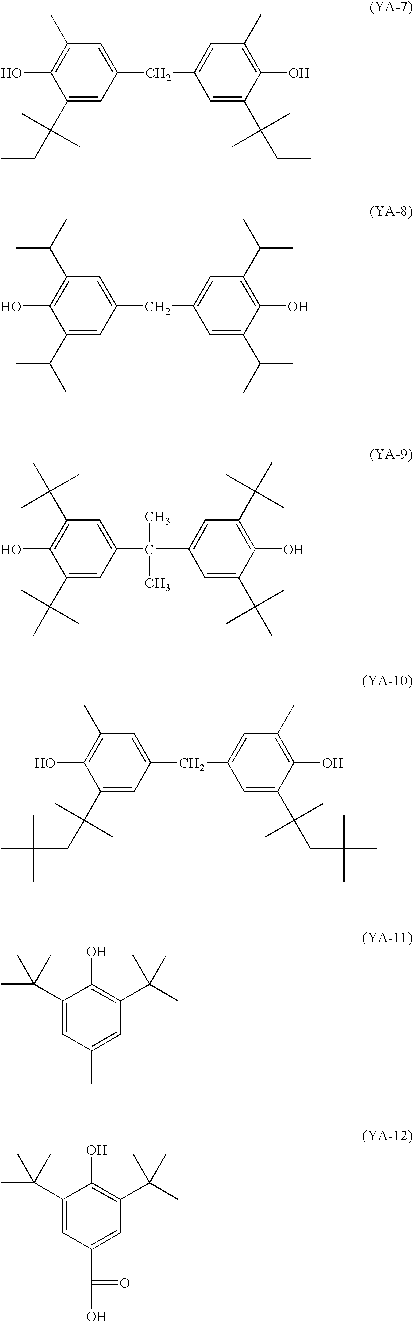

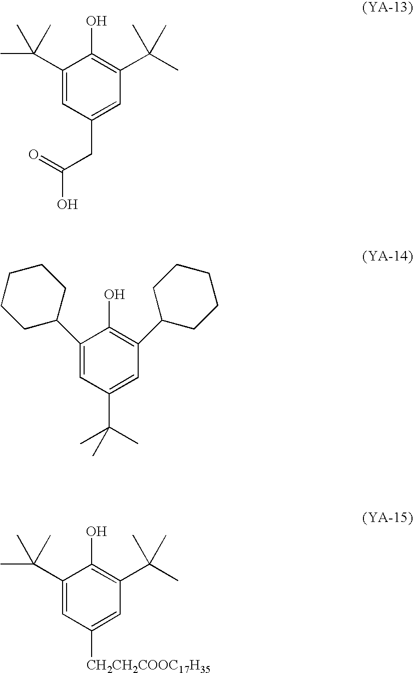

An amount of an incorporated compound represented by formula (YA), which is hindered phenol compound and include compound of formula (YB), is; usually, 0.00001 to 0.01 mol, and preferably, 0.0005 to 0.01 mol, and more preferably, 0.001 to 0.008 mol per mol of Ag.

A yellow dye forming leuco dye is incorporated preferably in a molar ratio of 0.00001 to 0.2, and more preferably 0.005 to 0.1, based on the total amount of reducing agents of formulas (RD1) and (RD2).

Besides the foregoing yellow dye forming leuco dyes, cyan dye forming leuco dyes are also usable in a photothermographic material to control image tone.

Cyan dye forming leuco dyes will be described hereinafter. A leuco dye is preferably a colorless or slightly colored compound which is capable of forming color upon oxidation when heated at 80 to 200° C. for 5 to 30 sec. There is also usable any leuco dye capable of forming a dye upon oxidation by silver ions. A compound which is sensitive to pH and being oxidized to a colored form.

Cyan forming leuco dyes will now be described. In the present invention, particularly preferably employed as cyan forming leuco dyes are color image forming agents which increase absorbance between 600 and 700 nm via oxidation, and include the compounds described in JP-A No. 59-206831 (particularly, compounds of λmax in the range of 600-700 nm), compounds represented by formulas (I) through (IV) of JP-A No. 5-204087 (specifically, compounds (1) through (18) described in paragraphs [0032] through [0037]), and compounds represented by formulas 4-7 (specifically, compound Nos. 1 through 79 described in paragraph [0105]) of JP-A No. 11-231460.

Cyan dye forming leuco dyes usable in a photothermographic material relating to this invention are compounds represented by the following formula (CLA) or (CLB). The compound of formula (CLB), which exhibits a high dye forming efficiency, can control image tone at a relative low quantity and exhibits superior image fastness.

There will be further described compounds represented by formula (CLA) or (CLB).

A compound of formula (CLA) is as below: 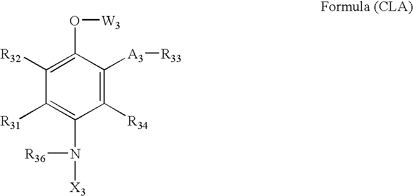
wherein R₃₁ and R₃₂ each represent a hydrogen atom, a substituted or unsubstituted alkyl group, an NHCO—R₃₀ group wherein R₃₀ is an alkyl group, an aryl group, or a heterocyclic group, while R₃₁ and R₃₂ may bond to each other to form an aliphatic hydrocarbon ring, an aromatic hydrocarbon ring, or a heterocyclic ring; A₃ represents-NHCO—, —CONH—, or —NHCONH—; R₃₃ represents-a substituted or unsubstituted alkyl group, an aryl group, or a heterocyclic group, or —A—R₃₃ is a hydrogen atom; W represents a hydrogen atom or a —CONHR₅— group, —COR₃₅ or a —CO—O—R₃₅ group wherein R₃₅ represents a substituted or unsubstituted alkyl group, an aryl group, or a heterocyclic group; R₃₄ represents a hydrogen atom, a halogen atom, a substituted or unsubstituted alkyl group, an alkoxy group, a carbamoyl group, or a nitrile group; R₃₆ represents a —CONH—R₃₇ group, a —CO—R₃₇ group, or a —CO—O—R₃₇ group wherein R₃₇ is a substituted or unsubstituted alkyl group, an aryl group, or a heterocyclic group; and X₃ represents a substituted or unsubstituted aryl group or a heterocyclic group.

In the foregoing formula (CLA), halogen atoms of R₃₁ and R₃₂ include fluorine, bromine, and chlorine; alkyl groups include those having at most 20 carbon atoms (methyl, ethyl, butyl, or dodecyl); alkenyl groups include those having at most 20 carbon atoms (vinyl, allyl, butenyl, hexenyl, hexadienyl, ethenyl-2-propenyl, 3-butenyl, 1-methyl-3-propenyl, 3-pentenyl, or 1-methyl-3-butenyl); alkoxy groups include those having at most 20 carbon atoms (methoxy or ethoxy). Alkyl groups of R₃₀ of —NHCO—R₃₀ include those having at most 20 carbon atoms (methyl, ethyl, butyl, or dodecyl), aryl groups include those having 6-20 carbon atoms such as a phenyl group or a naphthyl group; heterocyclic groups include each of thiophene, furan, imidazole, pyrazole, and pyrrole groups. R₃₃ represents an alkyl group (preferably having at most 20 carbon atoms such as methyl, ethyl, butyl, or dodecyl), an aryl group (preferably having 6 to 20 carbon atoms, such as phenyl or naphthyl), or a heterocyclic group (thiophene, furan, imidazole, pyrazole, or pyrrole). In a —CONHR₃₅ group, a —CO—R₃₅ group or a —CO—OR₃₅ of W₃, R₃₅ represents an alkyl group (preferably having at most 20 carbon atoms, such as methyl, ethyl, butyl, or dodecyl), an aryl group (preferably having 6 to 20 carbon atoms, such as phenyl or naphthyl), or a heterocyclic group (such as thiophene, furan, imidazole, pyrazole, or pyrrole).

R₃₄ is a hydrogen atom, a halogen atom (e.g., fluorine, chlorine, bromine, iodine), a chained or cyclic alkyl group (e.g., methyl, butyl, dodecyl, or cyclohexyl), an alkenyl group having at most 20 carbon atoms (e.g., vinyl, allyl, butenyl, hexenyl, hexadienyl, ethenyl-2propenyl, 3-butenyl, 1-methyl-3-propenyl, 3-pentenyl, 1-methyl-3-butenyl), an alkoxy group (e.g., methoxy, butoxy, or tetradecyloxy), a carbamoyl group (e.g., dimethylcarbamoyl, phenylcarbamoyl group), and a nitrile group. Of these, a hydrogen atom and an alkyl group are more preferred. R₃₃ and R₃₄ combine with each other to form a ring structure. The foregoing groups may have a single substituent or a plurality of substituents. Typical example of substituents include a halogen atom (e.g., fluorine,.chlorine, or bromine atom), an alkyl group (e.g., methyl, ethyl, propyl, butyl, or dodecyl), hydroxyl group, cyan group, nitro group, an alkoxy group (e.g., methoxy or ethoxy), an alkylsulfonamide group (e.g., methylsulfonamido or octylsulfonamido), an arylsulfonamide group (e.g., phenylsulfonamido or naphthylsulfonamido), an alkylsulfamoyl group (e.g., butylsulfamoyl), an arylsulfamoyl group (e.g., phenylsulfamoyl), an alkyloxycarbonyl group (e.g., methoxycarbonyl), an aryloxycarbonyl group (e.g., phenylokycarbonyl), an aminosulfonamide group, an acylamino group, a carbamoyl group, a sulfonyl group, a sulfinyl group, a sulfoxy group, a sulfo group, an aryloxy group, an alkoxy group, an alkylcarbonyl group, an arylcarbonyl group, or an aminocarbonyl group.

Either R₃₀ or R₃₅ is preferably a phenyl group, and more preferably a phenyl group having a plurality of substituents of a halogen atom or a cyano group. R₃₆ is a —CONH—R₈₇ group, a —CO—R₈₇ group, or —CO—O—R₈₇ group, wherein R₈₇ is an alkyl group (preferably having at most 20 carbon atoms, such as methyl, ethyl, butyl, or dodecyl), an aryl group (preferably having 6 to 20 carbon atoms, such as phenyl, naphthol, or thienyl), or a heterocyclic group (thiophene, furan, imidazole, pyrazole, or pyrrole). Substituents of the alkyl group represented by R₈₇ may be the same ones as substituents in R₃₁ to R₃₄.

X₃ represents an aryl group or a heterocyclic group. These aryl groups include groups having 6 to 20 carbon atoms such as phenyl, naphthyl, or thienyl, while the heterocyclic groups include any of the groups such as thiophene, furan, imidazole, pyrazole, or pyrrole. Substituents which may be substituted to the group represented by X₃ may be the same ones as the substituents in R₃₁ to R₃₄. As the groups represented by X₃ are preferred an aryl group, which is substituted with an alkylamino group (a diethylamino group) at the para-position, or a heterocyclic group.

The foregoing groups may further contain photographically useful groups.

Specific examples of a cyan dye forming leuco dye (CLA) are shown below but cyan dye forming leuco dyes usable in this invention are not limited to these. 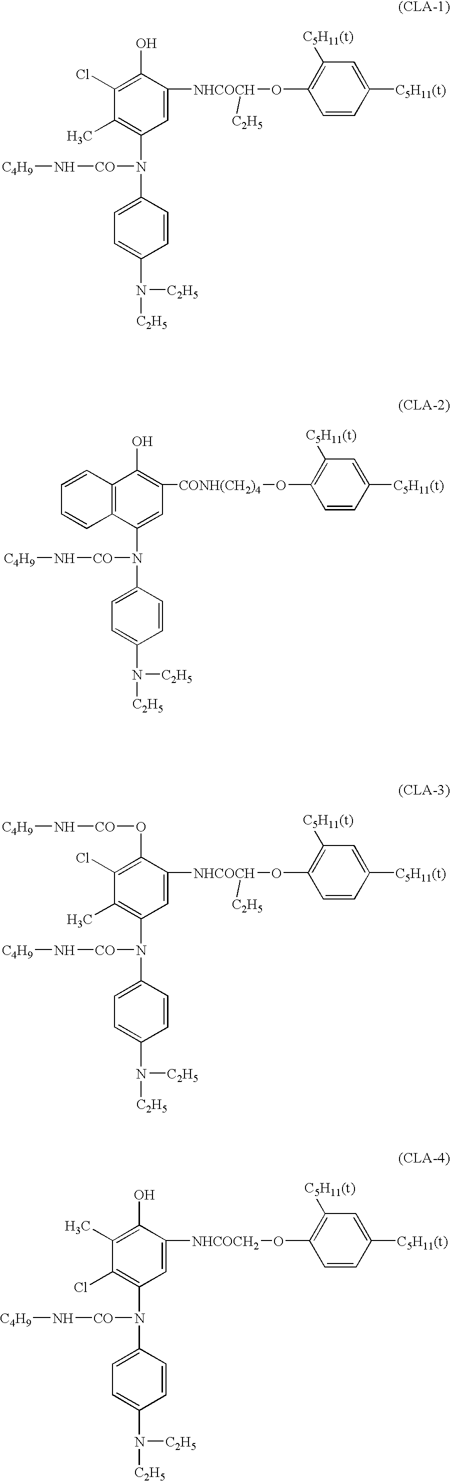 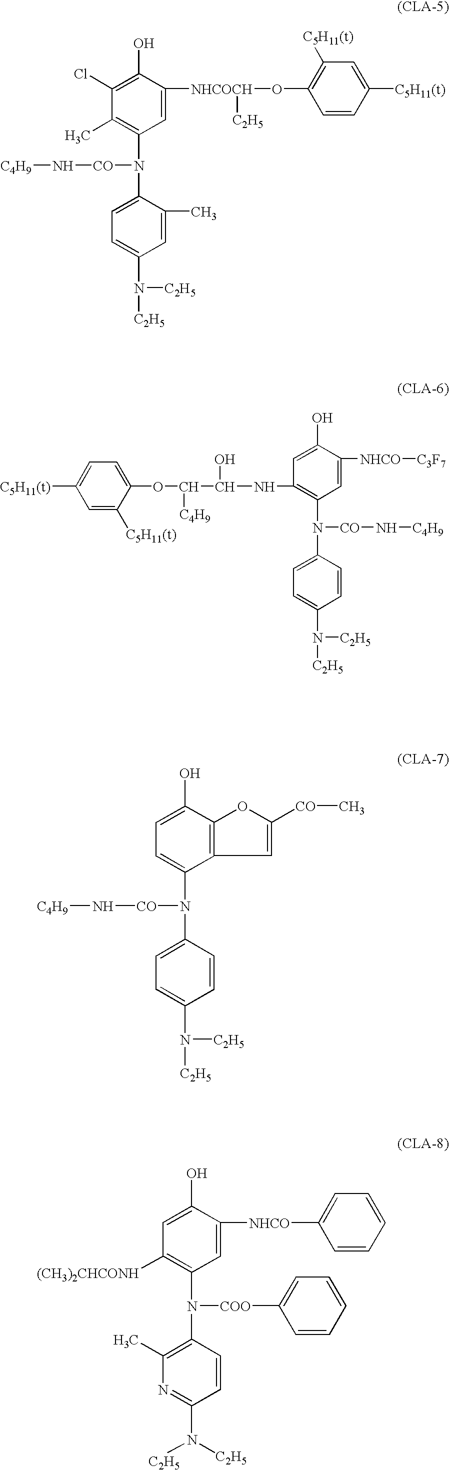 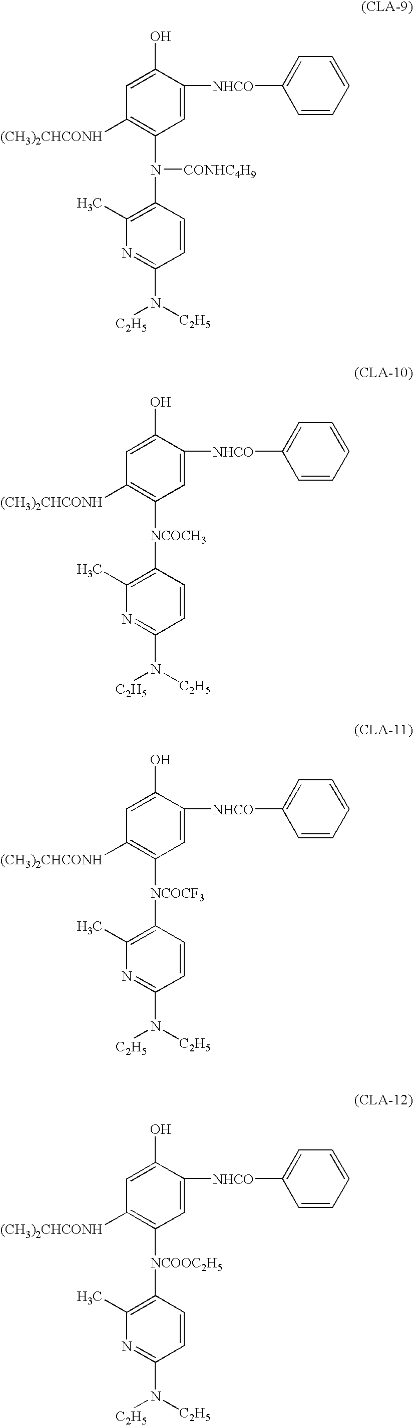
A compound of formula (CLB) is as below: 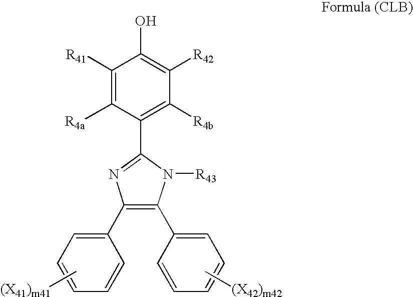
wherein R₄₁, R₄₂, R₄ₐ and R_{4b} are each a hydrogen atom, an aliphatic group, an aromatic group, an alkoxy group, an aryloxy group, an acylamino group, a sulfonamido group, a carbamoyl group or a halogen atom group; R₄₃ are each a hydrogen atom, an aliphatic group, an aromatic group, an acyl group, an alkoxycarbonyl group, an aryloxycarbonyl group, a carbamoyl group, a sulfamoyl group, or a sulfonyl group; X₁ and X₂ are each a group capable of being substituted on a benzene ring; m41 and m42 are each an integer of 0 to 5, provided that when X₁ or X₂ is plural, X₁ or X₂ may be the same or different.

Examples of an aliphatic group of R₄₁, R₄₂, R₄ₐ and R_{4b} include a hydrocarbon groups such as an alkyl group, a cycloalkyl group, an alkenyl group and alkynyl group. Such a hydrocarbon group preferably has 1-15 carbon atoms, and more preferably 1-20 carbon atoms. Examples of an alkyl group having 1-25 carbon atoms include methyl, ethyl, propyl, I-propyl, t-butyl, pentyl, hexyl, cyclohexyl; examples of a cycloalkyl group include cyclohexyl and cyclopentyl; examples of an alkenyl group include ethenyl, 2-propenyl, 3-butenyl, 1-methyl-3-propenyl, 3-pentenyl, 1-methyl-3-butenyl; examples of an alkynyl group include ethynyl, propynyl and parpargyl.

Examples of an aromatic group of R₄₁, R₄₂, R₄ₐ and R_{4b} include an aryl group (e.g., phenyl, naphthyl), and a heterocyclic group (e.g., pyridyl, thiazolyl, oxazolyl, imidazolyl, furyl, pyrazinyl, pyrimidinyl, pyridazinyl, selenazolyl, sulforanyl, piperidinyl, pyrazolyl, tetrazolyl). Examples of an alkoxy group of R₄₁, R₄₂, R₄ₐ and R_{4b} include methoxy, ethoxy, isopropyloxy and tert-butoxy group. Examples of an aryloxy group of R₄, R₄₂, R₄ₐ and R_{4b} include phenoxy and naphthyl. Examples of an acylamino group of R₄₁, R₄₂, R₄ₐ and R_{4b} include acetylamino and acetyloxy. Examples of a sulfonamido group of R₄₁, R₄₂, R₄ₐ and R_{4b} include methanesulfonamido, butanesulfoneamido, octanesulfonamido and benzenesulfonamido. Examples of a carbamoyl group of R₄₁, R₄₂, R₄ₐ and R_{4b} include aminocarbonyl, methylaminocarbonyl, dimethylaminocarbonyl, propylaminocarbonyl, pentylaminocarbonyl, cyclohexylaminocarbonyl, phenylaminocarbonyl and 2-pyridylaminocarbonyl. Examples of a halogen atom of R₄₁, R₄₂, R₄ₐ and R_{4b} include chlorine, bromine and iodine.

R₄₁ and R₄₂ are each preferably an aliphatic group, an alkoxy group or an aryloxy group; more preferably an alkyl or an alkoxy group; and still more preferably a secondary or tertiary alkyl or alkoxy group.

R₄ₐ and R_{4b} are each preferably a hydrogen atom or an aliphatic group, and more preferably a hydrogen atom. Examples of an aliphatic group, an aromatic group, an alkoxy group organ aryl group of R₄₃ are the same as cited those of an aliphatic group, an aromatic group, an alkoxy group or an aryl group of R₄₁ and R₄₂.

Examples of an acyl group represented by R₄₃ include acetyl, propionyl, butanoyl, hexanoyl, cyclohexanoyl, benzoyl, and pyridinoyl. Examples of an alkoxycarbonyl group represented by R₄₃ include methoxycarbonyl, ethoxycarbonyl and tert-butoxycarbonyl. Examples of an aryloxycarbonyl group represented by R₄₃ include phenoxycarbonyl. Examples of a carbamoyl group represented by R₄₃ include aminocarbonyl, dimethylaminocarbonyl, propylaminocarbonyl, pentylaminocarbonylcyclohexylaminocarbonyl, phenylaminocarbonyl, and 2-pyridylaminocarbonyl. Examples of a sulfamoyl group represented by R₄₃ include methylsulfamoyl, dimethylsulfamoyl and phenylsulfamoyl. Examples of a sulfonyl group represented by R₄₃ include methylsulfonylm butylsulfonyl and octylsulfonyl. R₄₃ is preferably a hydrogen atom, an alkyl group and an acyl group, and more preferably a hydrogen atom, or an alkyl or acyl group having 1-10 carbon atoms.

Examples of a group capable of being substituted on a benzene ring represented by X₄₁ and X₄₂ include an alkyl group having 1 to 25 carbon atoms (e.g., methyl, ethyl, propyl, i-propyl, t-butyl, pentyl, hexyl, or cyclohexyl), a halogenated alkyl group (e.g., trifluoromethyl or perfluorooctyl), a cycloalkyl group (e.g., cyclohexyl or cyclopentyl); an alkynyl group (e.g., propargyl), a glycidyl group, an acrylate group, a methacrylate group, an aryl group (e.g., phenyl), a heterocyclic group (e.g., pyridyl, thiazolyl, oxazolyl, imidazolyl, furyl, pyrrolyl, pyradinyl, pyrimidyl, pyridadinyl, selenazolyl, piperidinyl, sulforanyl, piperidinyl, pyrazolyl, or tetrazolyl), a halogen atom (e.g., chlorine, bromine, iodine or fluorine), an alkoxy group (e.g., methoxy, ethoxy, propyloxy, pentyloxy, cyclopentyloxy, hexyloxy, or cyclohexyloxy), an aryloxy group (e.g., phenoxy), an alkoxycarbonyl group (e.g., methyloxycarbonyl, ethyloxycarbonyl, or butyloxycarbonyl), an aryloxycarbonyl group (e.g., phenyloxycarbonyl), a sulfonamido group (e.g., methanesulfonamido, ethanesulfonamido, butanesulfonamido, hexanesulfonamido, cyclohexabesulfonamido, benzenesulfonamido), sulfamoyl group (e.g., aminosulfonyl, methyaminosulfonyl, dimethylaminosulfonyl, butylaminosulfonyl, hexylaminosulfonyl, cyclohexylaminosufonyl, phenylaminosulfonyl, or 2-pyridylaminosulfonyl), a urethane group (e.g., methylureido, ethylureido, pentylureido, cyclopentylureido phenylureido, or 2-pyridylureido), an acyl group (e.g., acetyl, propionyl, butanoyl, hexanoyl, cyclohexanoyl, benzoyl, or pyridinoyl), a carbamoyl group (e.g., aminocarbonyl, methylaminocarbonyl, dimethylaminocarbonyl, propylaminocarbonyl, a pentylaminocarbonyl group, cyclohexylaminocarbonyl, phenylaminocarbonyl, or 2-pyridylaminocarbonyl), an amido group (e.g., acetamide, propionamide, butaneamide, hexaneamide, or benzamide), a sulfonyl group (e.g., methylsulfonyl, ethylsulfonyl, butylsulfonyl, cyclohexylsulfonyl, phenylsulfonyl, or 2-pyridylsulfonyl), an amino group (e.g., amino, ethylamino, dimethylamino, butylamino, cyclopentylamino, anilino, or 2-pyridylamino), a cyano group, a nitro group, a sulfo group, a carboxyl group, a hydroxyl group, and an oxamoyl group. Further, these groups may further be substituted with these groups.

X₄₁ and X₄₂ are each preferably an alkoxy group, an aryloxy group, a carbamoyl group, an amido group, a sulfonamide group or an amino group, and more preferably an alkoxy group or an amino group.

Compounds represented by formula (CLB) can be readily synthesized by commonly known methods, for example, JP-B No. 7-45477 (the term, JP-B refers to Japanese Patent publication).

Specific examples of the compound of formula (CLB) areshown below, but are by no means limited to these.

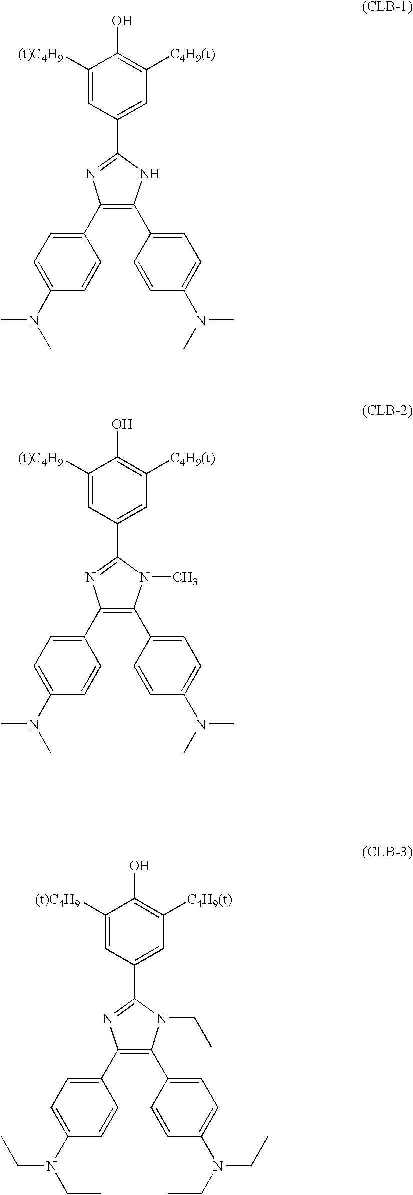

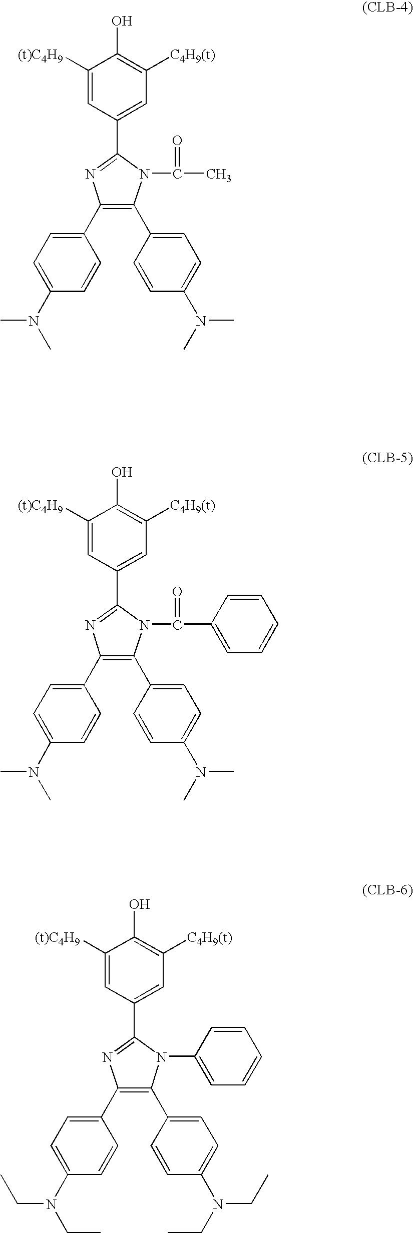

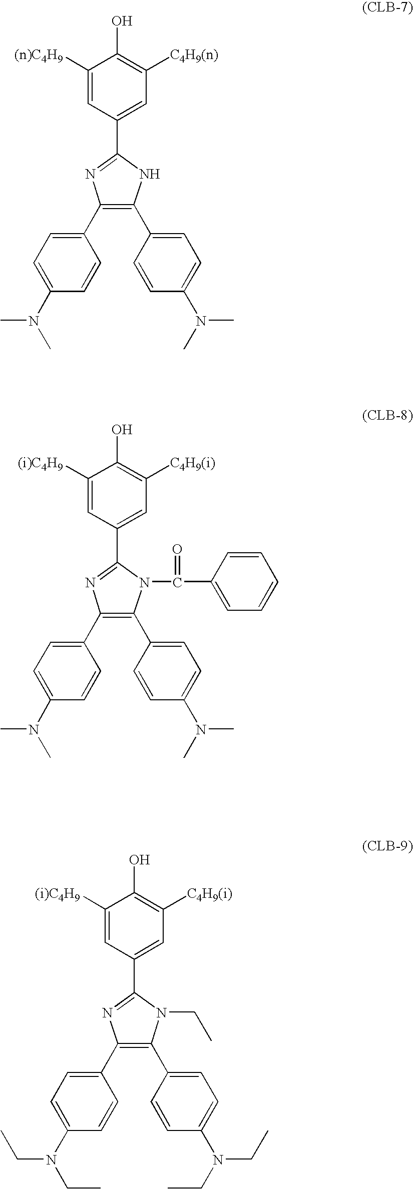

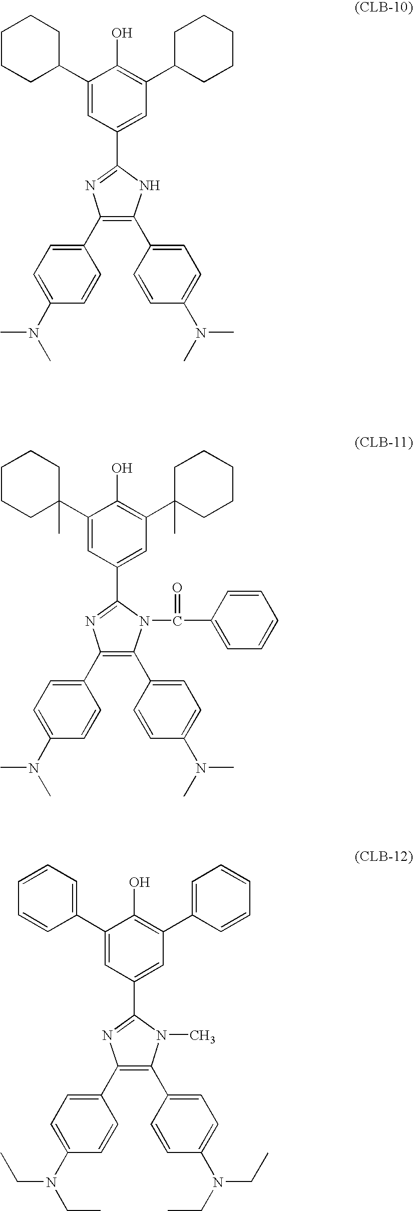

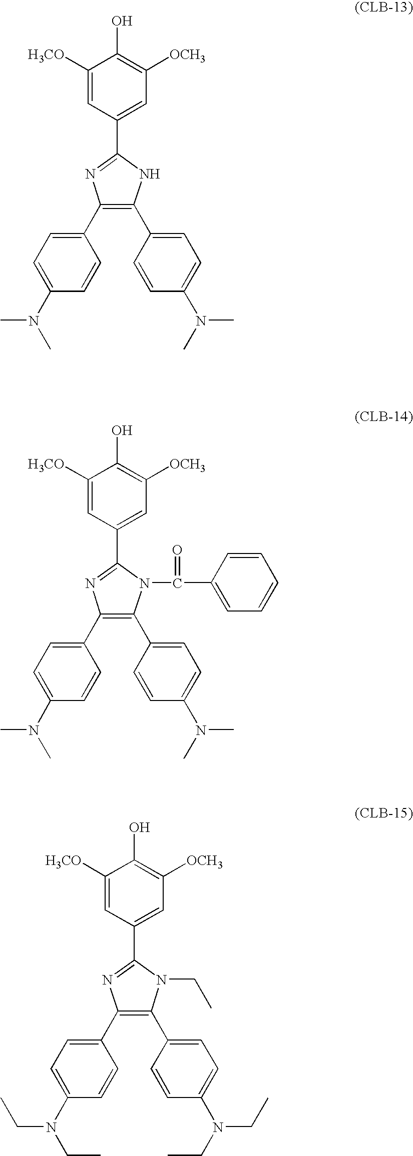

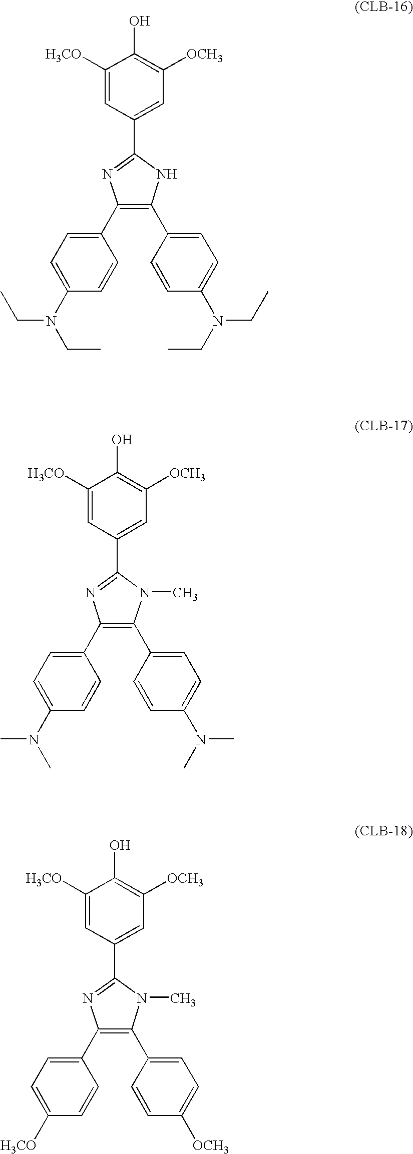

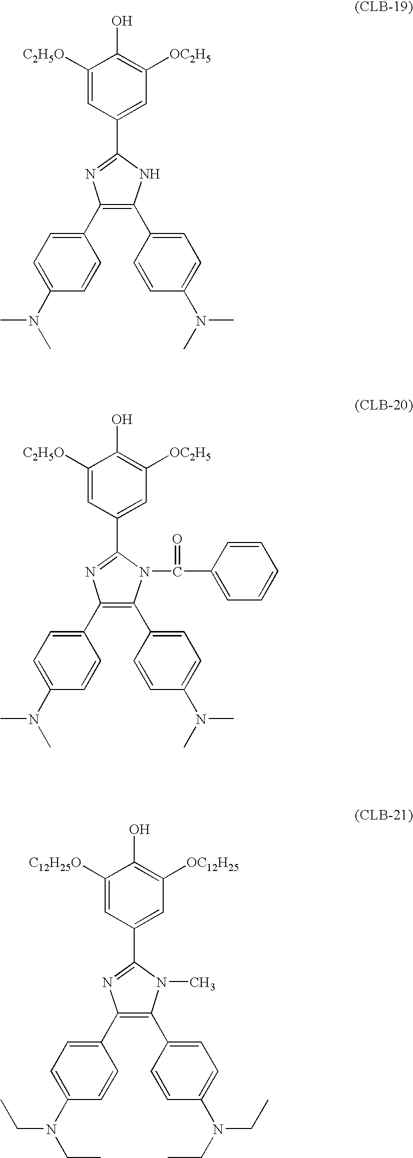

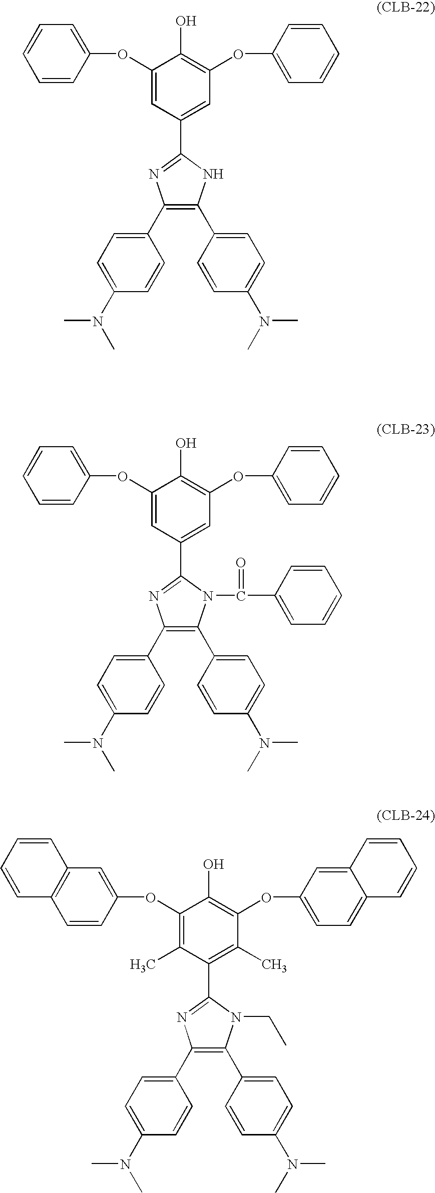

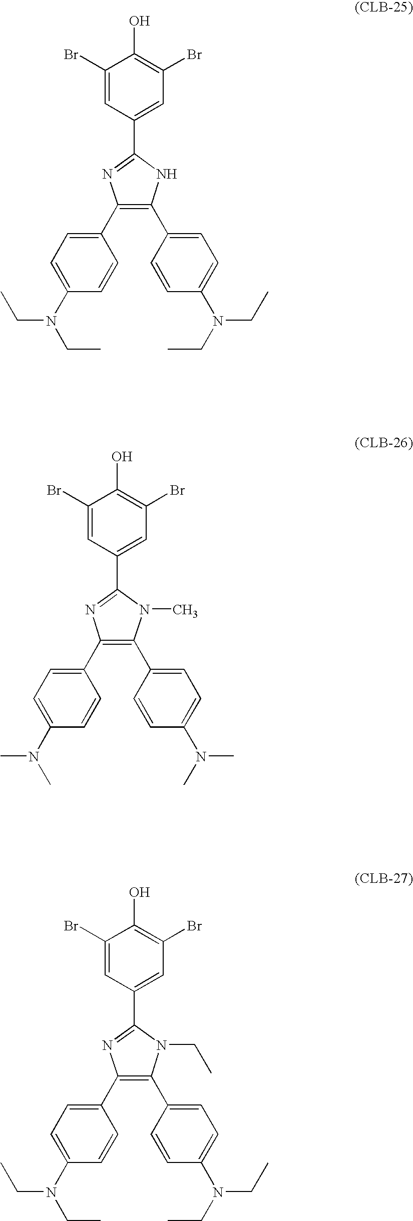

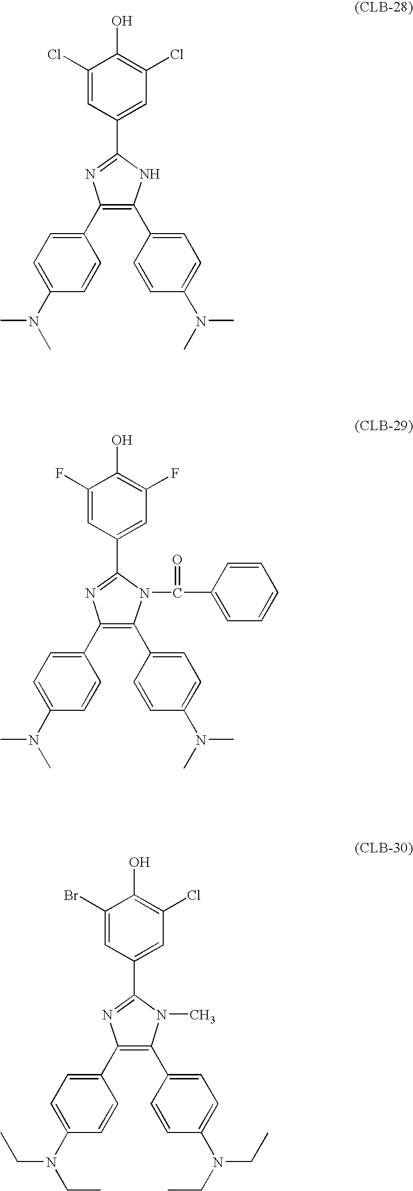

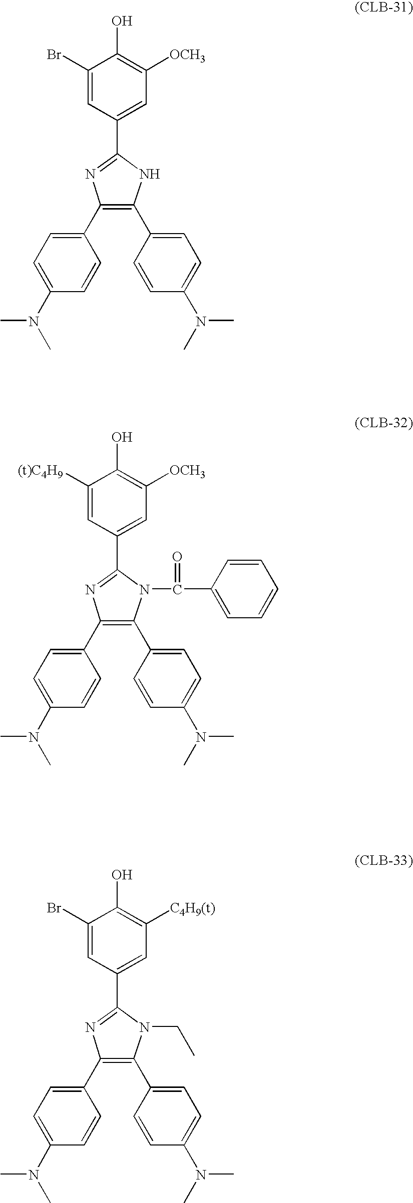

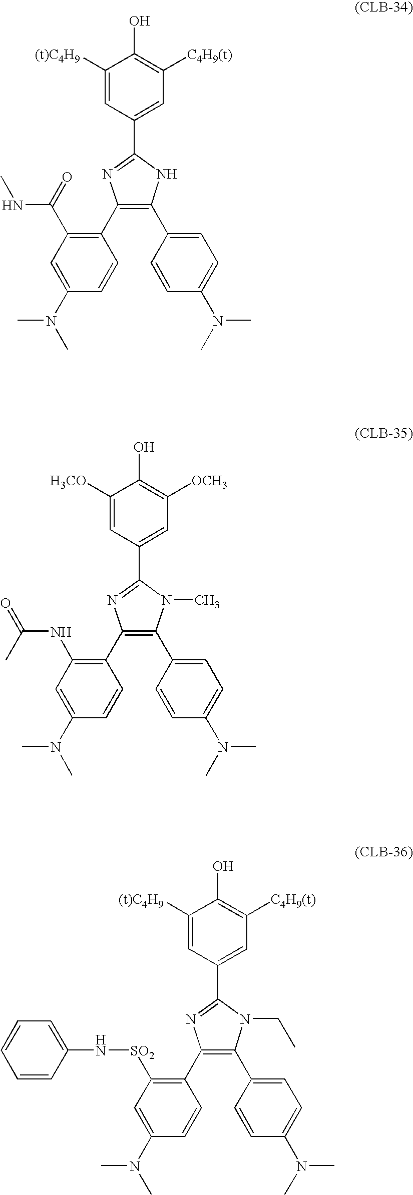

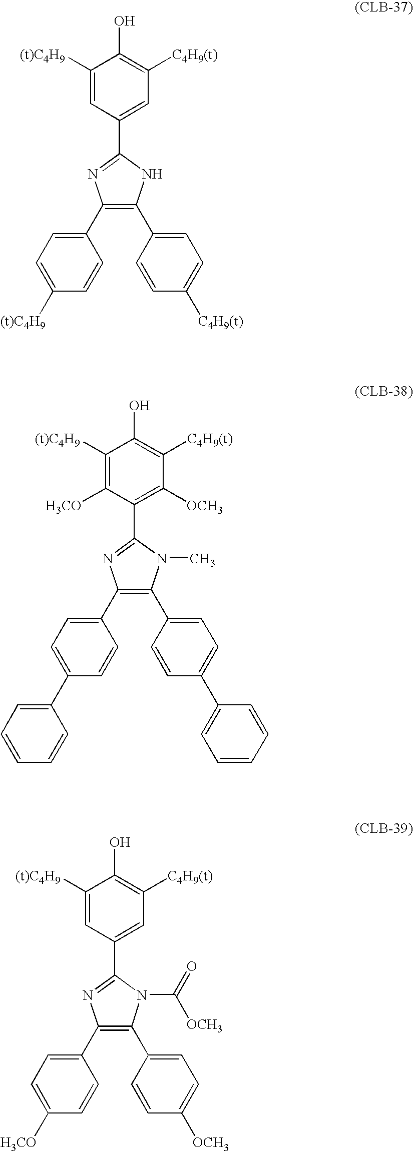

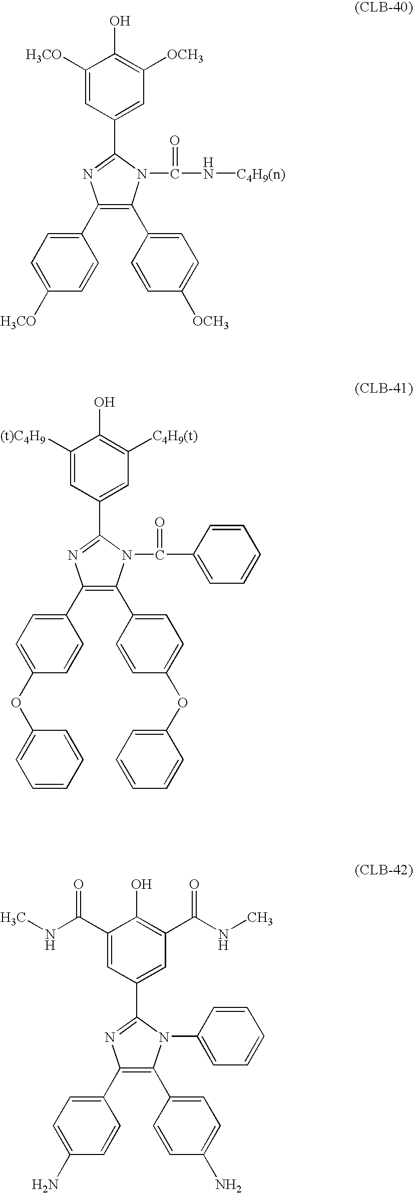

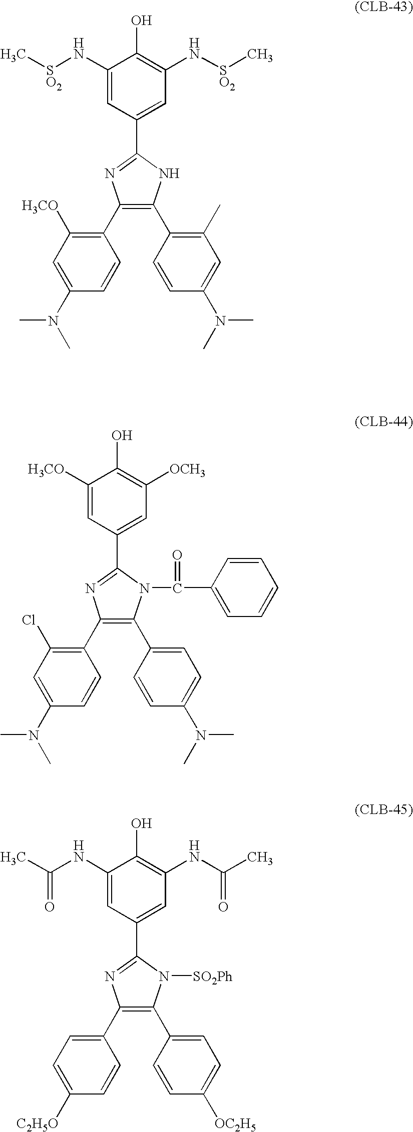

The addition amount of cyan forming leuco dyes is usually 0.00001 to 0.05 mol/mol of Ag, preferably 0.0005 to 0.02 mol/mol, and more preferably 0.001 to 0.01 mol. A cyan forming leuco dye is incorporated preferably in a molar ratio of 0.00001 to 0.2, and more preferably 0.005 to 0.1, based on the total amount of reducing agents of formulas (1) and (2). The cyan dye is preferably formed so that the sum of the maximum density at the absorption maximum of a color image formed by a cyan forming leuco dye is preferably 0.01 to 0.50, more preferably 0.02 to 0.30, and still more preferably 0.03 to 0.10.

In addition to the foregoing cyan forming leuco dye, magenta color forming leuco dyes or yellow color forming leuco dyes may be used to control delicate color tone.

The compounds represented by the foregoing formulas (YA) and (YB) and cyan-forming leuco dyes may be added employing the same method as for the reducing agents represented by the foregoing formula (RD1). They may be incorporated in liquid coating compositions employing an optional method to result in absolution form, an emulsified dispersion form, or a minute solid particle dispersion form, and then incorporated in a photosensitive material.

It is preferable to incorporate the compounds represented by formulas (RD1) and (RD2), formulas (YA) and (YB), and cyan forming leuco dyes into an image forming layer containing organic silver salts on the other hand, the former may be incorporated in the image forming layer, while the latter may be incorporated in a non-image forming layer adjacent to the aforesaid image forming layer. Alternatively, both may be incorporated in the non-image forming layer. Further, when the image forming layer is comprised of a plurality of layers, incorporation may be performed for each of the layers.

The photothermographic material of this invention may contain a binder in the light-sensitive layer or the light-insensitive layer.

Suitable binders for the silver salt photothermographic material are to be transparent or translucent and commonly colorless, and include natural polymers, synthetic resin polymers and copolymers, as well as media to form film, for example, those described in paragraph [0069] of JP-A No. 2001-330918. Preferable binders for the light-sensitive layer of the photothermographic material of this invention are poly(vinyl acetals), and a particularly preferable binder is poly(vinyl butyral), which will be detailed hereunder.

Polymers such as cellulose esters, especially polymers such as triacetyl cellulose, cellulose acetate butyrate, which exhibit higher softening temperature, are preferable for an over-coating layer as well as an undercoating layer, specifically for a light-insensitive layer such as a protective layer and a backing layer. Incidentally, if desired, the binders may be employed in combination of at least two types.

The binder preferably introduces at least a polar group chosen from −COOM, —SO₃M, —OSO₃M, —P═O(OM)₂, —O—P═O(OM)₂, —N(R)₂, —N⁺(R)₃, (in which M is a hydrogen atom, an alkali metal base or a hydrocarbon group), epoxy group, —SH, and —CN in the stage of copolymerization or addition reaction of these, —SO₃M or —OSO₃M is preferred. The content of a polar group is in the range of 1×10⁻⁸ to 1×10⁻¹, and preferably 1×10⁻⁶ to 1×10⁻².

Such binders are employed in the range of a proportion in which the binders function effectively. Skilled persons in the art can easily determine the effective range. For example, preferred as the index for maintaining aliphatic carboxylic acid silver salts in a photosensitive layer is the proportion range of binders to aliphatic carboxylic acid silver salts of 15:1 to 1:2 and most preferably of 8:1 to 1:1. Namely, the binder amount in the photosensitive layer is preferably from 1.5 to 6 g/m², and is more preferably from 1.7 to 5 g/m². When the binder amount is less than 1.5 g/m², density of the unexposed portion markedly increases, whereby it occasionally becomes impossible to use the resultant material.

In this invention, it is preferable that thermal transition point temperature (Tg) is preferably from 70 to 105° C. Thermal transition point temperature (Tg) can be measured by a differential scanning calorimeter, in which the crossing point of the base line and a slope of the endothermic peak is defined as Tg.

The glass transition temperature (Tg) is determined employing the method, described in Brandlap et al., “Polymer Handbook”, pages III-139 to III-179, 1966 (published by Wiley and Son Co.). The Tg of the binder composed-of copolymer resins is obtained based on the following formula:
Tg of the copolymer (in ° C.)=v₁Tg₁+v₂Tg₂+ . . . +vₙTgₙ
wherein v₁, v₂, . . . vₙ each represents the mass ratio of the monomer in the copolymer, and Tg₁, Tg₂, . . . Tgₙ each represents Tg (in ° C.) of the homopolymer which is prepared employing each monomer in the copolymer. The accuracy of Tg, calculated based on the formula calculation, is ±5° C.

The use of a binder exhibiting a Tg of 70 to 105° C. can achieve sufficient maximum density in the image formation.

Binders usable in this invention exhibit a Tg of 70 to 105° C., a number-average molecular weight of 1,000 to 1,000,000 (preferably 10,000 to 500,000) and a polymerization degree of 50 to 1,000. Polymer containing ethylenically unsaturated monomer as a constitution unit and its copolymer are those described in JP-A No. 2001-330918, paragraph [0069]. Of these, preferred examples thereof include methacrylic acid alkyl esters, methacrylic acid aryl esters, and styrenes. Polymer compounds containing an acetal group are preferred among polymer compounds. Of such polymer compounds containing an acetal group, polyvinyl acetal having an acetal structure is preferred, including, for example, polyvinyl acetal described in U.S. Pat. Nos. 2,358,836, 3,003,879 and 2,828,204; and British Patent No. 771,155. Further, The polymer compound containing an acetal group is also preferably a compound represented by formula (V) described in JP-A no. 2002-287299, paragraph [150].

Polyurethane resins known in the art are usable in this invention, such as polyester polyurethane, polyether polyurethane, polyether polyester polyurethane, polycarbonate polyurethane, polyester polycarbonate polyurethane, or polycaprolactone polyurethane. Polyurethane preferably contains at least one hydroxyl group at each of both ends of the molecule, i.e., at least two hydroxy group in total. The hydroxyl group cross-links polyisocyanate as a hardener to form a network structure so that it is preferred to contain hydroxyl groups as many as possible. Specifically, a hydroxyl group existing at the end of the molecule exhibits enhanced reactivity with a hardener. Polyurethane contains preferably at least three (more preferably at least four) hydroxyl groups at the end of the molecule. When polyurethane is employed, the polyurethane preferably has a glass transition temperature of 70 to 105° C., a breakage elongation of 100 to 2,000 percent, and a breakage stress of 0.5 to 100 M/mm².

The foregoing polymer compound (or polymer) may be used alone or plural compounds may be blended.

The foregoing polymer is preferably used as a main binder in the image forming layer. The main binder means that at least 50% by weight of the whole binder in the image forming layer is accounted for by the foregoing polymer. Accordingly, other polymers may be blended within the range of less than 50% by weight of the whole binder. Such polymers are not specifically limited when using a solvent in which the main polymer is soluble. Preferred examples thereof include polyvinyl acetate, acryl resin and urethane resin.

The image forming layer may contain an organic gelling agent. The organic gelling agent refers to a compound which provides its system a yield point when incorporated to organic liquid and having a function of disappearing or lowering fluidity.

In one preferred embodiment of this invention, a coating solution for the image forming layer contains an aqueous-dispersed polymer latex. The aqueous-dispersed polymer latex accounts for preferably at least 50% by weight of the whole binder of the coating solution. The polymer latex preferably accounts for at least 50% by weight of the whole binder of the image forming layer, and more preferably at least 70% by weight. The polymer latex is a dispersion in which a water-insoluble hydrophobic polymer is in the form of minute particles dispersed in aqueous dispersing medium. The polymer may be dispersed in any form, such as being emulsified in the dispersing medium, being emulsion-polymerized, being dispersed in the form of micelles or a polymer partially having a hydrophilic structure in the molecule and its molecular chain being molecularly dispersed. The average size of dispersed particles is preferably 1 to 50,000 nm, and more preferably 5 to 1,000 nm. The particle size distribution of the dispersed particles is not specifically limited and may be one having a broad distribution or a monodisperse distribution.

Polymer latex usable in the photothermographic material of this invention may be not only conventional polymer latex having a uniform structure but also a so-called core/shell type latex. In this regard, core and shell which differ in Tg, are occasionally preferred. The minimum film-forming temperature (MFT) of a polymer latex relating to this invention is preferably from −30 to 90° C., and more preferably 0 to 70° C. There may be added a film-forming aid to control the minimum film-forming temperature. The film-forming aid is also called a plasticizer and an organic compound (usually, organic solvent) which lowers the minimum film-forming temperature, as described in S. Muroi “Gosei Latex no Kagaku” (Chemistry of Synthetic Latex) Kobunshi Kankokai, 1970.

Polymer species used in polymer latex include, for example, acryl resin, vinyl acetate resin, polyester resin, polyurethane resin, rubber type resin, vinyl chloride resin, vinylidene chloride resin, polyolefin resin and their copolymers. The polymer may be a straight chained or branched polymer, or may be cross-linked. The polymer may be a homopolymer comprised of a single monomer or a copolymer comprised of at least two monomers. Copolymer may be a random copolymer or a block copolymer. The polymer molecular weight is usually from 5,000 to 1,000,000, and preferably 10,000 to 100,000 in terms of number-average molecular weight. An excessively small molecular weight results in insufficient mechanical strength and an excessively large one results in deteriorated film-forming capability.

The equilibrium moisture content of a polymer latex is preferably from 0.01% to 2% by weight at 25° C. and 60% RH (relative humidity), and more preferably 0.01% to 1%. The definition and measurement of the equilibrium moisture content is referred to, for example, “Kobunshi-Kogaku Koza 14, Kobunshi-Shikenho” (edited by Kobunshi Gakkai, Chijin Shoin).

Specific examples of polymer latex include those described in JP-A No. 2002-287299, {0173}. These polymers may be used singly or in their combination as a blend. A carboxylic acid component as a polymer specie, such as an acrylate or methacrylate component, is contained preferably in an amount of 0.1 to 10% by weight.

A hydrophilic polymer such as gelatin, polyvinyl alcohol, methyl cellulose, hydroxypropyl cellulose, carboxymethyl cellulose, or hydroxypropyl cellulose may optionally be incorporated within the range of not more than 50% by weight of the whole binder. The hydrophilic polymer content is preferably not more than 30% by weight of the image forming layer.

In the preparation of a coating solution for the image forming layer, an organic silver salt and an aqueous-dispersed polymer latex may be added in any order. Thus, either one may be added at first or both may be added simultaneously, but the polymer latex is added preferably later.

Before adding a polymer latex, an organic silver salt is added and then a reducing agent is preferably mixed. Aging a mixture of an organic silver salt and a polymer latex at an excessively low temperature results in deteriorated coated layer surface, and aging at an excessively high temperature leads to increased fogging. After mixing, the coating solution is aged preferably at a temperature of 30 to 65° C., more preferably 35 to 60° C., and still more preferably 35 to 55° C.

The coating solution for the image forming layer, after mixing an organic silver salt and an aqueous-dispersed polymer latex, is coated preferably after 30 min. to 24 hr., more preferably after 60 min. to 10 hr., and still more preferably after 120 min. to 10 hr. The expression “after mixing” means that an organic silver salt and aqueous-dispersed polymer latex are added and additive materials have been homogeneously dispersed.

The light-sensitive layer may contains cross-linking agents capable of binding binder molecules through cross linking. It is known that employing cross-linking agents in the aforesaid binders minimizes uneven development, due to the improved adhesion of the layer to the support. In addition, it results in such effects that fogging during storage is minimized and the creation of printout silver after development is also minimized.

There may be employed, as cross-linking agents used in this invention, various conventional cross-linking agents, which have been employed for silver halide photosensitive photographic materials, such as aldehyde type, epoxy type, ethyleneimine type, vinylsulfone type, sulfonic acid ester type, acryloyl type, carbodiimide type, and silane compound type cross-linking agents, which are described in JP-A No. 50-96216. Of these, isocyanate type compounds, silane type compounds, epoxy type compounds and acid anhydride are preferred.

Incidentally, adducts of an isocyanate with a polyalcohol are capable of markedly improving the adhesion between layers and further of markedly minimizing layer peeling, image dislocation, and air bubble formation. Such isocyanates may be incorporated in any portion of the silver salt photothermographic material. They may be incorporated in, for example, a support (particularly, when the support is paper, they may be incorporated in a sizing composition), and optional layers such as a photosensitive layer, a surface protective layer, an interlayer, an antihalation layer, and a subbing layer, all of which are placed on the photosensitive layer side of the support, and may be incorporated in at least two of the layers.

Further, as thioisocyanate based cross-linking agents usable in the present invention, compounds having a thioisocyanate structure corresponding to the isocyanates are also useful as thioisocyanate based cross-linking agents usable in the present invention.

The amount of the cross-linking agents employed in the present invention is in the range of 0.001 to 2.000 mol per mol of silver, and is preferably in the range of 0.005 to 0.500 mol.

Isocyanate compounds as well as thioisocyanate compounds, which may be incorporated in the present invention, are preferably those which function as the cross-linking agent. However, it is possible to obtain the desired results by employing compounds which have “v” of 0, namely compounds having only one functional group.

Examples of silane compounds which can be employed as a cross-linking agent in this invention are compounds represented by General formulas (1) to (3), described in JP-A No. 2001-264930.

Compounds, which can be used as a cross-linking agent, may be those having at least one epoxy group. The number of epoxy groups and corresponding molecular weight are not limited. It is preferable that the epoxy group be incorporated in the molecule as a glycidyl group via an ether bond or an imino bond. Further, the epoxy compound may be a monomer, an oligomer, or a polymer. The number of epoxy groups in the molecule is commonly from about 1 to about 10, and is preferably from 2 to 4. When the epoxy compound is a polymer, it may be either a homopolymer or a copolymer, and its number average molecular weight Mn is most preferably in the range of about 2,000 to about 20,000.

Acid anhydrides usable in this invention are compounds containing at least one acid anhydride group having a structure, as shown below:
—CO—O—CO—.

Any compound containing such at least one acid anhydride group is not limited with respect to the number of acid anhydride groups, molecular weight and others.

The foregoing epoxy compounds or acid anhydrides may be used singly or in combination. The addition amount is preferably 1×10⁻⁶ to 1×10⁻² mol/m², and more preferably 1×10⁻⁵ to 1×10⁻³ mol/m². The epoxy compounds or acid anhydrides may be incorporated into any layer of the light-sensitive layer side, such as a light-sensitive layer, surface protective layer, an interlayer, an antihalation layer or a sublayer. The compounds may be incorporated into one or more of these layers.

A silver saving agent may be incorporated to the light-sensitive or light-insensitive layer. The silver saving agent refers to a compound which is capable of lessen a silver amount necessary to obtain a prescribed silver image density.

Various mechanisms of working have been assumed with respect to function of lessen the silver amount but a compound capable of enhancing covering power of developed silver is preferred. The covering power of developed silver refers to an optical density per unit amount of silver. Silver saving agents may be incorporated to a light-sensitive layer or a light-insensitive layer, or to both layers. Examples of a silver saving agent include a hydrazine derivative compound, a vinyl compound, a phenol compound, a naphthol compound, a quaternary onium compound and a silane compound.

Specific examples of the hydrazine derivative include compounds H-1 through H-29 described in U.S. Pat. No. 5,545,505, col. 1-20; compounds 1 through 12 described in U.S. Pat. No. 5,464,738, col. 9-11; and compounds H 1-1 through H 1-28, H 2-1 through H 2-9, H 3-1 through H-3-12, H 4-1 through H 4-21, and H-5-1 through H-5-5, described in JP-A No. 2001-27790.

Specific examples of the vinyl compound include compounds CN-01 through CN-13, described in U.S. Pat. No. 5,545,515, col. 13-14; compounds HET-01 through HET-02, described in U.S. Pat. No. 5,635,339, col. 10; compounds MA-01 through MA-07, described in U.S. Pat. No. 5,654,130, col. 9-10; compounds IS-01 through IS-04, described in U.S. Pat. No. 5,705,324, col. 9-10; and compounds 1-1 through 218-2, described in JP-A No. 2001-125224.

Specific examples of phenol and naphthol derivatives include compounds A-1 through A-89 described in JP-A No. 2000-2.67222, paragraph [0075]-[0078]; compounds A-1 through A-258 described in JP-A No. 2003-66558, paragraph [0025]-[0045].

Specific examples of the onium compound include triphenyltetrazolium.

Specific examples of the silane compound include an alkoxysilane compounds having a primary or secondary amino group, e.g., compounds A1 through A33, described in JP-A No. 2003-5324, paragraph [0027]-[0029).

A silver saving agent is contained in an amount of 1×10⁻⁵ to 1 mol, preferably 1×10⁻⁴ to 5×10⁻¹ mol per mol of organic silver salt.

In this invention, specifically preferred silver saving agents are compounds represented by the following formula (SE1) or (SE2).

The compound of formula (SE1) is represented as follows:
Q₁-NHNH-Q₂ Formula (SE1)
wherein Q₁ is an aromatic or heterocyclic group bonding at a carbon atom to —NHNH-Q₂; Q₂ is a carbamoyl group, an acyl group, an alkoxycarbonyl group, an aryloxycarbonyl group, a sulfonyl group or a sulfamoyl group.

In the formula (SE1), an aromatic or heterocyclic group represented by Q₁ is preferably a 5- to 7-membered unsaturated ring. Preferred examples thereof include a benzene ring, a pyridine ring, a pyrazine ring, pyrimidine ring, pyridazine ring, 1,2,4-triazine ring, 1,2,40triazine ring, 1,3,5-triazine ring, pyrrole ring, animidazole ring, a pyrazole ring, 1,2,3-triazole ring, 1,2,4-triazole ring, tetrazole ring, 1,3,4-thiadizole ring, 1,2,4-thiadiazole ring1,2,5-thiadiazole ring, 1,3,4-oxadiazole ring, 1,2,4-oxadiazole ring, 1,2,5-oxadiazole ring, a thiazole ring, oxazole ring, isothiazole ring, isooxazole ring, and a thiophene ring. These rings may be combined with each other to form a condensed ring and such a condensed ring is also preferable.

These rings may be substituted and when substituted by at substituents, the substituents may be the same or different. Examples of a substituent include a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, cyano, an alkylsulfonyl group, an arylsulfonyl group, an alkoxycarbonyl group, an aryloxycarbonyl group, and an acyl group. Of the foregoing groups, those which are capable of being substituted, may further be substituted. Examples of such a substituent include a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an arylcarbonyl group, a carbamoyl group, a sulfamoyl group, cyano, an alkylsulfonyl group, an arylsulfonyl group, and an acyloxy group.

A carbamoyl group represented by Q₂ is preferably one having 1 to 50 carbon atoms (more preferably 6 to 40 carbon atoms). Examples thereof include unsubstituted carbamoyl, methylcarbamoyl, N-ethylcarbamoyl, N-propylcarbamoyl, N-sec-butylcarbamoyl, N-ocylcarbamoyl, N-cyclohexylcarbamoyl, N-tert-butylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl and N-benzylcarbamoyl.

An acyl group represented by Q₂ is preferably one having 1 to 50 carbon atoms (more preferably 6 to 40 carbon atoms). Examples thereof include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 4-hydoxymethylbenzoyl. An alkoxycarbonyl group represented by Q₂ is preferably one having 2 to 50 carbon atoms (more preferably 6 to 40 carbon atoms). Examples thereof include methoxycarbonyl, ethoxycarbonyl, isobutyloxycarbonyl, cyclohexylcarbonyl, dodecyloxycarbonyl, and benzyloxycarbonyl.

An aryloxycarbonyl group represented by Q₂ is preferably one having 7 to 50 carbon atoms (more preferably 7 to 40 carbon atoms). Examples thereof include phenoxycarbonyl, 4-octyloxyphenoxycarbonyl, 2-hydroxymethylphenoxycarbonyl, and 4-dodecyloxyphenoxycarbonyl. A sulfonyl group represented by Q₂ is preferably one having 1 to 50 carbon atoms (more preferably 6 to 40 carbon atoms). Examples thereof include methylsulfinyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

A sulfamoyl group represented by Q₂ is preferably one having 0 to 50 carbon atoms (more preferably 6 to 40 carbon atoms). Examples thereof include unsubstituted sulfamoyl, N-ethylsulfamoyl, N-(2-ethylhextl)sulfamoyl, N-decylsulfamoyl, N-hexadecylsulfamoyl, N-{2-ethylhexyloxy}propyl}sulfamoyl, N-(2-chloro-5-dodecyloxycarbonylphenyl)sulfamoyl, and N-(2-tetradecyloxyphenyl)sulfamoyl. The group represented by Q₂ may be substituted at a position capable of being substituted, by the same substituent as cited in one of a 5- to 7-membered unsaturated ring, and when substituted by at least two substituents, such substituents may be the same or different from each other.

Next, a preferred region of the compound represented by formula (SE1) will be described. Q₁ is preferably a 5- or 6-membered unsaturated ring, and a benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thiazole ring, oxazole ring, isothiazole ring isooxazole ring or these rings condensed with a benzene or unsaturated heterocyclic ring are more preferred. Q is preferably a carbamoyl group, and one having a hydrogen atom on a N-atom is specifically preferred.

The compound represented by the formula (SE2) is as follows: 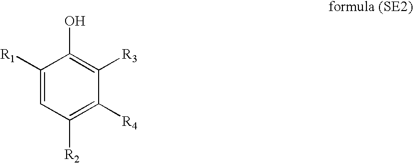
wherein R₁ is an alkyl group, an acyl group, an acylamino group, a sulfonamide group, an alkoxycarbonyl group or a carbamoyl group; R₂ is a hydrogen atom, an alkyl group, an alkoxy group, an aryloxy group, an alkylthio group, an arylthio group, an acyloxy group, or a carboxylic acid ester group; R₃ and R₄ are each a group capable of being substituted on a benzene ring, as cited in examples of a substituent of the foregoing formula (SE1), provided that R₃ and R₄ may combine with each other to form a ring.

R₁ is preferably an alkyl group having 1 to 20 carbon atoms (e.g., methyl, ethyl, isopropyl, butyl, tert-octyl, cyclohexyl), an acylamino group)e/g/., acetylamino, benzoylamino, methylureido, 4-cyanophenylureido) and a carbamoyl group (e.g., n-butylcarbamoyl, N,N-diethylcarbamoyl, phenylcarbamoyl, 2-chlorophenylcarbamoyl, 2,4-dichlorophenylcarbamoyl), and of these, an acylamino group (containing a ureido or urethane group) is more preferred. R₂ is preferably a halogen atom (more preferably, chlorine atom or bromine atom), an alkoxy group (e.g., methoxy, butoxy, n-hexyloxy, n-decyloxy, cyclohexyloxy, benzoyloxy) and an aryloxy group (e.g., phenoxy, naphthoxy).

R₃ is preferably a hydrogen atom, a halogen atom or an alkyl group having 1 to 20 carbon atoms, and a halogen atom is more preferred. R₄ is preferably a hydrogen atom, an alkyl group or an acylamino group, and an alkyl or acylamino group is more preferred. The foregoing groups may be substituted and examples of a substituent is the same as cited in R₁. When R₄ is an acylamino group, R₄ may combine with R₃ to form a carbostyryl ring.

In the formula (SE2), when R₃ and R₄ combine with each other to form a condensed ring, the condensed ring is preferably a naphthalene ring. The naphthalene ring may be substituted and examples of a substituent as cited as a substituent in formula (SE1). When a compound of formula (SE2) is a naphthol type compound, R₁ is preferably a carbamoyl group and more preferably a benzoyl group. R₂ is preferably an alkoxy group or aryloxy group and more preferably an alkoxy group.

Specific examples of a preferred silver saving agent are shown below, but are not limited to these.

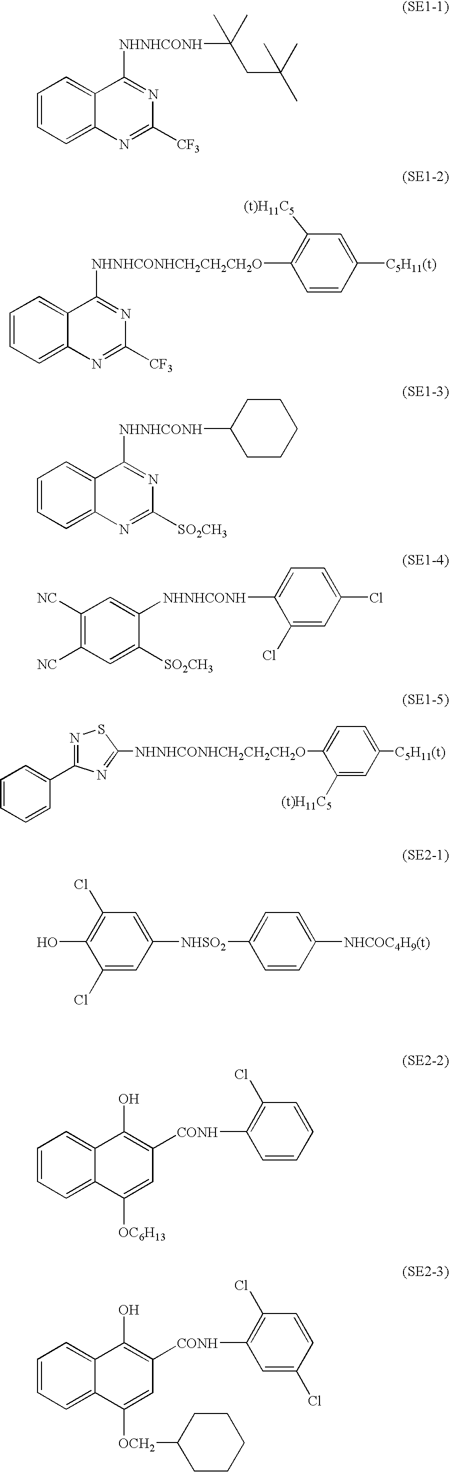

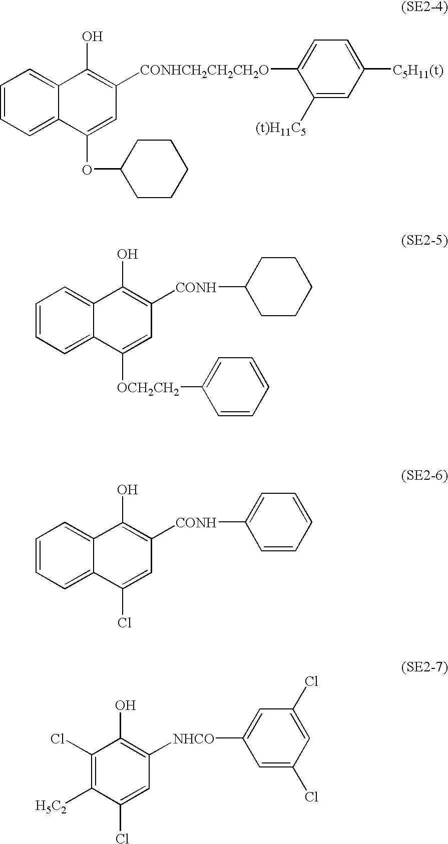

The photothermographic material of this invention preferably contains a thermal solvent. In this invention, the thermal is defined as a material capable of lowering the thermal developing temperature of a thermal solvent-containing photothermographic material by at least 1° C. (preferably at least 2° C., and more preferably at least 3° C.), as compared to a photothermographic material containing no thermal solvent. For example, a density obtained by developing a photothermographic material (B) containing no thermal solvent at 120° C. for 20 sec., can be obtained by developing a photothermographic material (A) in which a thermal solvent is added to the photothermographic material (B), at a temperature of 119° C. or less for the period of the same time as the photothermographic material (B).

A thermal solvent contains a polar group and is preferably a compound represented by the following formula (TS):
(Y)ₙZ formula (TS)
wherein Y is a group selected from an alkyl group, an alkenyl group, an alkynyl group, an aryl group or a heterocyclic group; Z is hydroxyl, carboxyl, an amino group, an amide group, a sulfonamido group, a phosphoric acid amide, cyano, imide, ureido, sulfonoxide, sulfone, phosphine, phosphineoxide and nitrogen-containing heterocyclic group; n is an integer of 1 to 3, provided that when Z is a mono-valent, n is 1 and when Z has a valence of two or more, n is the same as a valence number of Z, and when n is 2 or more, Ys may be the same or different.

Y may be substituted and examples of a substituent may be the same as represented by Z described above. In the formula (TS), Y is a straight, branched or cyclic alkyl group (preferably having 1-40 carbon atoms, more preferably 1-30, still more preferably 1-25 carbon atoms, e.g., methyl, ethyl, propyl, isopropyl, sec-butyl, tert-butyl, t-octyl, n-amyl, t-amyl, n-dodecyl,-n-tridecyl, octadecyl, icosyl, docosyl, cyclopentyl, cyclohexyl), alkenyl group (preferably having 2-40 carbon atoms, more preferably 2-30, still more preferably 2-25 carbon atoms, e.g., vinyl, allyl, 2-butenyl, 3-pentenyl), aryl group (preferably having 6-40 carbon atoms, more preferably 6-30, still more preferably 6-25 carbon atoms, e.g., phenyl, p-methylphenyl, naphthyl), heterocyclic group preferably having 2-20 carbon atoms, more preferably 2-16, still more preferably 2-12 carbon-atoms, e.g., pyridyl, pyrazyl, imidazolyl, pyrrolidyl). These substituents may be substituted and substituents may combine with each other to form a ring.

Y may be substituted and as examples of a substituent are cited those described in JP-A No. 2004-21068, paragraph [0015]. It is assumed, as the reason for the use of a thermal solvent activating development that the thermal solvent melts at a temperature near a developing temperature and solubilizes a material participating in development, rendering a reaction feasible at a temperature lower than the case containing no thermal solvent. Thermal development is a reduction reaction in which a carboxylic acid having a relatively high polarity or a silver ion carrier is involved. It is therefore preferred that a reaction field exhibiting an appropriate polarity is formed by a thermal solvent having a polar group.

The melting point of a thermal solvent is preferably 50 to 200° C., and more preferably 60 to 150° C. The melting point is preferably 100 to 150° C. specifically in a photothermographic material which places primary importance on stability to external environments, such as image fastness.

Specific examples of a thermal solvent include compounds described in JP-A No. 2004-21068, paragraph [0017] and compounds MF-1 through MF-3, MF-6, MF-7, MF-9 through MF-12 and MF-15 through MF-22.

A thermal solvent is contained preferably at 0.01 to 5.0 g/m², more preferably 0.05 to 2.5 g/m², and still more preferably 0.1 to 1.5 g/m². Thermal solvents may be contained singly or in combination thereof. A thermal solvent may be added to a coating solution in any form, such as a solution, emulsion or solid particle dispersion.

There is known a method in which a thermal solvent is dissolved using oil such as dibutyl phthalate, tricresyl phosphate, glyceryl triacetate or diethyl phthalate, and optionally an auxiliary solvent such as diethyl acetate or cyclohexanone, and is mechanically dispersed to obtain an emulsified dispersion.

Solid particle dispersion is prepared by dispersing powdery thermal solvent in an appropriate solvent such as water using a ball mill, a colloid mill, a vibration ball mill, a jet mill, a roller mill or a ultrasonic homogenizer. A protective colloid (e.g., polyvinyl alcohol), a surfactant (e.g., anionic surfactants such as sodium triisopropylnaphthalenesulfonate) may be used therein. In the foregoing mills, beads such as zirconia are usually used. Zr or the like is sometime dissolved out and mixed in the dispersion within a range of 1 to 1,000 ppm, depending dispersing conditions. A Zr content of 0.5 g or less per g of silver is acceptable to practical use. Aqueous dispersion preferably contains an antiseptic (e.g., benzoisothiazolinone sodium salt).

Any component layer of the photothermographic material of this invention preferably contains an antifoggant to inhibit fogging caused before being thermally developed and an image stabilizer to prevent deterioration of images after being thermally developed.

Next, there will be described an antifoggant and an image stabilizer usable in the photothermographic material of this invention.

Since bisphenols and sulfonamidophenols which contain a proton are mainly employed as a reducing agent, incorporation of a compound which generates reactive species capable of abstracting hydrogen is preferred to deactivate the reducing agent. It is also preferred to include a compound capable of oxidizing silver atoms or metallic silver (silver cluster) generated during storage of raw film or images. Specific examples of a compound exhibiting such a function include biimidazolyl compounds and iodonium compounds. The foregoing biimidazolyl compounds or iodonium compound is incorporated preferably in an amount of 0.001 to 0.1 mol/m² and more preferably 0.005 to 0.05 mol/m².

In cases when a reducing agent used in this invention is a compound containing an aromatic hydroxyl group (OH), specifically bisphenols, it is preferred to use a non-reducible compound capable of forming a hydrogen bond with such a group, for example, compounds (II-1) to (II-40) described in JP-A No. 2002-90937, paragraph [0061]-[064].

A number of compounds capable of generating a halogen atom as reactive species are knows as an antifoggant or an image stabilizer. Specific examples of a compound generating an active halogen atom include compounds of formula (9) described in JP-A No. 2002-287299, paragraph [0264]-[0271]. These compounds are incorporated preferably at an amount within the range of an increase of printed-out silver formed of silver halide being ignorable. Thus, the ratio to a compound forming no active halogen radical is preferably at most 150%, more preferably at most 100%. Specific examples of a compound generating-active halogen atom include compounds (III-1) to (III-23) described in paragraph [0086]-[0087] of JP-A NO. 2002-169249; compounds 1-1a to 1-1o, and 1-2a to 1-2o described in paragraph [0031] to [0034] and compounds 2a to 2z, 2aa to 2ll and 2-1a to 2-1f described in paragraph [00501-[0056] of JP-A No. 2003-50441; and compound 4-1 to 4-32 described in paragraph [0055] to [0058] and compounds 5-1 to 5-10 described in paragraph [0069] to [0072] of JP-A No. 2003-91054.

Examples of preferred antifoggants usable in this invention include compounds a to j described in [0012] of JP-A No. 8-314059, thiosufonate esters A to K described in [0028] of JP-A No. 7-209797, compounds (1) to (44) described on-page 14 of JP-A No.55-140833, compounds(I-1) to (I-6) described in [0063] and compounds (C-1) to (C-3) described in [0066] of JP-A No.2001-13627, compounds (III-1) to )III-108) described in [0027] of JP-A No. 2002-90937, vinylsulfone and/or β-halosulfone compounds VS-1 to VS-7 and HS-1 to HS-5 described in [0013] of JP-A-No. 6-208192, sulfonylbenzotriazole compounds KS-1 to KS-8 described in JP-A No. 2.00-330235, substituted propenenitrile compounds PR-01 to PR-08 described in JP-A No. 2000-515995 (published Japanese translation of PCT international publication for patent application) and compounds (1)-1 to (1)-132 described in [0042] to [0051] of JP-A No. 2002-207273. The foregoing antifoggant is used usually in an amount of at least 0.001 mol per mol of silver, preferably from 0.01 to 5 mol, and more preferably from 0.02 to 0.6 mol.

Compounds commonly known as other than the foregoing compounds may be contained in the photothermographic material of this invention, which may be a compound capable of forming a reactive species or a compound exhibiting a different mechanism of antifogging. Examples of such compounds include those described in U.S. Pat. No. 3,589,903, 4,546,075 and 4,452,885; JP-A No. 59-57234; U.S. Pat. Nos. 3,874,946 and 4,756,999; JP-A No. 59-57234, 9-188328 and 9-90550. Further, other antifoggants include, for example, compounds described in U.S. Pat. No. 5,028,523 and European Patent No. 600,587, 605,981 and 631,176.

The photothermographic material of this invention forms a photographic image upon thermal development and preferably contains an image toning agent to control image color in the form of dispersion in (organic binder matrix.

Examples of suitable image toning agents are described in RD 17029, U.S. Pat. Nos. 4,123,282, 3,994,732 and 4,021,249. Specific examples include imides (e.g. succinimide, phthalimide, naphthalimide, N-hydroxy-1,8-naphthalimide), mercaptans (e.g., 3-mercapto-1,24-triazole), phthalazinone derivatives and their metal salts (e.g., phthalazinone, 4-(1-naphthyl)phthalazinone, 6-chlorophthalazinone, 5,7-dimethyloxyphthalazinone, 2,3-dihydroxyl,4-phthalazine-dione), combination of phthalazine and phthalic acids (e.g., phthalic acid, 4-methylphthalic acid, 4-nitrophthalic acid, tetrachlorophthalic acid); combination of phthalazine and a compound selected from maleic acid anhydride, phthalic acid, 2.3-naphthalenedicarboxylic acid and o-phenylene acid derivatives and their anhydrides (e.g., phthalic acid, 4-methylpthalic acid, 4-nitrophthalic acid, tetrachlorophthalic acid anhydride). Of these, a specifically preferred image toning agent is a combination of phthalazinone or phthalazine, and phthalic acids or phthalic acid anhydrides.

To improve film tracking characteristics of thermal development apparatus and environmental suitability (accumulativeness in organ), fluorinated surfactants represented by the following formula (SF) are preferably used:
[R_{f}-(L₁)ₘ₁-]ₚ-(Y)ₙ₁-(A)_{q} formula (SF)
wherein R_{f} represents a fluorine-containing substituent, L₁ represents a bivalent linkage group containing no fluorine, Y represents a (p+q)-valent linkage group containing no fluorine, A represents an anion or its salt, m1 and n1 are each an integer of 0 or 1, p is an integer of 1 to 3, q is an integer of 1 to 3; provided that when q is 1, m1 and n1 are not zero at the same time. In the formula (SF), examples of R_{f} of a fluorine-containing substituent include a fluoroalkyl group having 1 to 25 carbon atoms (e.g., trifluoromethyl, trifluoroethyl, perfluoroethyl, perfluorobutyl, perfluorooctyl, perfluorododecyl, perfluorooctadecyl), and a fluoroalkenyl group (e.g., perfluoropropenyl, perfluorobutenyl, perfluorononenyl, perfluorododecenyl). R_{f} preferably contains 2 to 8 carbon atoms, and more preferably 2 to 6 carbon atoms. R_{f} preferably 2 to 12 fluorine atoms, and more preferably 3 to 12 fluorine atoms.

In the foregoing formula, L₁ represents a bivalent, fluorine-free linkage group. Examples of divalent linking groups containing no fluorine atom include an alkylene group (e.g., a methylene group, an ethylene group, and a butylene group),. an alkyleneoxy group (such as a methyleneoxy group, an ethyleneoxy group, or a butyleneoxy group), an oxyalkylene group (e.g., an oxymethylene group, an oxyethylene group, and an oxybutylene group), an oxyalkyleneoxy group (e.g., an oxymethyleneoxy group, an oxyethyleneoxy group, and an oxyethyleneoxyethyleneoxy group), a phenylene group, and an oxyphenylene group, a phenyloxy group, and an oxyphenyloxy group, or a group formed by combining these groups.

In the foregoing formula, A represents an anion group or a salt group thereof. Examples include a carboxylic acid group or salt groups thereof (sodium salts, potassium salts and lithium salts), a sulfonic acid group or salt groups thereof (sodium salts, potassium salts and lithium salts), a sulfuric acid half ester group or salt group thereof (sodium salts, potassium salts and lithium salts) and a phosphoric acid group and salt groups thereof (sodium salts, potassium salts and lithium salts).

In the foregoing formula, Y represents a fluorine-free linkage group having a valence of (p+q). Examples thereof include trivalent or tetravalent linking groups having no fluorine atom, which are groups of atoms comprised of a nitrogen atom as the center; n is an integer of 0 or 1, and preferably 1.

The fluorinated surfactants represented by the foregoing formula (SF) are prepared as follows. Alkyl compounds having 1 to 25 carbon atoms into which fluorine atoms are introduced (e.g., compounds having a trifluoromethyl group, a pentafluoroethyl group, a perfluorobutyl group, a perfluorooctyl group, or a perfluorooctadecyl group) and alkenyl compounds (e.g., a perfluorohexenyl group or a perfluorononenyl group) undergo addition reaction or condensation reaction with each of the tri- to hexa-valent alkanol compounds into which fluorine atom(s) are not introduced, aromatic compounds having 3 or 4 hydroxyl groups or hetero compounds. Anion group (A) is further introduced into the resulting compounds (including alkanol compounds which have been partially subjected to introduction of Rf) employing, for example, sulfuric acid esterification.

Examples of the aforesaid tri- to hexa-valent alkanol compounds include glycerin, pentaerythritol, 2-methyl-2-hydroxymethyl-1,3-propanediol, 2,4-dihydroxy-3-hydroxymethylpentane, 1,2,6-hexanrtriol. 1,1,1-tris(hydroxymethyl)propane, 2,2-bis(butanol), aliphatic triol, tetramethylolmethane, D-sorbitol, xylitol, and D-mannitol. The aforesaid aromatic compounds, having 3-4 hydroxyl groups and hetero compounds, include, for example, 1,3,5-trihydroxybenzene and 2,4,6-trihydroxypyridine.

Specific examples of a fluorinated surfactant include compounds (FS-1) through (FS-66) described in JP-A No. 2003-149766, paragraph [0029]-[0044]; compounds 1-1 through 1-4, described in JP-A No. 2004-021084; and compounds described in JP-A No. 2004-077792, paragraph [0025] and [0030].

Specific examples of fluorinated surfactants of formula (SF) are sown below.

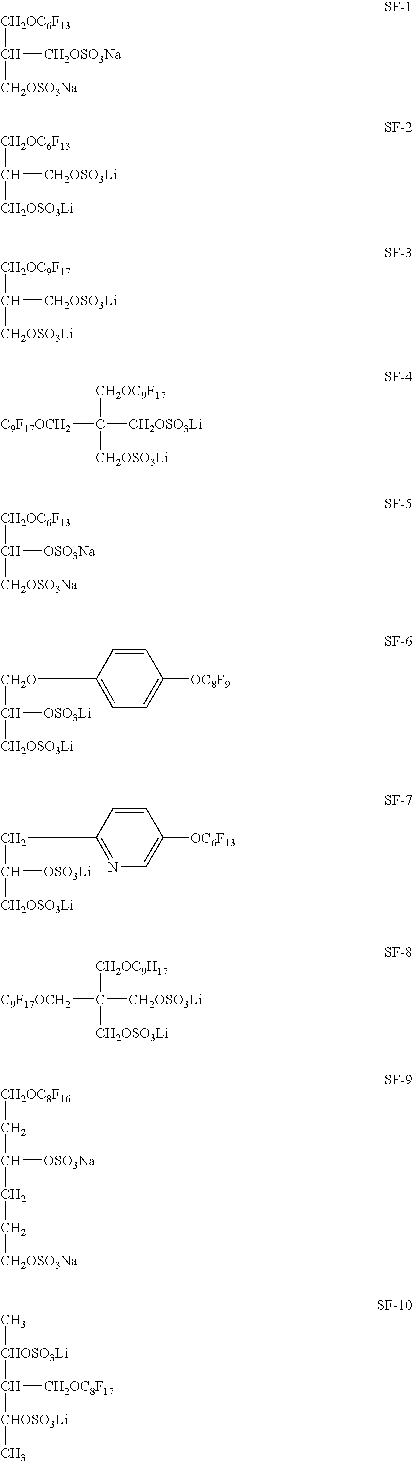

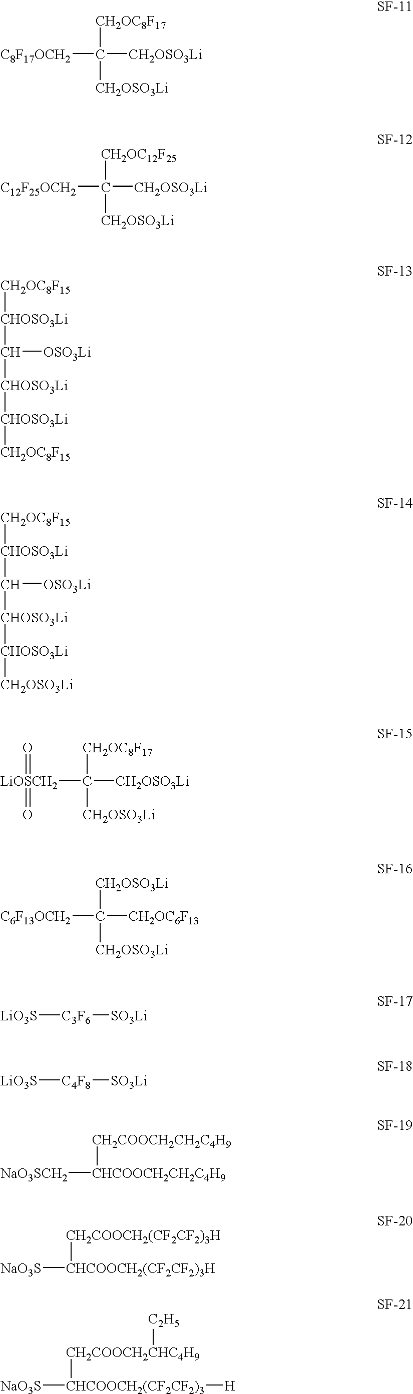

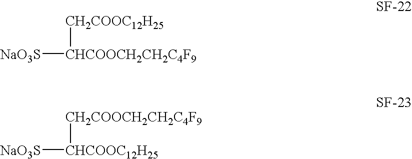

Fluorinated surfactants usable in this invention, other than the foregoing ones include compounds described in JP-A No. 2004-117505, paragraph [0035] and compounds described in JP-A Nos. 2000-214554, 2003-156819, 2003-177494, 2003-114504, 2003-270754 and 2003-270760.

The combined use of the foregoing anionic surfactants of formula (SF) and conventionally known nonionic fluorinated surfactants in the photothermographic material is preferred in terms of enhanced static property and coatability.

It is possible to add the fluorinated surfactants represented by the foregoing formula (SFY to liquid coating compositions, employing any conventional addition methods known in the art. Thus, they are dissolved in solvents such as alcohols including methanol or ethanol, ketones such as methyl-ethyl ketone.or acetone, and polar solvents such as dimethylformamide, and then added. Further, they may be dispersed into water or organic solvents in the form of minute particles at a maximum size of 1 μm, employing a sand mill, a jet mill, or an ultrasonic homogenizer and then added. Many techniques are disclosed for minute particle dispersion, and it is possible to perform dispersion based on any of these. It is preferable that the aforesaid fluorinated surfactants are added to the protective layer which is the outermost layer.

The added amount of the aforesaid fluorinated surfactants is preferably 1×10⁻⁸ to 1×10⁻¹ mol per m², more preferably 1×10⁻⁵ to 1×10⁻² mol per m². When the added amount is less than the lower limit, it is not possible to achieve desired charging characteristics, while it exceeds the upper limit, storage stability degrades due to an increase in humidity dependence.

The photothermographic material may contain lubricants. Commonly known lubricants, for example, described in JP-A No. 11-84573, paragraph [0061]-[0064], are usable, and solid lubricant particles or liquid lubricants at ordinary temperature are preferred. Examples of such liquid lubricants at ordinary temperature include compounds described in JP-A No. 2003-15259, paragraph [0019]. The use of organic solid lubricant particles having an average particle size of 1 to 30 μm is preferred and the melting point of the organic solid lubricant particles is preferably 110 to 200° C.

In the photothermographic material, the ten-point mean roughness (Rz), the maximum roughness (Rt) and the center-line mean roughness (Ra) are defined in JIS Surface Roughness (B0601). The JIS B 0601 also corresponds to ISO 468-1982, ISO 3274-1975, ISO 4287/1-1984, ISO 4287/2-1984 and ISO 4288-1985. The ten-point mean roughness is the value of difference, being expressed in micrometer (μm) between the mean value of altitudes of peaks from the heist to the 5th, measured in the direction of vertical magnification from a straight line that is parallel to the mean line and that does not intersect the profile, and the mean value of altitudes of valleys from the deepest to the 5th, within a sample portion, the length of which corresponds to the reference length, from the profile. The maximum roughness (Rt) of the surface is determined as follows. Thus, when a length corresponding to the reference length in the direction of a mean line is sampled from a roughness profile, the maximum roughness (Rt) is a value, expressed in micrometer (μm) measuring the space between a peak line and a valley line in the direction of vertical magnification of the profile. The center-line mean roughness (Ra), when the roughness curve is expressed by y=f(x), is a value, expressed in micrometer (μm), that is obtained from the following formula, extracting a part of reference length L in the direction of its center-line from the roughness curve, and taking the center-line of this extracted part as the X-axis and the direction vertical magnification as the Y-axis:

$$Ra = \frac{1}{L} {\int }_{0}^{L} \vert f ( x ) \vert ⅆ x$$

The measurement of Rz, Rt and Ra were made under an environment of 25° C. and 65% RH after allowed to stand under the same environment so that samples are not overlapped. The expression, samples are not overlapped means a method of winding with raising the film edge portion, overlapping with inserting paper between films or a method in which a frame is prepared with thick paper and its four corners are fixed. Measurement apparatuses usable in this invention include, for examples, RST PLUS non-contact three-dimensional micro-surface-form measurement system (WYKO Co.).

The Rz, Rt and Ra values can be adjusted so as to fall within the intended range by combination of the following technical means:

(1) the kind, average particle size, amount and a surface treatment method of a matting agent (inorganic or organic powder) contained in the layer of the image forming layer side and in the layer of the opposite side,

(2) dispersing conditions of the matting agent (e.g., the kind of a dispersing machine, dispersing time, the kind or the average particle size of beads used in the dispersion, the kind and amount of a dispersing agent, the kind of a polar group of a binder and its content),

(3) drying conditions in the coating stage (e.g., coating speed, distance from the coating side to the hot air nozzle, drying air volume) and residual solvent quantity,

(4) the kind of a filter used for filtration of coating solutions and filtration time, and

(5) when subjected to a calendering treatment after coating, its conditions (e.g., a calendering temperature of 40 to 80° C., a pressure of 50 to 300 kg/cm, a line-speed of 20 to 100 m and the nip number of 2 to 6).

In the invention, the value of Rz(E)/Rz(B) is preferably 0.1 to 0.7, more preferably 0.2 to 0.6, and still more preferably 0.3 to 0.5, whereby film tracking characteristics are improved and unevenness in density caused in thermal development is minimized. The designation, Rz(E) and RZ(B) are Rz values of the outermost surface of the image forming layer side and that of the opposite layer side, respectively.

The value of Ra(E)/Ra(B) is preferably 0.6 to 1.5, more preferably 0.6 to 1.3, and still more preferably 0.7 to 1.1, thereby resulting in minimized fogging during aging, enhanced film tacking characteristics and minimized unevenness in density, caused in thermal development.

In the photothermographic material of this invention, when matting agent(s) are contained in the outermost surface layer of the image forming layer side and the average. particle size of a matting agent exhibiting the maximum average particle size is designated as Le (μm), and matting agents are also contained in the outermost surface layer of the opposite side to the image forming layer and the average particle size of a matting agent.exhibiting the maximum average particle size is designated as Lb (μm), the ratio of Lb/Le is 2.0 to 10, and more preferably 3.0 to 4.5, thereby resulting in an improvement in unevenness of density. Further, the value of Rz(E)/Ra(E) of the image forming layer side is preferably 12 to 60, and more preferably 14 to 50, thereby resulting in improvements in unevenness of density and storage stability. The value of Rz(B)/Ra(B) is preferably 25 to 65, and more preferably 30 to 60, thereby resulting in improvements in unevenness of density and storage stability.

The foregoing surface roughness was evaluated in the following manner.

Using a noncontact three-dimensional surface analyzer (ST/PLUS, produced by WYKO Co.), a raw material sample which has not been subjected to thermal development, was measured as follows:

1) objective lens: ×10, intermediate lens: ×10

2) measurement range: 463.4 μm×623.9 μm

3) pixel size: 368×238

4) filter: cylinder correction and inclination correction

5) smoothing: medium smoothing

6) scanning speed: Low.

The foregoing Ra, Rz and Rt are defined in JIS Surface Roughness (B0601). A sample of 10 cm×10 cm was divided to 100 squares at intervals of 1 cm, the center of the respective square regions was measured and an average value was calculated from 100 measurements.

In one preferred embodiment of this invention, the surface layer contains a matting agent. In the surface layer of the photothermographic material (of the image forming layer side, and even when a non-image forming layer is provided on the opposite side of the support to the image forming layer), it is preferred to use organic or inorganic powder material as a matting agent to control the surface roughness. Specifically, it is preferred to use a powdery material exhibiting a Mohs hardness of at least 5. Powdery material can suitably be chosen from organic or inorganic powdery materials. Examples of inorganic powdery material include titanium oxide, barium sulfate, boron nitride, SnO₂, SiO₂, Cr₂O₃, α-Al₂O₃, α-Fe₂O₃, α-FeOOH, SiC, cerium oxide, corunmdum, artificial diamond, garnet, mica, siicate, silicon nitride and silicon carbide. Example of organic powdery material include polymethyl methacrylate, polystyrene, and Teflon (trade name). Of these, inorganic powder of SiO₂, titanium oxide, barium sulfate, α-Al₂O₃, α-Fe₂O₃, α-FeOOH, Cr₂O₃, or mica is preferred and SiO₂ and α-Al₂O₃ are more preferred, and SiO₂ is specifically preferred.

Of the foregoing powdery materials, those which have been subjected to a surface treatment, are preferred. The surface treatment layer is formed in the following manner. An inorganic raw material is subjected to dry-system pulverization, then water and a dispersing agent are added thereto and further subjected wet-system pulverization, and after subjected to centrifugal separation, coarse classification is conducted. Thereafter, the thus prepare particulate slurry is transferred to the surface treatment bath where surface coating of a metal hydroxide is performed. Thus, a prescribed amount of an aqueous solution of a salt of Al, Si, Ti, Zr, Sb, Sn, Zn or the like is added thereto and an acid or alkali is further added for neutralization to coat the inorganic powdery particulate surface with a hydrous oxide. Water-soluble salts as by-products are removed by decantation, filtration or washing. The slurry is adjusted to a specific pH value, filtered and washed with pure water. The thus washed cake is dried by a spray drier or a hand drier. Finally, the dried material is pulverized to obtain a product. Besides of the foregoing aqueous system, vapor of AlCl₃ or SiCl₄ may be introduced to non-magnetic inorganic powder, followed by introduction of water vapor to perform Al- or Si-surface treatment. Other surface treatment methods are referred to “Characterization of Powder Surfaces”, Academic-Press.

In this invention, it is preferred to perform a surface treatment using a silicon (Si) compound or Aluminum (Al) compound. The use of the thus surface-treated powder results in superior dispersion when preparing the dispersion of a matting agent. In that case, the Si content is preferably 0.1% to 10% by weight,.more preferably 0.1% to 5% by weight and still more preferably 0.1% to 2% by weight; the Al content is preferably 0.1% to 10% by weight, more preferably 0.1% to 5% by weight and still more preferably 0.1% to 2% by weight. The weight ratio of Si to Al is preferably Si<Al. The surface treatment can also be performed by the method described in JP-A No. 2-83219. With respect to the average particle size of a powdery material, that of spherical particle powder is its average diameter, that of a needle-form particle powder is the average major axis length and that of tabular particle powder is the average value of maximum diagonal lines on the tabular plane, which can readily be determined by electron microscopic observation.

The average particle size of the foregoing organic or inorganic powdery material is preferably 0.5 to 10 μm, and more preferably 1.0 to 8.0 μm. The average particle size of an organic or inorganic powdery material contained in the outermost layer of the image forming layer side is usually 0.5 to 8.0 μm, and preferably 2.0 to 5.0 μm; and the content is usually 1.0% to 20% by weight, based on the binder contained in the outermost layer (including cross0linking agents), preferably 2.0% to 15% by weight, and more preferably 3.0% to 10% by weight. The average particle size of an organic or inorganic powdery material contained in the outermost layer of the opposite side to the image forming layer is usually 2.0 to 15.0 μm, preferably 3.0 to 12.0 μm, and more preferably 4.0 to 10.0 μm; and the content is usually 0.2% to 10% by weight, based on the binder contained in the outermost layer (including cross0linking agents), preferably 0.4% to 7% by weight, and more preferably 0.6% to 5% by weight.

The coefficient of variation of powdery particle size distribution is preferably 505 or less, more preferably 405 or less, and still more preferably 30% or less. The coefficient of variation of particle size distribution is the value defined in the following equation:
{(standard deviation of particle size)/(average particle size)}×100.
Organic or inorganic powdery material may be dispersed in a coating solution and then coated. Alternatively, after coating a coating solution, organic or inorganic powdery material may be sprayed thereon. Plural powdery materials may employ the foregoing methods in combination.
Antihalation and Antuirradiation Layer.

It is preferred to form a filter layer on the same side as or on the opposite side to the light sensitive layer or to allow a dye or pigment to be contained in the light sensitive layer to control the amount of wavelength distribution of light transmitted through the light sensitive layer of photothermographic materials relating to this invention. Commonly known compounds having absorptions in various wavelength regions can used as a dye, in response to spectral sensitivity of the photothermographic material. In cases where the photothermographic material are applied as an image recording material using infrared light is preferred the use of squarilium dye containing a thiopyrylium nucleus (also called as thiopyrylium squarilium dye), squarilium dye containing a pyrylium nucleus (also called as pyrylium squarilium dye), thiopyrylium chroconium dye similar to squarilium dye or pyrylium chroconium. The compound containing a squarilium nucleus is a compound having a 1-cyclobutene-2-hydroxy-4one in the molecular structure and the compound containing chroconium nucleus is a compound having a 1-cyclopentene-2-hydroxy,4,5-dione in the molecular structure, in which the hydroxy group may be dissociated. Hereinafter, these dyes are collectively called a squarilium dye.

Further, compounds described in U.S. Pat. No. 5,380,635, JP-A Nos. 8-201959, 2002-040593, 2003-186135 and 2003-195450; U.S. Pat. No. 6,689,547 and U.S. Patent Application publication No. 20040259044 are also preferred as a dye.

Suitable supports used in the photothermographic imaging materials of the invention include various polymeric materials, glass, wool cloth, cotton cloth, paper, and metals (such as aluminum). Flexible sheets or roll-convertible one are preferred. Examples of preferred support used in the invention include plastic resin films such as cellulose acetate film, polyester film, polyethylene terephthalate film, polyethylene naphthalate film, polyamide film, polyimide film, cellulose triacetate film and polycarbonate film, and biaxially stretched polyethylene terephthalate (PET) film is specifically preferred. The support thickness is 50 to 300 μm, and preferably 70 to 180 μm.

To improve electrification properties of photothermographic imaging materials, metal oxides and/or conductive compounds such as conductive polymers may be incorporated into the constituent layer. These compounds may be incorporated into any layer and preferably into a sublayer, a backing layer, interlayer between the light sensitive layer and the sublayer. Conductive compounds described in U.S. Pat. No. 5,244,773, col. 14-20. Specifically, the surface protective layer of the backing layer side preferably contains conductive metal oxides, whereby advantageous effects of this invention (for example, tracking characteristics in thermal development) were proved to be enhanced.

The conductive metal oxide is crystalline metal oxide particles, and one which contains oxygen defects or one which contains a small amount of a heteroatom capable of forming a donor for the metal oxide, both exhibit enhanced conductivity and are preferred. The latter, which results in no fogging to a silver halide emulsion is preferred. Examples of metal oxide include ZnO, TiO₂, SnO₂, Al₂O₃, In₂O₃, SiO₂, MgO, BaO, MoO₃ and V₂O₅ and their combined oxides of these, ZnO, TiO₂ and SnO₂ are preferred. As an example of containing a heteroatom, addition of Al or In to ZnO, addition of Sb, Nb, P or a halogen element to SnO₂, and addition of Nb or Ta to TiO₂ are effective. The heteroatom is added preferably in an amount of 0.01 to 30 mol %, and more preferably 0.1 10 mol %. To improve particle dispersibility and transparency, a silicon compound may be added in the course of particle preparation.

The metal oxide particles have electric conductivity, exhibiting a volume resistance of 10⁷ Ω·cm or less and preferably 10⁵ Ω·cm or less. The foregoing metal oxide may be adhered to other crystalline metal oxide particles or, fibrous material (such as titanium oxide), as described in JP-A Nos. 56-143431, 56-120519 and 58-62647 and JP-B-No. 50-6235.

The particle size usable in this invention is preferably not more than 1 μm, and a particle size of not more than 0.5 μm results in enhanced stability after dispersion, rendering it easy to make use thereof. Employment of conductive particles of 0.3 μm or less enables to form a transparent photothermographic material. Needle-form or fibrous conductive metal oxide is preferably 30 μm or less in length and 1 μm or less in diameter, and more preferably 10 μm or less in length and 0.3 μm or less in diameter, in which the ratio of length to diameter is preferably 3 or more. SnO₂ is also commercially available from Ishihara Sangyo Co., Ltd., including SNS10M, SN-100P, SN-100D and FSS10M.

The photothermographic material of this invention is provided with at least one image forming layer as a light-sensitive layer on the support. There may be provided an image forming layer alone on the support but it is preferred to form at least one light-insensitive layer on the image forming layer. For instance, a protective layer may be provided on the image forming layer to protect the image forming layer. Further, to prevent blocking between photothermographic materials or adhesion of the photothermographic material to a roll, a back-coat layer may be provided on the opposite side of the support.

A binder used in the protective layer or the back coat layer can be chosen preferably from polymers having a higher glass transition point (Tg) than a binder used in the image forming layer and exhibiting resistance to abrasion or deformation, for example, cellulose acetate, cellulose butyrate or cellulose propionate.

To control gradation, at least two image forming layers may be provided on one side of the support or at least one image forming layer may be provided on both sides of the support.

Coating of Component Layer

It is preferable to prepare the silver salt photothermographic dry imaging material of the present invention as follows. Materials of each constitution layer as above are dissolved or dispersed in solvents to prepare coating compositions. Resultant coating compositions are subjected to simultaneous multilayer coating and subsequently, the resultant coating is subjected to a thermal treatment. “Simultaneous multilayer coating”, as described herein, refers to the following. The coating composition of each constitution layer (for example, a photosensitive layer and a protective layer) is prepared. When the resultant coating compositions are applied onto a support, the coating compositions are not applied onto a support in such a manner that they are individually applied and subsequently dried, and the operation is repeated, but are simultaneously applied onto a support and subsequently dried. Namely, before the residual amount of the total solvents of the lower layer reaches 70 percent by weight, the upper layer is applied.

Simultaneous multilayer coating methods, which are applied to each constitution layer, are not particularly limited. For example, are employed methods, known in the art, such as a bar coater method, a curtain coating method, a dipping method, an air knife method, a hopper coating method, and an extrusion method. Of these, more preferred is the pre-weighing type coating system called an extrusion-coating method. The extrusion coating method is suitable for accurate coating as well as organic solvent coating because volatilization on a slide surface, which occurs in a slide coating system, does not occur. Coating methods have been described for coating layers on the photosensitive layer side. However, the backing layer and the subbing layer are applied onto a support in the same manner as above.

In this invention, silver coverage is preferably from 0.3 to 1.5 g/m², and is more preferably from 0.5 to 1.5 g/m² for use in medical imaging. The ratio of the silver coverage which is resulted from silver halide is preferably from 2% to 18% with respect to the total silver, and is more preferably from 5% to 15%. Further, in the present invention, the number of coated silver halide grains, having a grain diameter (being a sphere equivalent grain diameter) of at least 0.01 μm, is preferably from 1×10¹⁴ to 1×10¹⁸ grains/m², and is more preferably from 1×10¹⁵ to 1×10¹⁷. Further, the coated weight of aliphatic carboxylic acid silver salts of the present invention is from 10¹⁷ to g per silver halide grain having a diameter (being a sphere equivalent grain diameter) of at least 0.01 μm, and is more preferably from 10¹⁶ to 10¹⁵ g. When coating is carried out under conditions within the aforesaid range, from the viewpoint of maximum optical silver image density per definite silver coverage, namely covering power as well as silver image tone, desired results are obtained.

The photothermographic material of this invention contains solvent preferably at 5 to 1,000 mg/m² when subjected to thermal development, and more preferably 100 to 500 mg/m²₁ thereby leading to enhanced sensitivity, reduced fogging and enhanced maximum density. Examples of such a solvents are described, for instance, in JP-A No. 2001-264936, paragraph [0030] but are not limited to thereto. The solvent may be used singly or in combination.

The solvent content in the photothermographic material can be controlled by adjusting conditions in the drying stage after coating, for example, temperature conditions. The solvent content can be determined by gas chromatography under the condition suitable for detection of contained solvents.

To prevent density change or fogging with time during storage or to improve curl or roll-set curl, it is preferred to pack the photothermographic material of this invention with a packaging material exhibiting a low oxygen permeability and/or moisture permeability. The oxygen permeability is preferably not more than 50 ml/atm·m²·day, more preferably-not more than 10 ml/atm·m²·day, and still more preferably not more than 1.0 ml/atm·m²·day. The moisture permeability is preferably not more than 0.01 g/m²·40° C.·90% RH·day (in accordance with JIS Z0208, Cap Method), more preferably not more than 0.005 g/m²·40° C.·90% RH·day, and still more preferably not more than 0.001 g/m²·40° C.·90% RH·day. Specific examples of packaging material include those described in JP-A Nos. 8-254793, 2000-206653, 2000-235241, 2002-062625, 2003-015261, 2003-057790, 2003-084397, 2003-098648, 2003-098635, 2003-107635, 2003-131337, 2003-146330, 2003-226439 and 2003-228152. The free volume within a package is preferably 0.01 to 10%, and preferably 0.02 to 5%, and it is also preferred to fill nitrogen within the package at a nitrogen partial pressure of at least 80%, preferably at least 90%. The relative humidity within the package is preferably 10% to 60%, and more preferably 40% to 55%.

Exposure used in the photothermographic material or the image forming method of this invention can employ various conditions with respect to a light source, exposure time and the like suitable for obtaining an intended appropriate images.

The silver salt photothermographic material of the present invention is preferably exposed using laser light to perform image recording. It is preferable to employ an optimal light source for the spectral sensitivity provided to the aforesaid photosensitive material. For example, when the aforesaid photosensitive material is sensitive to infrared radiation, it is possible to use any radiation source which emits radiations in the infrared region. However, infrared semiconductor lasers (at 780 nm and 820 nm) are preferably employed due to their high power, as well as ability to make photosensitive materials transparent.

The photothermographic material exhibits its characteristics when exposed to high illumination intensity light at an amount of at least 1 mW/mm² for a short period of time. The illumination intensity refers to one which gives an optical density of 3.0. When exposed tat a high intensity, an intended density can be obtained at a less mount of light i.e., (intensity)×(exposure time), whereby a high-speed system can be designed. The amount of light is preferably 2 mW/mm² to 50 W/mm², and more preferably 10 mW/mm² to 50 W/mm². Any light source meeting the foregoing is usable .in this invention but laser light is preferred. Examples of preferred laser light include a gas laser (Ar⁺, Kr⁺, He—Ne), YAG laser, dye laser, and a semiconductor laser. There are also usable semiconductor lasers exhibiting emission in the region of blue to violet (for example, exhibiting a peak intensity at a wavelength of 350 to 440 nm). NLH3000E semiconductor laser, available from Nichia Kagaku Co., Ltd., is cited as a high power semiconductor laser.

In the present invention, it is preferable that exposure is carried out utilizing laser scanning. Employed as the exposure methods are various ones. For example, listed as a preferable method is the method utilizing a laser scanning exposure apparatus in which the angle between the scanning surface of a photosensitive material and the scanning laser beam does not substantially become vertical. “Does not substantially become vertical”, as described herein, means that during laser scanning, the nearest vertical angle is preferably from 55 to 88 degrees, is more preferably from 60 to 86 degrees, and is most preferably from 70 to 82 degrees.

When the laser beam scans photosensitive materials, the beam spot diameter on the exposed surface of the photosensitive material is preferably at most 200 μm, and is more preferably at most 100 mm, and is more preferably at most 100 μm. It is preferable to decrease the spot diameter due to the fact that it is possible to decrease the deviated angle from the verticality of laser beam incident angle. Incidentally, the lower limit of the laser beam spot diameter is 10 μm. By performing the laser beam scanning exposure, it is possible to minimize degradation of image quality according to reflection light such as generation of unevenness analogous to interference fringes.

Further, as the second method, exposure in the present invention is also preferably carried out employing a laser scanning exposure apparatus which generates a scanning laser beam in a longitudinal multiple mode, which minimizes degradation of image quality such as generation of unevenness analogous to interference fringes, compared to the scanning laser beam in a longitudinal single mode. The longitudinal multiple mode is achieved utilizing methods in which return light due to integrated wave is employed, or high frequency superposition is applied. The longitudinal multiple mode, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

In the third preferred embodiment of the invention, it is preferred to form images by scanning exposure using at least two laser beams. The image recording method using such plural laser beams is a technique used in image-writing means of a laser printer or a digital copying machine for writing images with plural lines in a single scanning to meet requirements for higher definition and higher speed, as described in JP-A 60-166916. This is a method in which laser light emitted from a light source unit is deflection-scanned with a polygon mirror and an image is formed on the photoreceptor through an fθ lens, and a laser scanning optical apparatus similar in principle to an laser imager.

In the image-writing means of laser printers and digital copying machines, image formation with laser light on the photoreceptor is conducted in such a manner that displacing one line from the image forming position of the first laser light, the second laser light forms an image from the desire of writing images with plural lines in a single scanning. Concretely, two laser light beams are close to each other at a spacing of an order of some ten μm in the sub-scanning direction on the image surface; and the pitch of the two beams in the sub-scanning direction is 63.5 μm at a printing density of 400 dpi and 42.3 μm at 600 dpi (in which the printing density is represented by “dpi”, i.e., the number of dots per inch). As is distinct from such a method of displacing one resolution in the sub-scanning direction, one feature of the invention is that at least two laser beams are converged on the exposed surface at different incident angles to form images. In this case, when exposed with N laser beams, the following requirement is preferably met: when the exposure energy of a single laser beam (of a wavelength of λ nm) is represented by E, writing with N laser beam preferably meets the following requirement:
0.9×E≦En×N≦1.1×E
in which E is the exposure energy of a laser beam of a wavelength of λ nm on the exposed surface when the laser beam is singly exposed, and N laser beams each are assumed to have an identical wavelength and an identical exposure energy (En). Thereby, the exposure energy on the exposed surface can be obtained and reflection of each laser light onto the image forming layer is reduced, minimizing occurrence of an interference fringe.

In the foregoing, plural laser beams having a single wavelength are employed but lasers having different wavelengths may also be employed. In such a case, the wavelengths preferably fall within the following range:
(λ−30)<λ₁, λ₂, . . .λₙ<(λ+30).

In the first, second and third preferred embodiments of the image recording method of the invention, lasers for scanning exposure used in the invention include, for example, solid-state lasers such as ruby laser, YAG laser, and glass laser; gas lasers such as He—Ne laser, Ar laser, Kr ion laser, CO₂ laser, Co laser, He—Cd laser, N₂ laser and eximer laser; semiconductor lasers such as InGa laser, AlGaAs laser, GaAsP laser, InGaAs laser, InAsP laser, CdSnP₂ laser, and GSb laser; chemical lasers; and dye lasers. Of these, semiconductor lasers of wavelengths of 600 to 1200 nm are preferred in terms of maintenance and the size of the light source. When exposed onto the photothermographic imaging material in the laser imager or laser image-setter, the beam spot diameter on the exposed surface is 5 to 75 μm as a minor axis diameter and 5 to 100 μm as a major axis diameter. The laser scanning speed is set optimally for each photothermographic material, according to its sensitivity at the laser oscillation wavelength and the laser power.

### EXAMPLES

The present invention will be further described based on examples but is by no means limited to these. Unless specifically noted, “%” designates percent by weight.

### Example 1

Preparation of Subbed Photographic Support

A photographic support comprised of a 175 μm thick biaxially oriented polyethylene terephthalate film with blue tinted at an optical density of 0.170 (determined by Densitometer PDA-65, manufactured by Konica Corp.), which had been subjected to corona discharge treatment of 8 W·minute/m² on both sides, was subjected to subbing. Namely, subbing liquid coating composition a-1 was applied onto one side of the above photographic support at 22° C. and 100 m/minute to result in a dried layer thickness of 0.2 μm and dried at 140° C., whereby a subbing layer on the image forming layer side (designated as Subbing Layer A-1) was formed. Further, subbing liquid coating composition b-1 described below was applied, as a backing layer subbing layer, onto the opposite side at 22° C. and 100 m/minute to result in a dry layer thickness of 0.12 μm and dried at 140° C. An electrically conductive subbing layer (designated as subbing lower layer B-1), which exhibited an antistatic function, was applied onto the backing layer side. The surface of subbing lower layer A-1 and subbing lower layer B-1 was subjected to corona discharge treatment of 8 W·minute/m². Subsequently, subbing liquid coating composition a-2 was applied onto subbing lower layer A-1 was applied at 33° C. and 100 m/minute to result in a dried layer thickness of 0.03 μm and dried at 140° C. The resulting layer was designated as subbing upper layer A-2. Subbing liquid coating composition b-2 described below was applied onto subbing lower layer B-1 at 33° C. and 100 m/minute to results in a dried layer thickness of 0.2 μm and dried at 140° C. The resulting layer was designated as subbing upper layer B-2. Thereafter, the resulting support was subjected to heat treatment at 123° C. for two minutes and wound up under the conditions of 25° C. and 50 percent relative humidity, whereby a subbed sample was prepared. 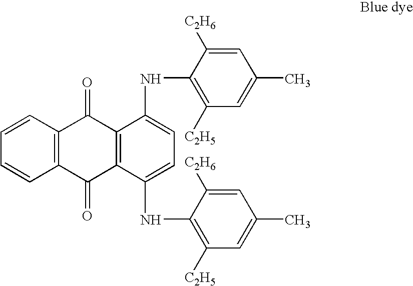
Preparation of Water-based Polyester A-1

A mixture consisting of 35.4 parts by weight of dimethyl terephthalate, 33.63 parts by weight of dimethyl isophthalate, 17.92 parts by weight of sodium salt of dimethyl 5-sulfoisophthalatel 62 parts by weight of ethylene glycol, 0.065 part by weight of calcium acetate monohydrate, and 0.022 part by weight of manganese acetate tetrahydrate underwent trans-esterification at 170 to 220° C. under a flow of nitrogen while distilling out methanol. Thereafter, 0.04 parts by weight of trimethyl phosphate, 0.04 part by weight of antimony trioxide, and 6.8 parts by weight of 4-cyclohexanedicarboxylic acid were added. The resulting mixture underwent esterification at a reaction temperature of 220 to 235° C. while a nearly theoretical amount of water being distilled away.

Thereafter, the reaction system was subjected to pressure reduction and heating over a period of one hour and was subjected to polycondensation at a final temperature of 280° C. and a maximum pressure of 133 Pa for one hour, whereby water-soluble polyester A-1 was synthesized. The intrinsic viscosity of the resulting water-soluble polyester A-1 was 0.33, the average.particle size was 40 nm, and Mw was 80,000 to 100,000.

Subsequently, 850 ml of pure water was placed in a 2-liter three-necked flask fitted with stirring blades, a refluxing cooling pipe, and a thermometer, and while rotating the stirring blades, 150 g of water-soluble polyester A-1 was gradually added. The resulting mixture was stirred at room temperature for 30 minutes without any modification. Thereafter, the interior temperature was raised to 98° C. over a period of 1.5 hours and at that resulting temperature, dissolution was performed. Thereafter, the temperature was lowered to room temperature over a period of one hour and the resulting product was allowed to stand overnight, whereby water-based polyester A-1 solution was prepared.

Preparation of Modified Water-based Polyester Solution

Into a 3-liter four-necked flask fitted with stirring blades, a reflux cooling pipe, a thermometer, and a dropping funnel was put 1,900 ml of the aforesaid 15 percent by weight water-based polyester A-1 solution, and the interior temperature was raised to 80° C., while rotating the stirring blades. Into this was added 6.52 ml of a 24 percent aqueous ammonium peroxide solution, and a monomer mixed liquid composition (consisting of 28.5 g of glycidyl methacrylate, 21.4 g of ethyl acrylate, and 21.4 g of methyl methacrylate) was dripped over a period of 30 minutes, and reaction was allowed for an additional 3 hours. Thereafter, the resulting product was cooled to at most 30° C., and filtrated, whereby modified water-based polyesters solution B-1 (vinyl based component modification ratio of 20 percent by weight) of 18 wt % solid was obtained.

Subsequently, modified water-based polyester B-2 at a solid concentration of 18 percent by weight (a vinyl based component modification ratio of 20 percent by weight) was prepared in the same manner as above except that the vinyl modification ratio was changed to 36 percent by weight and the modified component was changed to styrene:glycidyl methacrylate:acetacetoxyethyl methacrylate:n-butyl acrylate=39.5:40:20:0.5.

Preparation of Acryl Based Polymer Latexes C-1 to C-3

Acryl based polymer latexes C-1 to C-3 having the monomer compositions shown in Table 1 were synthesized employing emulsion polymerization. All the solid concentrations were adjusted to 30 percent by weight.

TABLE 1

| Latex | | Tg |
|---|---|---|
| No. | Monomer Composition (weight ratio) | (° C.) |
| C-1 | styrene:glycidyl methacrylate:n-butyl acrylate = 20:40:40 | 20 |
| C-2 | styrene:n-butyl acrylate:t-butyl acrylate:hydroxyethyl | 55 |
| | methacrylate = 27:10:35:28 | |
| C-3 | styrene:glycidyl methacrylate:acetoacetoxyethyl | 50 |
| | methacrylate = 40:40:20 | |

Coating Composition (a-1) of Subbing Lower Layer A-1
on Image Forming Layer Side

| | | |
|---|---|---|
| Acryl Based Polymer Latex C-3 (30% solids) | 70.0 | g |
| Aqueous dispersion of ethoxylated alcohol | 5.0 | g |
| and ethylene homopolymer (10% solids) | | |
| Surfactant (A) | 0.1 | g |
| Distilled water to make | 1000 | ml |

Coating Composition (a-2) of Image Forming Layer Side
Subbing Upper Layer

| | | |
|---|---|---|
| Modified Water-based Polyester B-2 (18 wt %) | 30.0 | g |
| Surfactant (A) | 0.1 | g |
| Spherical silica matting agent (Sea Hoster | 0.04 | g |
| KE-P50, manufactured by Nippon Shokubai | | |
| Co., Ltd.) | | |
| Distilled water to make | 1000 | ml |

Coating Composition (b-1) of Backing Layer Side Subbing
Lower Layer

| | | |
|---|---|---|
| Acryl Based Polymer Latex C-1 (30% solids) | 30.0 | g |
| Acryl Based Polymer Latex C-2 (30% solids) | 7.6 | g |
| SnO₂ sol* | 180 | g |
| Surfactant (A) | 0.5 | g |
| Aqueous 5 wt. % PVA-613 (PVA, manufactured | 0.4 | g |
| by Kuraray Co., Ltd.) | | |
| Distilled water to make | 1000 | ml |

Coatings Composition (b-2) of Backing Layer Side Subbing
Upper Layer

| | | |
|---|---|---|
| Modified Water-based Polyester B-1 (18% | 145.0 | g |
| by weight) | | |
| Spherical silica matting agent (Sea Hoster | 0.2 | g |
| KE-P50, manufactured by Nippon Shokubai | | |
| Co., Ltd.) | | |
| Surface Active Agent (A) | 0.1 | g |
| Distilled water to make | 1000 | ml |

*The solid concentration of SnO₂ sol synthesized employing the method described in Example 1 of JP-B No. 35-6616 was heated and concentrated to reach a solid concentration of 10 percent by weight, and subsequently, the pH was adjusted to 10 by the addition of ammonia water.

On the subbing layer A-2 on the subbed support, a back coat layer and a protective layer of the back coat layer having the following composition were coated. 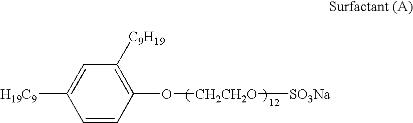
Preparation of Coating Solution of Back Coat Layer

Into 830 g of methyl ethyl ketone (also denoted simply as MEK), 84.2 g of cellulose acetate propionate (CAP482-20, available form Eastman Chemical Co.) and 4.5 g of polyester resin (Vitel PE2200B, available from Bostic Co.) were added and dissolved with stirring. Subsequently, to this solution, 0.30 g of the following infrared dye 1 was added and further thereto, 4.5 g of a fluorinated surfactant (Surflon KH40, available from Asahi Glass Co., Ltd.) and 2.3 g of a fluorinated surfactant Megafac F120K, available from Dainippon Ink Co., Ltd.) which.were dissolved in 43.2 g of methanol, were added and sufficiently stirred until dissolved. Then, 2.5 g of oleyl oleate was added with stirring to prepare a coating solution of the back coat layer. 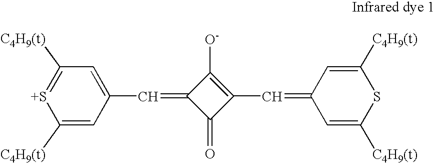
Preparation of Coating Solution of Back Coat Protective Layer

Similarly to the foregoing coating solution of the back coat layer, a coating solution of the protective layer for the back coat layer was prepared according to the following composition, in which silica was dispersed in MEK at a concentration of 1% using a dissolver type homogenizer and finally added.

| | | |
|---|---|---|
| Cellulose acetate propionate (10% MEK solution | 15 | g |
| CAP482-20, Eastman Chemical Co. | | |
| Monodisperse silica (having a monodisperse | 0.03 | g |
| degree of 15% and average grain size of 10 μm | | |
| and surface-treated with aluminum at 1% of | | |
| the whole silica) | | |
| C₈F₁₇(CH₂CH₂O)₁₂C₈F₁₇ | 0.075 | g |
| Fluorinated surfactant (SF-17) | 0.01 | g |
| Fluoropolymer (FM-1) | 0.05 | g |
| Stearic acid | 0.1 | g |
| Butyl stearate | 0.1 | g |
| α-alumina (Mohs hardness 9) | 0.1 | g |

Preparation of Silver Halide Emulsion A1
Solution A1

| | | |
|---|---|---|
| Phenylcarbamoyl-modified gelatin | 88.3 | g |
| Compound (AO-1)* (10% aqueous | 10 | ml |
| methanol solution) | | |
| Potassium bromide | 0.32 | g |
| Water to make | 5429 | ml |

Solution B1

| | | |
|---|---|---|
| 0.67 mol/L aqueous silver nitrate | 2635 | ml |
| solution | | |

Solution C1

| | | |
|---|---|---|
| Potassium bromide | 50.69 | g |
| Potassium iodide | 2.66 | g |
| Water to make | 660 | ml |

Solution D1

| | | |
|---|---|---|
| Potassium bromide | 151.6 | g |
| Potassium iodide | 7.67 | g |
| Potassium hexachloroiridium (IV) K₃IrCl₆ | 0.93 | ml |
| (1% aqueous solution) | | |
| Potassium hexacyanoiron (II) | 0.004 | g |
| Potassium hexachloroosmium (IV) | 0.004 | g |
| Water to make | 1982 | ml |

Solution E1

0.4 mol/L aqueous potassium bromide solution
in an amount to control silver potential

Solution F1

| | | |
|---|---|---|
| Potassium hydroxide | 0.71 | g |
| Water to make | 20 | ml |

Solution G1

| | | |
|---|---|---|
| 56% aqueous acetic acid solution | 18.0 | ml |

Solution H1

| | | |
|---|---|---|
| Sodium carbonate anhydride | 1.72 | g |
| Water to make | 151 | ml |

*Compound (AO-1): HO(CH₂CH₂O)ₙ(CH(CH₃)CH₂O)₁₇(CH₂CH₂O)ₘH (m + n = 5 to 7)

Upon employing a mixing stirrer shown in JP-B No. 58-58288, ¼ portion of solution B1 and whole solution C1 were added to solution A1 over 4 minutes 45 seconds, employing a double-jet precipitation method while adjusting the temperature to 20° C. and the pAg to 8.09, whereby nuclei were formed. After one minute, whole solution F1 was added. During the addition, the pAg was appropriately adjusted employing Solution E1. After 6 minutes, ¾ portions of solution B1 and whole solution D1 were added over 14 minutes 15 seconds, employing a double-jet addition method while adjusting the temperature to 20° C. and the pAg to 8.09. After stirring for 5 minutes, the mixture was heated to 40° C., and whole solution G1 was added, whereby a silver halide. emulsion was flocculated. Subsequently, while leaving 2000 ml of the flocculated portion, the supernatant was removed, and 10 L of water was added. After stirring, the silver halide emulsion was again flocculated. While leaving 1,500 ml of the flocculated portion, the supernatant was removed. Further, 10 L of water was added. After stirring, the silver halide emulsion was flocculated. While leaving 1,500 ml of the flocculated portion, the supernatant was removed. Subsequently, solution H1 was added and the resultant mixture was heated to 60° C., and then stirred for an additional 120 minutes. Finally, the pH was adjusted to 5.8 and water was added so that the weight was adjusted to 1,161 g per mol of silver, whereby a light-sensitive silver halide emulsion A1 was prepared.

The prepared emulsion was comprised of monodisperse cubic silver iodobromide grains (iodide content 3.5 mol %) .having.an average grain size of 25 nm, 12 percent of a coefficient of variation of grain size (hereinafter, also denoted as a grain size variation coefficient) and a (100) crystal face ratio of 92 percent.

Preparation of Silver Halide Emulsion A2

Similarly to the foregoing silver halide emulsion A1, light-sensitive silver halide emulsion A2 was prepared, except that after adding the total amount of solution F1 after nucleation, 40 ml of an 4% aqueous solution of 4-hydroxy-6-methyl-1,3,3a,7-tetrazaindene was added. The prepared emulsion was comprised of monodisperse cubic silver iodobromide grains (iodide content 3.5 mol %) having an average grain size of 25 nm, a grain size variation coefficient of 12 percent and a (100) crystal face ratio of 92 percent.

Preparation of Silver Halide Emulsion A3

Similarly to the foregoing silver halide emulsion A1, light-sensitive silver halide emulsion A3 was prepared, except that after nucleation, the total amount of solution F1 was added and then, 4 ml of a 16 ethanol solution of the following compound (TPPS) was added thereto. The prepared emulsion was comprised of monodisperse cubic silver iodobromide grains (iodide content 3.5 mol %) having an average grain size of 25 nm, a grain size variation coefficient of 12 percent and a (100) crystal face ratio of 92 percent. 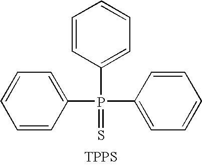
Preparation of Silver Halide Emulsion B1

Similarly to the silver halide emulsion A1, light-sensitive silver halide emulsion B1 was prepared, except that the double jet addition was conducted at 40° C. The prepared emulsion was comprised of monodisperse cubic silver iodobromide grains (iodide content 3.5 mol %) having an average grain size of 55 nm, a grain size variation coefficient of 12 percent and a (100) crystal face ratio of 92 percent.

Preparation of Silver Halide Emulsion B1

Similarly to the foregoing silver halide emulsion B1, light-sensitive silver halide emulsion B2 was prepared, except that after nucleation, the whole amount of solution F1 was added and then, 4 ml of a 0.1% ethanol solution of the foregoing compound (TPPS) was added thereto. The prepared emulsion was comprised of monodisperse cubic silver iodobromide grains (iodide content 3.5 mol %) having an average grain size of 55 nm, a grain size variation coefficient of 12 percent and a (100) crystal face ratio of 92 percent.

Preparation of Powdery Organic Silver Salt

In 4,720 ml of pure water were dissolved 130.8 g of behenic acid, 67.7 g of arachidic acid, 43.6 g of stearic acid, and 2.3 g of palmitic acid at 80° C. Subsequently, 540.2 ml of a 1.5 M aqueous sodium hydroxide solution was added, and further, 6.9 ml of concentrated nitric acid was added. Thereafter, the resultant mixture was cooled to 55° C., whereby an aliphatic acid sodium salt solution was prepared. While maintaining the aliphatic acid sodium salt solution at 55° C., the light-sensitive silver halide emulsion (in an amount shown in Table 2) and 450 ml of pure water were added and stirred for 5 min.

Subsequently, 468.4 ml of 1 mol/L silver nitrate solution was added over 2 min. and stirred for 10 min., whereby an organic silver salt dispersion was prepared. Thereafter, the organic silver salt dispersion was transferred to a water washing machine, and deionized water was added. After stirring, the resultant dispersion was allowed to stand, whereby a flocculated organic silver salt was allowed to float and was separated, and the lower. portion, containing water-soluble salts, were removed. Thereafter, washing was repeated employing deionized water until electric conductivity.of the resultant effluent reached 2 μS/cm. After centrifugal dehydration, the resultant cake-shaped aliphatic carboxylic acid silver salt was dried employing an gas flow type dryer Flush Jet Dryer (manufactured by Seishin Kigyo Co., Ltd.), while setting the drying conditions such as nitrogen gas as well as heating flow temperature at the inlet of the dryer (65° C. at the inlet and 40° C. at the outlet), until its moisture content reached 0.1 percent, whereby powdery organic silver salt was prepared. From electrbn-microscopic observation of photothermographic material sample 119 which was prepared using this organic silver salt, the organic silver salt was comprised of tabular grains having an average grain size (equivalent circle diameter) of 0.08 μm, an aspect ratio of 5 and a monodisperse degree of 10%.

The moisture content of the organic silver salt compositions was determined employing an infrared moisture meter.

Preparation of Preliminary Dispersion A

In 1457 g of methyl ethyl ketone (hereinafter referred to as MEK) was dissolved 14.57 g of poly(vinyl butyral) exhibiting a Tg of 75° C. and containing a SO₃K group at 0.2. mmol/g, as a binder of the light-sensitive layer (Image forming layer). While stirring by dissolver DISPERMAT Type CA-40M (manufactured by VMA-Getzmann Co.), 500 g of the foregoing powdery organic silver salt was gradually added and sufficiently mixed, and preliminary dispersion A was thus prepared.

Preparation of Light-sensitive Dispersion

Preliminary dispersion A, prepared as above, was charged into a media type homogenizer DISPERMAT Type SL-Cl2EX (manufactured by VMA-Getzmann Co.), filled with 0.5 mm diameter zirconia beads (Toreselam, produced by Toray Co.) so as to occupy 80 percent of the interior volume so that the retention time in the mill reached 1.5 minutes and was dispersed at a peripheral rate of the mill of 8 m/second, whereby light-sensitive emulsion dispersed solution was prepared.

Preparation of Stabilizer Solution

Stabilizer solution was prepared by dissolving 1.0 g of stabilizer land 0.31 g of potassium acetate in 4.97 g of methanol.

Preparation of Infrared Sensitizing Dye A Solution

Infrared sensitizing dye A solution was prepared by dissolving 9.6 mg of infrared sensitizing dye 1, 9.6 mg of infrared sensitizing dye 2, 1.488 g of 2-chloro-benzoic acid, 2.779 g of stabilizer 2, and 365 mg of 5-methyl-2-mercaptobenzimidazole in 31.3 ml of MEK in a dark room.

Preparation of Additive Solution a

Additive solution a was prepared by dissolving a reducing agent (as shown in Table 2), 0.159 g of compound (YAMl) of the foregoing formula (YB), 0.159 g of cyan color forming leuco dye (as shown in Table 2), 1.54 g of 4-methylphthalic acid, and 0.48 g of aforesaid infrared dye 1 in 110.0 g of MEK.

Preparation of Additive Solution b

Additive Solution b was prepared by dissolving 1.56 g of Antifoggant 2, 0.5 g of antifoggant 3, 0.5 g of antifoggant 4, 0.5 g of antifoggant 5 and 3.43 g of phthalazine in 40.9 g of MEK.

Preparation of Additive Solution c

Additive Solution c was prepared by dissolving 0.05 g of silver saving agent (SE1-1) in 39.95 g of MEK.

Preparation of Additive Solution d

Additive Solution d was prepared by dissolving 0.1 g of supersensitizer 1 in 9.9 g of MEK.

Preparation of Additive Solution e

Additive Solution e was prepared by dissolving 0.5 g of potassium p-toluenesulfonate and 0.5 g of antifoggant 6 in 9.0 g of MEK.

Preparation of Additive Solution f

Additive solution f was prepared by dissolving an antifoggant containing vinylsulfone [(CH₂═CH—SO₂CH₂)₂CHOH] in 9.0 g of MEK.

Preparation of Light-sensitive Layer Coating Composition

While stirring, 50 g of the foregoing light-sensitive dispersion (shown in Table 2) and 15.11 g of MEK were mixed and the resultant mixture was maintained at 21° C., then, 1000 μl of chemical sensitizer S-5 (0.5% methanol solution) and after 2 min., 390 μl of antifoggant 1 (10% methanol solution) was added thereto and stirred for 1 hr. Further, 494 μl of calcium bromide (10% methanol solution) was added and after stirred for 10. minutes, gold sensitizer Au-5 corresponding to 1/20 mol of the foregoing chemical sensitizer was added. Subsequently, 167 μl of the foregoing stabilizer solution was added and stirred for 10 minutes. Thereafter, 1.32 g of the foregoing infrared sensitizing dye A was added and the resulting mixture was stirred for one hour. Subsequently, the resulting mixture was cooled to 13° C. and stirred for 30 min. While maintaining at 13° C., 0.5 g of additive solution d, 0.5 g of additive solution e, 0.5 g of additive solution f and 13.31 g of the binder used in the preliminary dispersion A were added and stirred for 30 min. Thereafter, 1.084 g of tetrachlorophthalic acid (9.4% MEK solution) was added and stirred for 15 minutes. Further, while stirring, 12.43 g of additive solution a, 1.6 ml of Desmodur N3300 (aliphatic isocyanate, manufactured by Mobay Chemical Co. 100% MEK solution), 4.27 g of additive solution b and 4.0 g of additive solution c were successively added, whereby light-sensitive layer coating composition was prepared.

Additives used in the respective coating solutions and the coating solution of the image forming layer are shown with respect to their structures, as below.

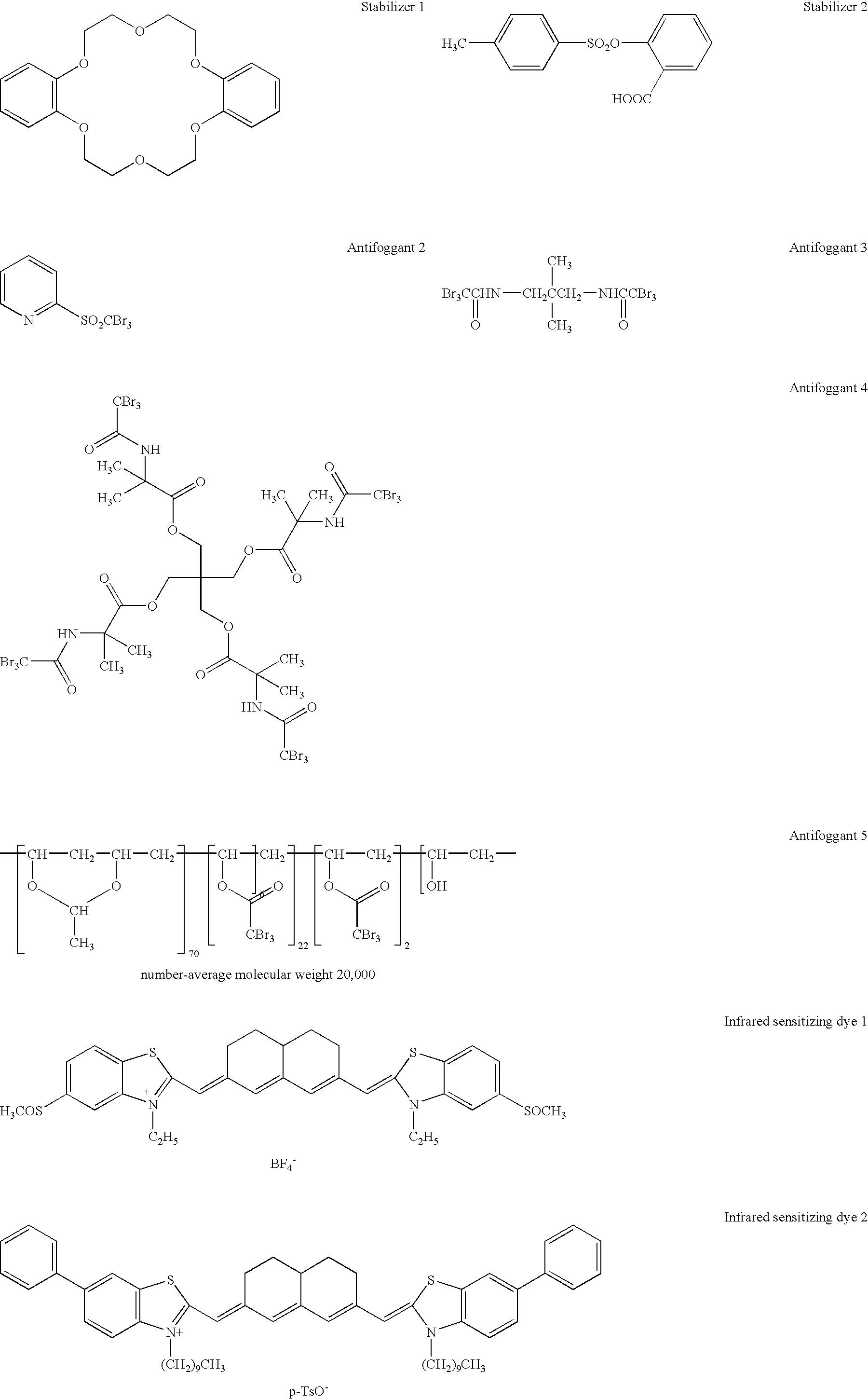

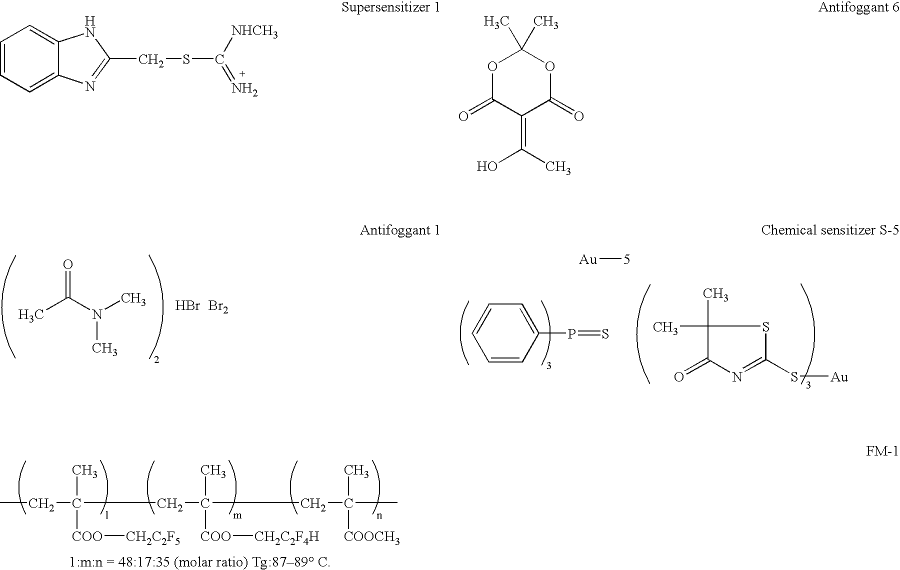

Preparation of Lower Protective Layer

| | | |
|---|---|---|
| Acetone | 5 | g |
| MEK | 21 | g |
| Cellulose acetate Propionate(CAP-141-20, | 2.3 | g |
| Tg of 190° C., Eastman Chemical Co.) | | |
| Methanol | 7 | g |
| Phthalazine | 0.25 | g |
| CH₂═CHSO₂CH₂CH₂OCH₂CH₂SO₂CH═CH₂ | 0.035 | g |
| C₁₂F₂₅(CH₂CH₂O)₁₀C₁₂F₂₅ | 0.01 | g |
| Fluorinated surfactant (SF-17) | 0.01 | g |
| Stearic acid | 0.1 | g |
| Butyl stearate | 0.1 | g |
| α-alumina (Mohs hardness 9) | 0.1 | g |

Preparation of Upper Protective Layer

| | | |
|---|---|---|
| Acetone | 5 | g |
| MEK | 21 | g |
| Cellulose acetate Propionate(CAP-141-20, | 2.3 | g |
| Tg of 190° C., Eastman Chemical Co.) | | |
| Paraloid (Rohm & Haas Co.) | 0.08 | g |
| Benzotriazole | 0.03 | g |
| Methanol | 7 | g |
| Phthalazine | 0.25 | g |
| Monodisperse silica (having a monodisperse | 0.140 | g |
| degree of 15% and average grain size of 10 μm | | |
| and surface-treated with aluminum at 1% of | | |
| the whole silica) | | |
| CH₂═CHSO₂CH₂CH₂OCH₂CH₂SO₂CH═CH₂ | 0.035 | g |
| C₁₂F₂₅(CH₂CH₂O)₁₀C₁₂F₂₅ | 0.01 | g |
| Fluorinated surfactant (SF-17) | 0.005 | g |
| Fluoropolymer (FM-1) | 0.01 | g |
| Stearic acid | 0.1 | g |
| Butyl stearate | 0.1 | g |
| α-alumina (Mohs hardness 9) | 0.1 | g |

Coating solutions of the lower and upper protective layers were prepared based on the foregoing composition similarly to the coating solution of the back coat layer described earlier, in which silica was dispersed in MEK at a concentration of 1 using a dissolver type homogenizer and finally added.

Preparation of Photothermographic Material

The coating solution of the back coat layer and the coating solution of the protective layer for the back coat layer were coated on the upper subbing layer B-2, using a extrusion coater at a coating speed of 50 m/min so that the respective layers had a dry thickness of 3.5 μm. Drying was conducted at a dry bulb temperature of 100° C. and a dew point of 10° C. over a period of 5 min.

The coating solution of the image forming layer and the coating solution of the protective layer (surface protective layer) for the image forming layer were coated on the upper subbing layer A-2, using a extrusion coater at a coating speed of 50 m/min to prepare photothermographic material samples 101 to 126, as shown in Table 2. Coating was conducted so that the image forming layer (or light-sensitive layer) had a dry thickness shown in Table 2, the protective layer for the image forming layer (surface protective layer) had a dry thickness of 3.0 μm (i.e., 1.5 μm of the upper surface protective layer and 1.5 μm of the lower surface protective layer). Thereafter, drying was conducted at a dry bulb temperature of 75° C. and a dew point of 10° C. over a period of 10 min.

The thus prepared photothermographic material sample (sample 119) exhibited a pH of 5.3 and a Beck smoothness of 6,000 sec. on the surface of the image forming layer side and a pH of 5.5 and a Beck smoothness of 9,000 sec. on the surface of the back coat layer side.

Surface roughness was measured for samples 101 to 126. As a result, it was proved that Rz(E)/Rz(B)=0.40 and Rz=1.4 μm. Further, Rz(B) was 3.5 μm, Ra(E) was 0.09 μm and Ra(B) was 0.12 μm.

In samples 101 to 110, 113 to 119, 121 to 123, 125 and 126, an absorption peak assigned to.a cyan dye forming leuco dye was observed at a wavelength of 620 nm. In samples 111 and 112, an absorption.peak assigned to a cyan dye forming leuco dye was observed at a wavelength of 640 nm.

Sample 113 was prepared similarly to sample 104, except that in the preparation of powdery-organic silver salt, 130.8 g of behenic acid, 67.7 g of arachidic acid and 43.6 g of stearic acid were replaced by 259.9 g of behenic acid.

Sample 114 was prepared similarly to sample 104, except that in the preparation of powdery organic silver salt A, 540.2 ml of 1.5 mol/L aqueous sodium hydroxide was replaced by 540.2 ml of 1.5 mol/L aqueous potassium hydroxide.

Sample 115 was prepared similarly to sample 104, except that the fluorinated surfactant (SF-17) used in the protective layers for the back coat layer and the image forming layer was replaced by C₈F₁₇SO₃Li.

Sample 116 was prepared similarly to sample 104, except that, as a binder of the image forming layer in the preparation of preliminary dispersion, poly(vinyl butyral) resin exhibiting a Tg of 75° C. and containing a SO₃K group at 0.2 mmol/g was replaced by poly(vinyl butyral) resin exhibiting a Tg of 65° C. and containing a SO₃K group at 0.2 mmol/g.

Exposure and Processing

The thus prepared samples 1 to 20 were each cut to a size of 34.5 cm×43.0 cm, packed with packaging material in an atmosphere 25° C. and 50% R.H. and allowed to stand at ordinary temperature for 2 weeks. Thereafter, the samples were evaluated as follows.

Packaging Material

There were used a paper tray and a barrier bag comprising 10 μm polyethylene/12μm PE/9 μm aluminum foil/15 μm nylon/50 μm polyethylene containing 3% carbon and exhibiting an oxygen permeability of 0.02 ml/atm·m²·25° C.·day and a moisture permeability of 0.001 g/m²·40° C.·90% RH·day.

Evaluation of Sample

Samples were each exposed using a laser imager shown in FIG. 1(a) (setting area of 0.35 m²) and thermal-developed concurrently with exposure and obtained images werkesubjected to densitometry. Herein, the expression, being thermal-developed concurrently with exposure means that, in a sheet of a photothermographic material (1), while one portion of the sheet is exposed, another portion after having being exposed, is developed at the same time. In other words, exposure and thermal development are concurrently performed within a sheet of the photographic material. The distance between exposure section (6) and the developing section (3) was 12 cm, in which the transport speed of from the photothermographic material-supplying section to the exposure section (6), that at the exposure section (6) and that at the thermal developing section (3) were each 30 mm/sec. The position of a stock tray for photothermographic material from the bottom was 45 cm in height from the floor surface. The photothermographic material was set in film storage section (4) of a laser image shown in FIG. 1 and conveyed via film guide (10) in which transport roller (2) are to be set up to the exit (7) but a part of them is illustrated. Scanning exposure was applied onto the emulsion side surface of each sample, employing an exposure apparatus in which a semiconductor laser, which was subjected to a longitudinal multi-mode at a wavelength of 810 nm, employing high frequency superposition, was employed as a laser beam source. Exposure was carried out while adjusting the angle between the exposed surface of the sample and the exposure laser beam to 75 degrees. Such exposure resulted in forming images exhibiting minimized unevenness and surprisingly superior sharpness, compared to the case in which the angle was adjusted to 90 degrees.

Thereafter, the light-insensitive layer of each sample was brought into contact with the surface of development section 3 and thermal development was carried out at 123° C. for 10 sec. (the interval time of thermal development was 4 sec in continuous processing). The light-insensitive layer side of the thus thermal processed photothermographic material was cooled at cooling section 5, which may be a roller form, as shown in FIG. 1(a) or a plate form, as shown in FIG. 1(b). The laser image was operated in a room conditioned at 23° C. and 50% RH. Exposure was stepwise performed with decreasing exposure energy by 0.05 in logE from the maximum output.

Measurement of Cooling Rate

Measurement of a cooling rate was conducted in such a manner that ten thermocouples were uniformly attached to each of the light-sensitive layer side and the light-insensitive layer side of the photothermographic material and processing of from thermal development to discharging via cooling was performed and the temperature history of each reaching 45° C. was measured for the respective layer sides. Thus, the cooling time of from the development temperature (123° C.) to until reaching 45° C. was measured and the cooling rate was represented by a relative value of the reciprocal of the cooling time.

### Example 2

Preparation of Subbed Photographic Support

A subbed photographic support was prepared similarly to Example 1.

Preparation of Coating Solution of Back Coat Layer

Into 830 g of methyl ethyl ketone (also denoted simply as MEK), 84.2 g of cellulose acetate propionate (CAP482-20, available form Eastman Chemical Co.) and 4.5 g of polyester. resin (Vitel PE2200B, available from Bostic Co.) were added and dissolved with stirring. Subsequently, to this solution, 4.5 .g of a fluorinated surfactant (Surflon KH40, available from Asahi Glass Co., Ltd.) and 2.3 g of a fluorinated surfactant Megafac F120K,. available from Dainippon Ink Co., Ltd.) which were dissolved in 43.2 g of methanol, were added and sufficiently stirred until dissolved. Then, 2.5 g of oleyl oleate was added and finally 75 g of silica (having an average particle size of 10 μm) which was dispersed in MEK at a concentration 1% by a dissolver type homogenizer to prepare a coating solution of the back coat layer.

Preparation of Coating Solution of Back Coat Protective Layer

Similarly to the foregoing coating solution of the back coat layer, a coating solution of the protective layer for the back coat layer was prepared. according to the following composition, in which silica was dispersed using a dissolver type homogenizer and finally added.

| | | |
|---|---|---|
| Cellulose acetate propionate (10% MEK solution | 15 | g |
| CAP482-20, Eastman Chemical Co. | | |
| Monodisperse silica (having a monodisperse | 0.03 | g |
| degree of 15% and average grain size of 10 μm | | |
| and surface-treated with aluminum at 1% of | | |
| the whole silica) | | |
| C₈F₁₇(CH₂CH₂O)₁₂C₈F₁₇ | 0.05 | g |
| Fluorinated surfactant (SF-17) | 0.01 | g |
| Fluoropolymer (FM-1) | 0.05 | g |
| Stearic acid | 0.1 | g |
| Butyl stearate | 0.1 | g |
| α-alumina (Mohs hardness 9) | 0.1 | g |

Preparation of Silver Halide Emulsion A1

Light-sensitive silver halide emulsion A1 was prepared similarly to the silver halide emulsion A1 of Example 1.

Preparation of Silver Halide Emulsion B1

Light-sensitive silver halide-emulsion B1 was prepared similarly to the silver halide emulsion B2 of Example 1.

Preparation of Silver Halide Emulsion C

Light-sensitive silver halide emulsion C was prepared similarly to the foregoing silver halide emulsion A1, except that potassium bromide used in the preparation of the silver halide A1 was replaced by potassium iodide. The prepared emulsion was comprised of monodisperse cubic silver iodide grains having an average grain size of 25 nm, a grain size variation coefficient of 12 percent and a (100) crystal face ratio of 92 percent.

Preparation of Silver Halide Emulsion D

Light-sensitive silver halide emulsion D was prepared similarly to the foregoing silver halide emulsion A1, except that a part of potassium bromide used in the preparation of the silver halide A1 was replaced by potassium iodide so as to have. an iodide content of 90 mol %. The prepared emulsion was comprised of monodisperse cubic silver iodobromide grains having an average grain size of 25 nm, a grain size variation coefficient of 12 percent and a (100) crystal face ratio of 92 percent.

Preparation of Silver Halide Emulsion E

Light-sensitive silver halide emulsion E was prepared similarly to the foregoing silver halide emulsion C, except that the double jet addition was conducted at 45° C. The prepared emulsion was comprised of monodisperse cubic silver iodobromide grains having an average grain size of 55 nm, a grain size variation coefficient of 12 percent and a (100) crystal face ratio of 92 percent.

Preparation of Silver Halide Emulsion F

Light-sensitive silver halide emulsion F was prepared similarly to the foregoing silver halide emulsion D, except that the double jet addition was conducted at 45° C. The prepared emulsion was comprised of monodisperse cubic silver iodobromide grains having an average grain size of 55 nm, a grain size variation coefficient of 12 percent and a (100) crystal face ratio of 92 percent. The iodide content was 90 mol %.

Preparation of Silver Halide Emulsion G

Similarly to the silver halide emulsion C, light-sensitive silver halide-emulsion G was prepared, except that after nucleation, the whole amount of solution F1 was added and then, 4 ml of a 0.1% ethanol solution of the following compound (TPPS) was added thereto. The prepared emulsion was comprised of monodisperse cubic silver iodide grains having an average grain size of 25 nm, a grain size variation coefficient of 12 percent and a (100) crystal face ratio of 92 percent.

Preparation of Silver Halide Emulsion H

Similarly to the silver halide emulsion E, light-sensitive silver halide emulsion H was prepared, except that after nucleation, the whole amount of solution F1 was added and then, 4 ml of a 0.l % ethanol solution of the following compound (TPPS) was added thereto. The prepared emulsion was comprised of monodisperse cubic silver iodide grains having an average grain size of 55 nm, a grain size variation coefficient of 12 percent and a (100) crystal face ratio of 92 percent.

Preparation of Powdery Organic Silver Salt A

In 4,720 ml of pure water were dissolved 130.8 g of behenic acid, 67.7 g of arachidic acid, 43.6 g of stearic acid, and 2.3 g of palmitic acid at 80° C. Subsequently, 540.2 ml of a 1.5 mol/L aqueous sodium hydroxide solution was added, and further, 6.9 ml of concentrated nitric acid was added. Thereafter, the resultant mixture was cooled to 55° C., whereby an aliphatic acid sodium salt solution was prepared. While maintaining the aliphatic acid sodium salt solution at 55° C., the light-sensitive silver halide emulsion (in an amount shown in Table 3) and 450 ml of pure water were added and stirred for 5 min.

Subsequently, 468.4 ml of 1 mol/L silver nitrate solution was added over 2 min. and stirred for 10 min., whereby an organic silver salt dispersion was prepared. Thereafter, the organic silver salt dispersion was transferred to a water washing machine, and deionized water was added. After stirring, the resultant dispersion was allowed to stand, whereby a flocculated organic silver salt was allowed to float and was separated, and the lower portion, containing water-soluble salts, were removed. Thereafter, washing was repeated employing deionized water until electric conductivity of the resultant effluent reached 2 μS/cm. After centrifugal dehydration, the resultant cake-shaped aliphatic carboxylic acid silver salt was dried employing an gas flow type dryer Flush Jet Dryer (manufactured by Seishin Kigyo Co., Ltd.), while setting the drying conditions such as nitrogen gas as well as heating flow temperature at the inlet of the dryer (65° C. at the inlet and 40° C. at the outlet), until its moisture content reached 0.1 percent, whereby powdery organic silver salt was prepared.

Preparation of Preliminary Dispersion A

Preliminary dispersion A was prepared similarly to the preliminary dispersion A of Example 1.

Preparation of Light-sensitive Dispersion A

Preliminary dispersion A, prepared as above, was charged into a media type homogenizer DISPERMAT Type SL-C12EX (manufactured by VMA-Getzmann Co.), filled with 0.5 mm diameter zirconia beads (Toreselam, produced by Toray Co.) so as to occupy 80 percent of the-interior volume so that the retention time in the mill reached 1.5 minutes and was dispersed at a peripheral rate of the mill of 8 m/second, whereby light-sensitive emulsion dispersed solution was prepared.

Preparation of Stabilizer Solution

Stabilizer solution was prepared by dissolving 1.0 g of stabilizer 1 and 0.31 g of potassium acetate in 4.97 g of methanol.

Preparation of 2-Chlorobenzoic Acid Solution

In 31.3 ml of MEK, 1.488 g of 2-chlorobenzoic acid, 2.779 g of stabilizer 2 and 365 mg of 5-methyl-2-mercaptobenzimidazole were dissolved in a dark room to prepare a 2-chlorobenzoic acid solution.

Preparation of Additive Solution a

Additive solution a was prepared by dissolving, in 110 g of MEK,. a reducing agent (as shown in Table 3), 0.159 g of yellow color forming leuco dye (as shown in Table 3), 0.159 g of cyan color forming leuco dye (as shown in Table 3) and 1.54 g of 4-methylphthalic acid.

Preparation of Additive Solution b

Additive Solution b was prepared by dissolving 1.56 g of Antifoggant 2, 0.5 g of antifoggant 3, 0.5 g of antifoggant 4, 0.5 g of antifoggant 5 and 3.43 g of phthalazine in 40.9 g of MEK.

Preparation of Additive Solution c

Additive Solution c was prepared by dissolving 0.2 g of silver saving agent (SE2-2) in 39.8 g of MEK.

Preparation of Additive Solution d

Additive Solution d was prepared by dissolving 0.5 g of potassium p-toluenesulfonate and 0.5 g of antifoggant 6 in 9.0 g of MEK.

Preparation of Additive Solution e

Additive solution e was prepared by dissolving 1.0 g of vinylsulfone [(CH₂═CH—SO₂CH₂)₂CHOH) in 9.0 g of MEK.

Preparation of Light-sensitive Layer Coating Composition

While stirring, 50 g of the foregoing light-sensitive dispersion A and 15.11 g of MEK were mixed and the resultant mixture was maintained at 21° C., then, 1000 μl of chemical sensitizer S-5 (0.5% methanol solution) and after 2 min., 390 μm of antifoggant 1 (10% methanol solution) was added thereto and stirred for 1 hr. Further, 494 μl of calcium bromide (10% methanol-solution) was added and after stirred for 10 minutes, gold sensitizer Au-5 corresponding to 1/20 mol of the foregoing chemical sensitizer was added. Subsequently, 167 μl of the foregoing stabilizer solution was added and stirred for 10 minutes. Thereafter, 1.32 g of the foregoing 2-chlorobenzoic acid solution was added and the resulting mixture was stirred for one hour. Subsequently, the resulting mixture was cooled to 13° C. and stirred for 30 min. While maintaining at 13° C., 0.5 g of additive solution d, 0.5 g of additive solution e and 13.31 g of the binder used in the preliminary dispersion were added and stirred for 30 min. Thereafter, 1.084 g of tetrachlorophthalic acid (9.4% MEK solution) was added and stirred for 15 minutes. Further, while stirring, 12.43 g of additive solution a, 1.6 ml of Desmodur N3300 (aliphatic isocyanate, manufactured by Mobay Chemical Co. 10% MEK solution), 4.27 g of additive solution b and 1.0 g of additive solution c were successively added, whereby light-sensitive layer coating composition was prepared.

Preparation of Lower Protective.Layer

To 500 g of acetone, 2100 g of MEK and 700 g of methanol, 230 g of cellulose acetate butyrate (CAB-171-15S, available from Eastman Chemical Co.) was added and dissolved with stirring by a dissolver. Subsequently, 25 g of phthalazine, 3.5 g of CH₂═CHSO₂CH₂CH₂OCH₂CH₂SO₂CH═CH₂, 1 g of C₁₂F₂₅(CH₂CH₂O)₁₀C₁₂F₂₅, 0.5 g of compound (SF-17) of the afore-mentioned formula (SF), 10 g of stearic acid and 10 g of butyl stearate were added and dissolved with stirring to prepare a coating solution of a lower protective layer (lower surface protective layer) for the foregoing image forming layer.

Preparation of Upper Protective Layer

To 500 g of acetone, 2100 g of MEK and 700 g of methanol, 230 g of cellulose acetate butyrate (CAB-171-15S, available from Eastman Chemical Co.) was added and dissolved with stirring by a dissolver. Subsequently, 25 g of phthalazine, 3.5 g of CH₂═CHSO₂CH₂CH₂OCH₂CH₂SO₂CH═CH₂, 1 g of C₁₂F₂₅(CH₂CH₂O)₁₀C₁₂F₂₅, 1 g of compound (SF-17) of the afore-mentioned formula (SF), 1.0 g of a fluoropdlymer (FM-1), 10 g of stearic acid and 10 g of butyl stearate were added and dissolved with stirring. Finally, 280 g of monodisperse silica (having a monodisperse degree of 15% and average grain size of 10 μm and surface-treated with aluminum at 1% of the whole silica) was dispersed in MEK at a concentration of 1% using a dissolver type homogenizer and added.

Preparation of Photothermographic Material

The coating solution of the back coat layer and the coating solution of the protective layer for the back coat layer were coated on the upper subbing layer B-2, using a extrusion coater at a coating speed of 50 m/min so that the respective layers had a dry thickness of 3.5 μm. Drying was conducted at a dry bulb temperature of 100° C. and a dew point of 10° C. over a period of 5 min.

The coating solution of the image forming layer and the coating solution of the protective layer (surface protective layer) for the image forming layer were coated on the upper subbing layer A-2, using a extrusion coater at a coating speed of 50 m/min to prepare photothermographic material samples 201 to 227, as shown in Table 3. Coating was conducted so that the image forming layer (or light-sensitive layer) had a dry thickness shown in Table 3, the protective layer for the image forming layer (surface protective layer) had a dry thickness of 3.0 μm (i.e., 1.5 μm of the upper surface protective layer and 1.5 μm of the lower surface protective layer). Thereafter, drying was conducted at a dry bulb temperature of 75° C. and a dew point of 10° C. over a period of 10 min.

Surface roughness was measured for samples 201 to 227. As a result, it was proved that Rz(E)/Rz(B)=0.40 and Rz=1.4 μm. Further, Rz(B) was 3.5 μm, Ra(E) was 0.09 μm and Ra(B) was 0.12 μm.

In samples 201 to 227 (except for samples 221 and 225) was noted an absorption peal at a wavelength of 420 nm, assigned to the yellow color forming leuco dye. In samples 201 to 211, 214 to 220, 222 to 224, 226 and 227 was noted an absorption peal at a wavelength of 620 nm, assigned to the cyan color forming leuco dye. In samples 212 and 213 was noted an absorption peal at a wavelength of 640 nm, assigned to the cyan color forming leuco dye.

Sample 214 was prepared similarly to sample 205, except that in the preparation of powdery organic silver salt, 130.8 g of behenic acid, 67.7 g of arachidic acid and 43.6 g of stearic acid were replaced by 259.9 g of behenic acid.

Sample 213 was prepared similarly to sample 205, except that in the preparation of powdery organic silver salt, 540.2 ml of 1.5 mol/L aqueous sodium hydroxide was replaced by 540.2 ml of 1.5 mol/L aqueous potassium hydroxide.

Sample 215 was prepared similarly to sample 205, except that the fluorinated surfactant (SF-17) used in the protective layers for the back coat layer and the image forming layer was replaced by C₈F₁₇SO₃Li.

Sample 216 was prepared similarly to sample 205, except that, as a binder of the image forming layer in the preparation of preliminary dispersion, poly(vinyl butyral) resin exhibiting a Tg of 75° C. and containing a SO₃K group at 0.2 mmol/g was replaced by poly(vinyl butyral) resin exhibiting a Tg of 65° C. and containing a SO₃K group at 0.2 mmol/g.

0513-0514Evaluation of Sample

Similarly to Examples 1, samples were each exposed using a laser imager and thermal-developed concurrently with exposure and obtained images were subjected to densitometry, except for employment of an exposure apparatus in which a semiconductor laser (NLHV3000E, Nichia Kagaku Kogyo Co., Ltd.), which was subjected to a longitudinal multi-mode at a wavelength of 405 nm was employed as a laser beam source.

Measurement of Cooling Rate

Measurement of a cooling rate was conducted in such a manner that ten thermocouples were uniformly attached to each of the light-sensitive layer side and the light-insensitive layer side of the photothermographic material and processing of from thermal development to discharging via cooling was performed and the temperature history of each reaching 45° C. was measured for the respective layer sides.

Packaging Material

There were used a barrier bag comprising 10 μm polyethylene/12μm PE/9 μm aluminum foil/15 μm nylon/50 μm polyethylene containing 3% carbon and exhibiting an oxygen permeability of 0.02 ml/atm·m²·25° C.·day and a.moisture permeability of 0.001 g/m²·40° C.·9% RH·day, and paper tray.

The thus thermally developed images were each evaluated with respect to the following performance.

Image Density

The density of a maximum density area of the image obtained above was represented using a densitometer and designated as an image density.

Fogging

The density of an unexposed area was determined using a densitometer and represented as a fog density.

Sensitivity

The respective images obtained above were each subjected to densitometry using a densitometer to prepare a characteristic curve comprising an abscissa of exposure and an ordinate of density. Sensitivity was represented by a relative value of the reciprocal of exposure necessary to give a density higher than the unexposed area by 1.0 (i.e., a density of 1.0 plus a fog density), based on the sensitivity of sample 1 being 100.

Comparing a sensitivity (denoted as S′) obtained when a photothermographic material is subjected to a heat treatment (123° C., 10 sec.) under the same condition as the thermal development, then, exposed to white light (4874K, 30 sec.) and thermally developed at 123° C. for 10 sec. with a sensitivity (denoted as S) obtained when, without being subjected to the thermal treatment, exposed to the white light and thermally developed under the same condition as above, values within parentheses in the column of the sensitivity indicate the sensitivity of the former (S′), which is represented by a relative value, based on the sensitivity of the latter (S) being 100.

In the comparison, reduction of the relative sensitivity of the sample which was subjected to the thermal treatment prior to being exposed to white light was confirmed to be mainly due to fact that disappearance or reduction of spectral sensitization effects resulted in variation of the relative relation between surface sensitivity of a silver halide grain and internal sensitivity of the grain, from observation/determination of change in spectral sensitivity and the like.

Silver Image Tone

Onto the respective photothermographic material samples, a chest radiographic image was printed and thermally developed with adjusting the processing time so as to give a maximum density of 4.0 or more. The thus processed samples were visually evaluated using a viewing lantern with respect to silver image color in the high density area (having a density of 2.5). Thus, using wet-processed film for use in a laser imager (produced by Konica Corp.) as a reference sample, the samples.were visually evaluated with respect to silver image color relative to the reference sample, based on the following criteria at intervals of 0.5:

5: identical image color to the reference sample,

4: preferable and substantially identical image color to the reference sample,

3: slightly different image color from the reference sample but acceptable in practice,

2: apparently different image color from the reference sample,

1: unpleasant and different image color from the reference sample.

Density Uniformity

The processed samples were visually observed evaluated with respect to unevenness in density and evaluated, based on the following criteria:

5: no unevenness in density was observed,

4: unevenness in density was slightly observed,

3: weak unevenness in density was partially observed,

2: strong unevenness in density was partially observed,

1: strong unevenness in density was overall observed.

Image Lightfastness

After exposed and developed as above, the respective samples were adhered onto a viewing lantern exhibiting a luminance of 1,000 lux or more and allowed to stand for 10 days. Thereafter, the samples were visually evaluated with. respect to change of the image, based on the following criteria at intervals of 0.5:

5: nearly no change was observed,

4: slight change in color was observed,

3: change in color and increased fogging were partially observed,

2: change in color and increased fogging were observed in many portions,

1: change in color and increased fogging were markedly observed and overall unevenness in density occurred.

The results are shown in Tables 2 and 3.

TABLE 2

| Sample | | | | | | | | | | Image | | | Light- | Image | Density | |
|---|---|---|---|---|---|---|---|---|---|---|---|---|---|---|---|---|
| No. | *1 | *2 | *3 | *4 | *5 | *6 | *7 | *8 | *9 | Density | S | Fog | fastness | Tone | uniformity | Remark |
| 101 | A2/B2 = | (1-1) = | (2-6) = | YA-1 | CLA-12 | 1.0 | 3.0 | 15.0 | 18.0 | 4.2 | 102(4) | 0.18 | 4.5 | 5.0 | 5.0 | Inv. |
| | 36.2/9.1 | 4.20 | 23.78 | | | | | | | | | | | | | |
| 102 | A3/B2 = | (1-1) = | (2-6) = | YA-1 | CLA-12 | 1.0 | 3.0 | 15.0 | 18.0 | 4.2 | 102(4) | 0.18 | 4.5 | 5.0 | 5.0 | Inv. |
| | 36.2/9.1 | 4.20 | 23.78 | | | | | | | | | | | | | |
| 103 | A3/B2 = | (1-7) = | (2-6) = | YA-1 | CLA-12 | 1.0 | 3.0 | 15.0 | 18.0 | 4.2 | 103(4) | 0.18 | 4.5 | 5.0 | 5.0 | Inv. |
| | 36.2/9.1 | 4.20 | 23.78 | | | | | | | | | | | | | |
| 104 | A3/B2 = | (1-10) = | (2-6) = | YA-1 | CLA-12 | 1.0 | 3.0 | 15.0 | 18.0 | 4.6 | 103(4) | 0.18 | 4.5 | 5.0 | 5.0 | Inv. |
| | 36.2/9.1 | 4.20 | 23.78 | | | | | | | | | | | | | |
| 105 | A3/B2 = | (1-10) = | (2-2) = | YA-1 | CLA-12 | 1.0 | 3.0 | 15.0 | 18.0 | 4.6 | 102(4) | 0.18 | 5.0 | 5.0 | 5.0 | Inv. |
| | 36.2/9.1 | 4.20 | 23.78 | | | | | | | | | | | | | |
| 106 | A3/B2 = | (1-10) = | (2-6) = | YA-1 | CLA-12 | 1.0 | 3.0 | 14.0 | 17.0 | 4.5 | 102(4) | 0.18 | 4.5 | 5.0 | 5.0 | Inv. |
| | 36.2/9.1 | 4.20 | 23.78 | | | | | | | | | | | | | |
| 107 | A3/B2 = | (1-10) = | (2-6) = | YA-1 | CLA-12 | 1.0 | 3.0 | 16.0 | 19.0 | 4.8 | 102(4) | 0.18 | 4.0 | 4.5 | 5.0 | Inv. |
| | 36.2/9.1 | 4.20 | 23.78 | | | | | | | | | | | | | |
| 108 | A3/B2 = | (1-10) = | (2-6) = | YA-1 | CLA-12 | 1.0 | 3.0 | 17.0 | 20.0 | 5.0 | 102(4) | 0.18 | 4.0 | 4.5 | 5.0 | Inv. |
| | 36.2/9.1 | 4.20 | 23.78 | | | | | | | | | | | | | |
| 109 | A3/B2 = | (1-10) = | (2-6) = | YA-1 | CLA-8 | 1.0 | 3.0 | 15.0 | 18.0 | 4.2 | 102(4) | 0.18 | 4.5 | 5.0 | 5.0 | Inv. |
| | 36.2/9.1 | 4.20 | 23.78 | | | | | | | | | | | | | |
| 110 | A3/B2 = | (1-10) = | (2-6) = | YA-2 | CLA-8 | 1.0 | 3.0 | 15.0 | 18.0 | 4.2 | 102(4) | 0.18 | 4.5 | 5.0 | 5.0 | Inv. |
| | 36.2/9.1 | 4.20 | 23.78 | | | | | | | | | | | | | |
| 111 | A3/B2 = | (1-10) = | (2-6) = | YA-1 | CLB-1 | 1.0 | 3.0 | 15.0 | 18.0 | 4.4 | 103(4) | 0.16 | 5.0 | 5.0 | 5.0 | Inv. |
| | 36.2/9.1 | 4.20 | 23.78 | | | | | | | | | | | | | |
| 112 | A3/B2 = | (1-10) = | (2-6) = | YA-1 | CLB-13 | 1.0 | 3.0 | 15.0 | 18.0 | 4.4 | 103(4) | 0.16 | 5.0 | 5.0 | 5.0 | Inv. |
| | 36.2/9.1 | 4.20 | 23.78 | | | | | | | | | | | | | |
| 113 | A3/B2 = | (1-10) = | (2-6) = | YA-1 | CLA-12 | 1.0 | 3.0 | 15.0 | 18.0 | 4.4 | 101(4) | 0.17 | 5.0 | 5.0 | 4.0 | Inv. |
| | 36.2/9.1 | 4.20 | 23.78 | | | | | | | | | | | | | |
| 114 | A3/B2 = | (1-10) = | (2-6) = | YA-1 | CLA-12 | 1.0 | 3.0 | 15.0 | 18.0 | 4.8 | 102(4) | 0.18 | 4.5 | 5.0 | 5.0 | Inv. |
| | 36.2/9.1 | 4.20 | 23.78 | | | | | | | | | | | | | |
| 115 | A3/B2 = | (1-10) = | (2-0) = | YA-1 | CLA-12 | 1.0 | 3.0 | 15.0 | 18.0 | 4.4 | 101(4) | 0.19 | 4.5 | 5.0 | 4.0 | Inv. |
| | 36.2/9.1 | 4.20 | 23.78 | | | | | | | | | | | | | |
| 116 | A3/B2 = | (1-10) = | (2-6) = | YA-1 | CLA-12 | 1.0 | 3.0 | 15.0 | 18.0 | 4.7 | 102(4) | 0.20 | 4.0 | 4.5 | 5.0 | Inv. |
| | 36.2/9.1 | 4.20 | 23.78 | | | | | | | | | | | | | |
| 117 | A3/B2 = | (1-10) = | (2-6) = | YA-1 | CLA-12 | 1.0 | 2.0 | 15.0 | 18.0 | 4.5 | 102(5) | 0.19 | 4.5 | 5.0 | 4.5 | Inv. |
| | 36.2/9.1 | 4.20 | 23.78 | | | | | | | | | | | | | |
| 118 | A3/B2 = | (1-10) = | (2-0) = | YA-1 | CLA-12 | 1.5 | 1.5 | 15.0 | 18.0 | 4.4 | 102(6) | 0.20 | 4.0 | 4.5 | 4.0 | Inv. |
| | 36.2/9.1 | 4.20 | 23.78 | | | | | | | | | | | | | |
| 119 | A1/B1 = | (1-1) = | (2-6) = | YA-1 | CLA-12 | 1.0 | 3.0 | 15.0 | 18.0 | 3.9 | 100(22) | 0.18 | 3.5 | 4.0 | 4.0 | Inv. |
| | 36.2/9.1 | 4.20 | 23.78 | | | | | | | | | | | | | |
| 120 | A1/B1 = | (1-1) = | (2-0) = | — | — | 1.0 | 0.5 | 15.0 | 18.0 | 3.3 | 99(27) | 0.24 | 2.5 | 1.0 | 2.0 | Comp. |
| | 36.2/9.1 | 4.20 | 23.78 | | | | | | | | | | | | | |
| 121 | A1/B1 = | (1-1) = | (2-0) = | YA-1 | CLA-12 | 1.0 | 0.5 | 18.0 | 21.0 | 4.8 | 100(26) | 0.29 | 2.0 | 2.0 | 3.0 | Comp. |
| | 36.2/9.1 | 4.20 | 23.78 | | | | | | | | | | | | | |
| 122 | A1/B1 = | (1-1) = | (2-0) = | YA-1 | CLA-12 | 1.0 | 0.5 | 6.0 | 9.0 | 2.8 | 96(26) | 0.26 | 2.5 | 1.5 | 2.0 | Comp. |
| | 36.2/9.1 | 4.20 | 23.78 | | | | | | | | | | | | | |
| 123 | A1/B1 = | (1-1) = | (2-0) = | YA-1 | CLA-12 | 3.0 | 0.5 | 15.0 | 18.0 | 3.8 | 99(25) | 0.22 | 2.5 | 3.0 | 3.0 | Comp. |
| | 36.2/9.1 | 4.20 | 23.78 | | | | | | | | | | | | | |
| 124 | A1/B1 = | (1-1) = | (2-6) = | — | — | 3.0 | 0.5 | 15.0 | 18.0 | 3.2 | 98(25) | 0.22 | 2.5 | 2.0 | 2.5 | Comp. |
| | 36.2/9.1 | 4.20 | 23.78 | | | | | | | | | | | | | |
| 125 | A1/B1 = | (1-1) = | (2-0) = | YA-1 | CLA-12 | 3.0 | 0.5 | 18.0 | 21.0 | 4.6 | 99(25) | 0.24 | 2.5 | 2.5 | 3.0 | Comp. |
| | 36.2/9.1 | 4.20 | 23.78 | | | | | | | | | | | | | |
| 126 | A1/B1 = | (1-1) = | (2-0) = | YA-1 | CLA-12 | 3.0 | 0.5 | 6.0 | 9.0 | 2.7 | 96(25) | 0.23 | 3.0 | 2.0 | 2.0 | Comp. |
| | 36.2/9.1 | 4.20 | 23.78 | | | | | | | | | | | | | |

*1: Silver halide emulsion (amount, g),
*2: Reducing agent of formula (RD1) (amount, g)
*3: Reducing agent of formula (RD2) (amount, g),
*4: Yellow dye forming leuco dye,
*5: Cyan dye forming leuco dye,
*6: Length ratio of cooling unit to developing unit
*7: Cooling rate ratio of light-insensitive side to light-sensitive side,
*8: Light-sensitive layer thickness (μm)
*9: Total thickness (μm) of light-sensitive and light-insensitive layers

TABLE 3

| Sample | | | | | | | | | | Image | | | Light- | Image | Density | |
|---|---|---|---|---|---|---|---|---|---|---|---|---|---|---|---|---|
| No. | *1 | *2 | *3 | *4 | *5 | *6 | *7 | *8 | *9 | Density | S | Fog | fastness | Tone | uniformity | Remark |
| 201 | C/E = | (1-1) = | (2-6) = | YA-1 | CLA-12 | 1.0 | 3.0 | 15.0 | 18.0 | 4.2 | 100(14) | 0.17 | 4.0 | 4.5 | 4.5 | Inv. |
| | 36.2/9.1 | 4.20 | 23.78 | | | | | | | | | | | | | |
| 202 | D/F = | (1-1) = | (2-6) = | YA-1 | CLA-12 | 1.0 | 3.0 | 15.0 | 18.0 | 4.2 | 100(14) | 0.17 | 4.0 | 4.5 | 4.5 | Inv. |
| | 36.2/9.1 | 4.20 | 23.78 | | | | | | | | | | | | | |
| 203 | G/H = | (1-1) = | (2-6) = | YA-1 | CLA-12 | 1.0 | 3.0 | 15.0 | 18.0 | 4.2 | 102(4) | 0.17 | 4.5 | 5.0 | 5.0 | Inv. |
| | 36.2/9.1 | 4.20 | 23.78 | | | | | | | | | | | | | |
| 204 | G/H = | (1-7) = | (2-6) = | YA-1 | CLA-12 | 1.0 | 3.0 | 15.0 | 18.0 | 4.2 | 102(4) | 0.17 | 4.5 | 5.0 | 5.0 | Inv. |
| | 36.2/9.1 | 4.20 | 23.78 | | | | | | | | | | | | | |
| 205 | G/H = | (1-10) = | (2-6) = | YA-1 | CLA-12 | 1.0 | 3.0 | 15.0 | 18.0 | 4.5 | 103(4) | 0.17 | 4.5 | 5.0 | 5.0 | Inv. |
| | 36.2/9.1 | 4.20 | 23.78 | | | | | | | | | | | | | |
| 206 | G/H = | (1-10) = | (2-2) = | YA-1 | CLA-12 | 1.0 | 3.0 | 15.0 | 18.0 | 4.5 | 102(4) | 0.17 | 5.0 | 5.0 | 5.0 | Inv. |
| | 36.2/9.1 | 4.20 | 23.78 | | | | | | | | | | | | | |
| 207 | G/H = | (1-10) = | (2-6) = | YA-1 | CLA-12 | 1.0 | 3.0 | 14.0 | 17.0 | 4.5 | 102(4) | 0.17 | 4.5 | 5.0 | 5.0 | Inv. |
| | 36.2/9.1 | 4.20 | 23.78 | | | | | | | | | | | | | |
| 208 | G/H = | (1-10) = | (2-6) = | YA-1 | CLA-12 | 1.0 | 3.0 | 16.0 | 19.0 | 4.7 | 102(4) | 0.17 | 4.5 | 4.5 | 5.0 | Inv. |
| | 36.2/9.1 | 4.20 | 23.78 | | | | | | | | | | | | | |
| 209 | G/H = | (1-10) = | (2-6) = | YA-1 | CLA-12 | 1.0 | 3.0 | 17.0 | 20.0 | 4.9 | 102(4) | 0.17 | 4.5 | 4.5 | 5.0 | Inv. |
| | 36.2/9.1 | 4.20 | 23.78 | | | | | | | | | | | | | |
| 210 | G/H = | (1-10) = | (2-6) = | YA-1 | CLA-8 | 1.0 | 3.0 | 15.0 | 18.0 | 4.5 | 103(4) | 0.17 | 4.5 | 5.0 | 5.0 | Inv. |
| | 36.2/9.1 | 4.20 | 23.78 | | | | | | | | | | | | | |
| 211 | G/H = | (1-10) = | (2-6) = | YA-2 | CLA-8 | 1.0 | 3.0 | 15.0 | 18.0 | 4.5 | 103(4) | 0.17 | 4.5 | 5.0 | 5.0 | Inv. |
| | 36.2/9.1 | 4.20 | 23.78 | | | | | | | | | | | | | |
| 212 | G/H = | (1-10) = | (2-6) = | YA-1 | CLB-1 | 1.0 | 3.0 | 15.0 | 18.0 | 4.7 | 103(4) | 0.15 | 5.0 | 5.0 | 5.0 | Inv. |
| | 36.2/9.1 | 4.20 | 23.78 | | | | | | | | | | | | | |
| 213 | G/H = | (1-10) = | (2-6) = | YA-1 | CLB-13 | 1.0 | 3.0 | 15.0 | 18.0 | 4.7 | 103(4) | 0.15 | 5.0 | 5.0 | 5.0 | Inv. |
| | 36.2/9.1 | 4.20 | 23.78 | | | | | | | | | | | | | |
| 214 | G/H = | (1-10) = | (2-6) = | YA-1 | CLA-12 | 1.0 | 3.0 | 15.0 | 18.0 | 4.3 | 101(3) | 0.16 | 5.0 | 5.0 | 4.0 | Inv. |
| | 36.2/9.1 | 4.20 | 23.78 | | | | | | | | | | | | | |
| 215 | G/H = | (1-10) = | (2-6) = | YA-1 | CLA-12 | 1.0 | 3.0 | 15.0 | 18.0 | 4.7 | 102(4) | 0.17 | 4.5 | 5.0 | 5.0 | Inv. |
| | 36.2/9.1 | 4.20 | 23.78 | | | | | | | | | | | | | |
| 216 | G/H = | (1-10) = | (2-6) = | YA-1 | CLA-12 | 1.0 | 3.0 | 15.0 | 18.0 | 4.4 | 101(4) | 0.18 | 4.5 | 5.0 | 4.0 | Inv. |
| | 36.2/9.1 | 4.20 | 23.78 | | | | | | | | | | | | | |
| 217 | G/H = | (1-10) = | (2-6) = | YA-1 | CLA-12 | 1.0 | 3.0 | 15.0 | 18.0 | 4.5 | 102(4) | 0.19 | 4.0 | 4.5 | 5.0 | Inv. |
| | 36.2/9.1 | 4.20 | 23.78 | | | | | | | | | | | | | |
| 218 | G/H = | (1-10) = | (2-6) = | YA-1 | CLA-12 | 1.0 | 2.0 | 15.0 | 18.0 | 4.4 | 102(5) | 0.17 | 4.5 | 5.0 | 4.5 | Inv. |
| | 36.2/9.1 | 4.20 | 23.78 | | | | | | | | | | | | | |
| 219 | G/H = | (1-10) = | (2-6) = | YA-1 | CLA-12 | 1.5 | 1.5 | 15.0 | 18.0 | 4.3 | 102(6) | 0.19 | 4.0 | 4.5 | 4.0 | Inv. |
| | 36.2/9.1 | 4.20 | 23.78 | | | | | | | | | | | | | |
| 220 | A1/B1 = | (1-1) = | (2-6) = | YA-1 | CLA-12 | 1.0 | 3.0 | 15.0 | 18.0 | 3.9 | 99(22) | 0.17 | 3.5 | 4.0 | 4.0 | Inv. |
| | 36.2/9.1 | 4.20 | 23.78 | | | | | | | | | | | | | |
| 221 | A1/B1 = | (1-1) = | (2-6) = | — | — | 1.0 | 0.5 | 15.0 | 18.0 | 3.1 | 97(26) | 0.23 | 2.5 | 1.0 | 2.0 | Comp. |
| | 36.2/9.1 | 4.20 | 23.78 | | | | | | | | | | | | | |
| 222 | A1/B1 = | (1-1) = | (2-6) = | YA-1 | CLA-12 | 1.0 | 0.5 | 18.0 | 21.0 | 4.8 | 99(25) | 0.27 | 2.0 | 2.0 | 3.0 | Comp. |
| | 36.2/9.1 | 4.20 | 23.78 | | | | | | | | | | | | | |
| 223 | A1/B1 = | (1-1) = | (2-6) = | YA-1 | CLA-12 | 1.0 | 0.5 | 6.0 | 9.0 | 2.8 | 97(25) | 0.25 | 2.5 | 1.5 | 2.0 | Comp. |
| | 36.2/9.1 | 4.20 | 23.78 | | | | | | | | | | | | | |
| 224 | A1/B1 = | (1-1) = | (2-6) = | YA-1 | CLA-12 | 3.0 | 0.5 | 15.0 | 18.0 | 3.9 | 99(25) | 0.22 | 2.5 | 3.0 | 3.0 | Comp. |
| | 36.2/9.1 | 4.20 | 23.78 | | | | | | | | | | | | | |
| 225 | A1/B1 = | (1-1) = | (2-6) = | — | — | 3.0 | 0.5 | 15.0 | 18.0 | 3.1 | 97(25) | 0.22 | 2.5 | 2.5 | 2.5 | Comp. |
| | 36.2/9.1 | 4.20 | 23.78 | | | | | | | | | | | | | |
| 226 | A1/B1 = | (1-1) = | (2-6) = | YA-1 | CLA-12 | 3.0 | 0.5 | 18.0 | 21.0 | 4.8 | 99(26) | 0.23 | 2.5 | 2.5 | 3.0 | Comp. |
| | 36.2/9.1 | 4.20 | 23.78 | | | | | | | | | | | | | |

*1: Silver halide emulsion (amount, g),
*2: Reducing agent of formula (RD1) (amount, g)
*3: Reducing agent of formula (RD2) (amount, g),
*4: Yellow dye forming leuco dye,
*5: Cyan dye forming leuco dye,
*6: Length ratio of cooling unit to developing unit
*7: Cooling rate ratio of light-insensitive side to light-sensitive side,
*8: Light-sensitive layer thickness (μm)
*9: Total thickness (μm) of light-sensitive and light-insensitive layers

As apparent from Tables 2 and 3, when rapid thermal processing was conducted using a compact laser imager provided with a cooling section of a reduced path length, samples according to this invention resulted in images exhibiting enhanced sensitivity, minimized fogging, higher maximum density, superior lightfastness and silver image tone, and improved uniformity of density, as compared to comparative samples.

Specifically from comparison of samples 116 and 104, it was proved that samples 104 exhibited improved results with respect to fogging during storage at a relatively high temperature. It was further proved from comparison of samples 217 and 205 that samples 205 exhibited improved results with respect to fogging during storage at a relatively high temperature.

What is claimed is:

1. An image forming method comprising:
subjecting a photothermographic material comprising on at least one side of a support a light-sensitive layer containing an organic silver salt, photosensitive silver halide grains, a binder and a reducing agent for silver ions and a light-insensitive layer to imagewise exposure and
subjecting the photothermographic material to thermal development to form an image,
wherein a total thickness of the light-sensitive layer and the light-insensitive layer is from 10 to 20 μm and at least one of the light-sensitive layer and the light-insensitive layer contains a compound capable of forming a dye image upon thermal development;
and wherein the exposure and the thermal development are performed by using a laser imager, the laser imager comprises a developing section having a path length (1) and a cooling section having a path length (2), a ratio of the path length (2) to the path length (1) is not more than 1.5, and the cooling section is provided downstream from the developing section and conveys the photothermographic material sent from the developing section while cooling the photothermographic material.

2. The method of claim 1, wherein the photothermographic material is cooled in the cooling section at a rate (A) on a light-sensitive layer side of the photothermographic material and at a rate (B) on the other side of the photothermographic material, and the rate (B) being greater than the rate (A).

3. The method of claim 2, wherein a ratio of the rate (B) to the rate (A) is 1.1 or more.

4. The method of claim 1, wherein an opposite side of the photothermographic material to the light-sensitive layer is in contact with a member of the cooling section.

5. The method of claim 4, wherein the member of the cooling section is comprised of at least one selected from the group consisting of a metallic plate, a metallic roller, a nonwoven fabric and a flocked roller.

6. The method of claim 1, wherein the photothermographic material is in a sheet form and is thermally developed while being conveyed at a rate of 25 to 200 mm/sec.

7. The method of claim 6, wherein while a portion of a sheet of the photothermographic-material is exposed, another portion of the sheet that was exposed is developed simultaneously.

8. The method of claim 1, wherein the laser imager further comprises an exposure section and a distance between the exposure section and the developing section is 0 to 50 cm.

9. The method of claim 1, wherein the dye image exhibits an absorption having a peak at a wavelength of 360 to 450 nm.

10. The method of claim 1, wherein the dye image exhibits an absorption having a peak at a wavelength of 600 to 700 nm.

11. The method of claim 1, wherein the photothermographic material meets the following requirement:
1/1000≦S2/S1<1/10
wherein S1 represents a sensitivity obtained when subjected to exposure to light and thermal development and S2 represents a sensitivity obtained when heated under the same condition as the thermal development and then subject to the exposure to light and the thermal development.

12. The method of claim 1, wherein the silver halide grains have an iodide content of 5 to 100 mol %.

13. The method of claim 1, wherein the photothermographic material comprises a compound represented by the following formula (SF):
[R_{f}-(L₁)_{m1-]}ₚ-(Y)ₙ₁-(A)_{q} formula (SF)
wherein R_{f} is a fluorine-containing substituent, L₁ is a bivalent linkage group containing no fluorine, Y is a linkage group having a valence of (p+q) and containing no fluorine atom, A is an anion or its salt, m1 and n1 are each an integer of 0 or 1, p is an integer of 1 to 3, q is an integer of 1 to 3, provided that when q is 1, m1 and n1 are not zero at the same time.

14. The method of claim 1, wherein an average grain size of the silver halide grains is 10 to 50 nm.

15. The method of claim 13, wherein the light-sensitive layer further contain silver halide grains having an average grain size of 55 to 100 nm.

16. The method of claim 1, wherein the silver halide grains are those which were chemically sensitized with at least a chalcogen compound.

17. The method of claim 1, wherein the photothermographic material is in a sheet form and the thermal development is performed, while heating the photothermographic material for a period of 10 sec. or less.

18. The method of claim 17, wherein the laser imager is installed within an area of not mrore than 0.40m².
